(19) United States
(12) Patent Application Publication
(10) Pub. No.: US 2023/0418068 A1
(43) Pub. Date: Dec. 28, 2023

(54) Anamorphic directional illumination device

(71) Applicant: RealD Spark, LLC, Boulder, CO (US)

(72) Inventors: Graham J. Woodgate, Henley-on-Thames (GB); Michael G. Robinson, Boulder, CO (US); Austin Wilson, Tempe, AZ (US)

(21) Appl. No.: 18/211,789

(22) Filed: Jun. 20, 2023

Related U.S. Application Data
(60) Provisional application No. 63/354,676, filed on Jun. 22, 2022.
(60) Provisional application No. 63/358,413, filed on Jul. 5, 2022.
(60) Provisional application No. 63/392,683, filed on Jul. 27, 2022.
(60) Provisional application No. 63/397,251, filed on Aug. 11, 2022.
(60) Provisional application No. 63/423,998, filed on Nov. 9, 2022.
(60) Provisional application No. 63/447,977, filed on Feb. 24, 2023.
(60) Provisional application No. 63/402,571, filed on Aug. 31, 2022.
(60) Provisional application No. 63/424,012, filed on Nov. 9, 2022.

(51) Int. Cl. G02B 27/01

(52) U.S. Cl. CPC G02B 27/0172; G02B 2027/0123

(57) ABSTRACT

An anamorphic near-eye display apparatus comprises a spatial light modulator with asymmetric pixels; an input transverse anamorphic lens; and an extraction waveguide that passes input light in a first direction to a lateral anamorphic reflector arranged to reflect the light back through the waveguide. The transverse and lateral anamorphic components are arranged to achieve desirable aberrations of light cones output from the spatial light modulator. Extraction elements are arranged along the waveguide to extract the reflected light towards the pupil of an observer, maintaining the directionality of the fan of light rays from the spatial light modulator and anamorphic imaging system. A thin, transparent and efficient anamorphic display apparatus for Augmented Reality and Virtual Reality displays is provided.

### TECHNICAL FIELD

This disclosure generally relates to near-eye display apparatuses and illumination systems therefor.

### BACKGROUND

Head-worn displays incorporating a near-eye display apparatus may be arranged to provide fully immersive imagery such as in virtual reality (VR) displays or augmented imagery overlayed over views of the real world such as in augmented reality (AR) displays. If the overlayed imagery is aligned or registered with the real-world image it may be termed Mixed Reality (MR). In VR displays, the near-eye display apparatus is typically opaque to the real world, whereas in AR displays the optical system is partially transmissive to light from the real world.

The near-eye display apparatuses of AR and VR displays aim to provide images to at least one eye of a user with full colour, high resolution, high luminance and high contrast; and with wide fields of view (angular size of image), large eyebox sizes (the geometry over which the eye can move while having visibility of the full image field of view). Such displays are desirable in thin form factors, low weight and with low manufacturing cost and complexity.

Further, AR near-eye display apparatuses aim to have high transmission of real-world light rays without image distortions or degradations and reduced glare of stray light away from the display wearer. AR optics may broadly be categorised as reflective combiner type or waveguide type. Waveguide types typically achieve reduced form factor and weight due to the optical path folding within the waveguide. Known methods for injecting images into a waveguide may use a spatial light modulator and a projection lens arrangement with a prism or grating to couple light into the waveguide. Pixel locations in the spatial light modulator are converted to a fan of ray directions by the projection lens. In other arrangements a laser scanner may provide the fan of ray directions. The angular locations are propagated through the waveguide and output to the eye of the user. The eye's optical system collects the angular locations and provides spatial images at the retina.

### BRIEF SUMMARY

According to a first aspect of the present disclosure, there is provided an anamorphic near-eye display apparatus comprising: an illumination system comprising a spatial light modulator, the illumination system arranged to output light; and an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises an array of extraction features, the extraction features arranged to transmit light guided along the extraction waveguide in the first direction and to extract light guided along the extraction waveguide in the second direction towards an eye of a viewer, the array of extraction features distributed along the extraction waveguide so as to provide exit pupil expansion, and the lateral anamorphic component comprises: a reflective linear polariser disposed between the light reversing reflector and the array of extraction features; and a polarisation conversion retarder disposed between the reflective linear polariser and the light reversing reflector, the polarisation conversion retarder arranged to convert a polarisation state of light passing therethrough between a linear polarisation state and a circular polarisation state.

Aberrations of the optical system in at least the lateral direction may advantageously be reduced. Image blur of pixels as seen by the viewer may be reduced and image contrast advantageously increased. A compact and thin optical system may be provided that may be partially transparent for augmented reality operation. Increased field of view in the lateral direction for desirable maximum image blur may be achieved.

The reflective linear polariser may be curved in the lateral direction. The reflective linear polariser may be curved in only one plane may be conveniently formed from a flexible layer without distortion. Advantageously image fidelity may be increased.

The light reversing reflector may not be curved in the lateral direction. The anamorphic near-eye display apparatus may be provided with end shapes other than those provided by a curved light reversing reflector and with desirable outer shape.

The light reversing reflector may be curved in the lateral direction. Advantageously aberrations may be reduced.

The polarisation conversion retarder may be curved in the lateral direction. The polarisation conversion retarder may be formed near to the light reversing reflector, reducing complexity of assembly.

The polarisation conversion retarder may have a retardance of a quarter wavelength at a wavelength of visible light. Advantageously high efficiency of throughput of light through the lateral anamorphic component may be achieved over a wide field angle.

The optical system may comprise an input linear polariser disposed between the spatial light modulator and the array of extraction reflectors, wherein the input linear polariser and the reflective linear polariser of the lateral anamorphic component may be arranged to pass a common polarisation state. Stray light reflected from the reflective polariser may be reduced and advantageously image contrast improved.

The lateral anamorphic component may further comprise: a polarisation control retarder disposed between the reflective linear polariser and the array of extraction features, the polarisation control retarder arranged to change a polarisation state of light passing therethrough; and an absorbing linear polariser disposed between the polarisation control retarder and the reflective linear polariser, wherein the absorbing linear polariser and the reflective linear polariser may be arranged to pass a common linear polarisation state that may be a component of the polarisation state output from the polarisation control retarder in the direction along the waveguide. In operation, light of an input polarisation state may propagate in the first direction and light of an output polarisation state orthogonal to the input polarisation state may propagate in the second direction. The polarisation control retarder may have a retardance of a quarter wavelength or a half wavelength at a wavelength of visible light. The optical system may comprise an input linear polariser disposed between the spatial light modulator and the array of extraction reflectors. Stray light may be reduced and efficiency of light extraction may be increased. Advantageously image contrast may be increased.

The extraction features may be reflective extraction features disposed internally within the extraction waveguide. The reflective extraction features may comprise extraction reflectors that extend across at least part of the extraction waveguide between front and rear guide surfaces of the extraction waveguide. The extraction reflectors may comprise intermediate surfaces spaced apart by a partially reflective coating. Advantageously surface scatter artefacts may be reduced and image contrast improved.

The partially reflective coating may comprise at least one dielectric layer. Polarised light propagating in the first direction with the input polarisation state may be preferentially transmitted and polarised light with a different polarisation state to the input polarisation state propagating in the second direction may be preferentially extracted. Efficiency may be increased and image contrast advantageously reduced.

The extraction reflectors may have a surface normal direction that may be inclined with respect to the direction along the waveguide by an angle in the range 20 to 40 degrees, preferably by an angle in the range 25 to 35 degrees and most preferably by an angle in the range 27.5 degrees to 32.5 degrees. Advantageously the visibility of a flipped image in the transverse direction may be reduced.

The extraction waveguide may have a front guide surface and a rear guide surface, and the rear guide surface may comprise extraction facets that may be the extraction features, each extraction facet arranged to reflect light guided in the second direction towards an eye of a viewer through the front guide surface. Advantageously the cost and complexity of fabrication of the extraction waveguide may be reduced. High efficiency of operation may be achieved.

The extraction waveguide may have a front guide surface and a rear guide surface, and the rear guide surface may comprise a diffractive optical element comprising the extraction features. Advantageously the cost and complexity of assembling the extraction waveguide may be reduced.

The extraction waveguide may comprise: a front guide surface, a polarisation-sensitive reflector opposing the front guide surface; and an extraction element disposed outside the polarisation-sensitive reflector, wherein the extraction element may comprise: a rear guide surface opposing the front guide surface; and the array of extraction features; the anamorphic near-eye display apparatus may be arranged to provide light guided along the extraction waveguide in the first direction with an input linear polarisation state before reaching the polarisation-sensitive reflector; the polarisation conversion retarder disposed between the reflective linear polariser and the light reversing reflector may be a first polarisation conversion retarder; the anamorphic near-eye display apparatus may comprise a second polarisation conversion retarder arranged between the polarisation-sensitive reflector and the reflective linear polariser, the second polarisation conversion retarder arranged to convert from a state that may be parallel or orthogonal to the input linear polarisation state to a polarisation state that may have a component parallel to the input linear polarisation state and a component orthogonal to the input linear polarisation state; the anamorphic near-eye display apparatus may comprise an absorptive linear polariser arranged to pass the component parallel to the input linear polarisation state or the component orthogonal to the input linear polarisation state; the reflective linear polariser may be arranged to pass the same component as the absorptive linear polariser; the second polarisation conversion retarder, the absorptive linear polariser, the reflective linear polariser, the first polarisation conversion retarder and the light reversing reflector may be arranged in combination to rotate the input linear polarisation state of the light guided in the first direction so that the light guided in the second direction and output from the second polarisation conversion retarder may have a linear polarisation state that may have a component parallel to the input linear polarisation state and a component orthogonal to the input linear polarisation state; and the polarisation-sensitive reflector may be arranged to reflect light guided in the first direction having the input linear polarisation state and to pass the component of light guided in the second direction that may be orthogonal to the input linear polarisation state, so that the front guide surface and the polarisation-sensitive reflector may be arranged to guide light in the first direction, and the front guide surface and the rear guide surface may be arranged to guide the component of light that may be orthogonal to the input linear polarisation state in the second direction. The polarisation-sensitive reflector may comprise a reflective linear polariser. The polarisation-sensitive reflector may comprise at least one dielectric layer. A near-eye anamorphic display apparatus may be provided with reduced image blur at least in the lateral direction. The visibility of stray light and flipped images in the lateral direction may be reduced. Complexity of manufacture of the extraction waveguide may be reduced.

According to a second aspect of the present disclosure, there is provided a head-worn display apparatus comprising an anamorphic near-eye display apparatus according to the first aspect and a head-mounting arrangement arranged to mount the anamorphic near-eye display apparatus on a head of a wearer with the anamorphic near-eye display apparatus extending across at least one eye of the wearer. A display apparatus suitable for virtual reality and augmented reality applications may be provided.

According to a third aspect of the present disclosure, there is provided an anamorphic near-eye display apparatus comprising: an illumination system comprising a spatial light modulator, the illumination system arranged to output light; and an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises an array of extraction features, the extraction features arranged to transmit light guided along the extraction waveguide in the first direction and to extract light guided along the extraction waveguide in the second direction towards an eye of a viewer, the array of extraction features distributed along the extraction waveguide so as to provide exit pupil expansion, and the transverse anamorphic component comprises: a partially reflective surface; a reflective linear polariser disposed in series with the partially reflective surface, wherein at least one of the partially reflective surface and the reflective linear polariser has positive optical power in the transverse direction; and a polarisation conversion retarder disposed between the partially reflective surface and the reflective linear polariser, the polarisation conversion retarder arranged to convert a polarisation state of light passing therethrough between a linear polarisation state and a circular polarisation state. Aberrations of the optical system in at least the transverse direction may advantageously be reduced. Image blur of pixels as seen by the viewer may be reduced and image contrast advantageously increased. A compact transverse anamorphic component may be provided. Increased field of view in the transverse direction for desirable maximum image blur may be achieved.

Each of the partially reflective surface and the reflective linear polariser may have positive optical power in the transverse direction. The partially reflective surface and the reflective linear polariser may be curved in only one plane so may be conveniently formed from a flexible layer without distortion. Advantageously image fidelity may be increased.

At least one of the partially reflective surface and the reflective linear polariser that has positive optical power in the transverse direction may have no optical power in the lateral direction. Advantageously the complexity and cost of fabrication may be reduced.

The transverse anamorphic component may further comprise at least one lens element. Advantageously aberrations may be further reduced and image fidelity increased.

The reflective linear polariser may be disposed after the partially reflective surface in a direction of transmission of light from the spatial light modulator or the reflective linear polariser may be disposed before the partially reflective surface in a direction of transmission of light from the spatial light modulator. Desirable aberrational performance may be achieved by appropriate selection of the sequence of the reflective linear polariser and the partially reflective surface.

The extraction waveguide may have an input end extending in the lateral and transverse directions, the extraction waveguide arranged to receive light from the illumination system through the input end, and the transverse anamorphic component may be disposed between the spatial light modulator and the input end of the extraction waveguide. Transverse ray bundles may be directed into the extraction waveguide, advantageously providing desirable field of view of operation by the viewer.

The transverse anamorphic component may further comprise a further polarisation conversion retarder that either may be disposed before the partially reflective surface and the reflective linear polariser in a direction of transmission of light from the spatial light modulator or may be disposed after the partially reflective surface and the reflective linear polariser in a direction of transmission of light from the spatial light modulator.

The anamorphic near-eye display apparatus may further comprise a linear polariser arranged between the transverse anamorphic component and the input end of the extraction waveguide. The spatial light modulator may be arranged to output linearly polarised light. The illumination system may further comprise an output polariser disposed between the spatial light modulator and the transverse optical component, the output polariser arranged to output linearly polarised light. The polarisation state propagating in the first direction along the waveguide may be provided with desirable orientation to achieve high efficiency and high image contrast.

According to a fourth aspect of the present disclosure, there is provided an anamorphic near-eye display apparatus comprising: an illumination system comprising a spatial light modulator, the illumination system arranged to output light; and an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises an array of extraction features, the extraction features arranged to transmit light guided along the extraction waveguide in the first direction and to extract light guided along the extraction waveguide in the second direction towards an eye of a viewer, the array of extraction features distributed along the extraction waveguide so as to provide exit pupil expansion, and wherein the lateral anamorphic component comprises a lens formed by at least one surface of an air gap formed in a waveguide. Advantageously improved aberrations may be achieved across the field of view and for a larger exit pupil.

The lens of the lateral anamorphic component may comprise an air gap and a surface facing the air gap. Control of aberrations may be increased and advantageously the modulation transfer function for off-axis directions may be increased and the image blur reduced.

The air gap may have edges, and the anamorphic near-eye display apparatus may comprise reflectors extending across the edges of the air gap. Advantageously light losses may be reduced and image uniformity increased.

The waveguide in which the air gap may be formed may be the extraction waveguide. The light reversing reflector may be a reflective end of the extraction waveguide. The lateral anamorphic component may further comprise the light reversing reflector. Advantageously a compact display apparatus with improved aberrations may be achieved.

According to a fifth aspect of the present disclosure, there is provided an anamorphic near-eye display apparatus comprising: an illumination system comprising a spatial light modulator, the illumination system arranged to output light; and an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises an array of extraction features, the extraction features arranged to transmit light guided along the extraction waveguide in the first direction and to extract light guided along the extraction waveguide in the second direction towards an eye of a viewer, the array of extraction features distributed along the extraction waveguide so as to provide exit pupil expansion, and the lens of the lateral anamorphic component is a Pancharatnam-Berry lens. Advantageously the size of the lateral anamorphic component may be reduced.

According to a sixth aspect of the present disclosure, there is provided an anamorphic near-eye display apparatus comprising: an illumination system comprising a spatial light modulator, the illumination system arranged to output light; and an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises an array of extraction features, the extraction features arranged to transmit light guided along the extraction waveguide in the first direction and to extract light guided along the extraction waveguide in the second direction towards an eye of a viewer, the array of extraction features distributed along the extraction waveguide so as to provide exit pupil expansion, and at least one of an input end of the extraction waveguide, the transverse anamorphic component and the spatial light modulator has a curvature in the lateral direction that compensates for field curvature of the lateral anamorphic component. Advantageously the modulation transfer function for off-axis directions may be increased and the image blur reduced. Increased image fidelity and higher image contrast may be observed by the viewer.

According to a seventh aspect of the present disclosure, there is provided an anamorphic near-eye display apparatus comprising: an illumination system comprising a spatial light modulator, the illumination system arranged to output light; and an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises: a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises an array of extraction features, the extraction features arranged to transmit light guided along the extraction waveguide in the first direction and to extract light guided along the extraction waveguide in the second direction towards an eye of a viewer, the array of extraction features distributed along the extraction waveguide so as to provide exit pupil expansion, and the spatial light modulator comprises an array of pixels, wherein each pixel comprises sub-pixels of plural colour components and a pitch of the sub-pixels of each colour component across the pixels in the lateral direction varies between the colour components in a manner that compensates for chromatic aberration between light of the colour components. The separation of separate colour components that arises at least from refraction at the front light guide surface and is seen by the viewer as colour blur may be reduced, achieving increased image fidelity for colour images. The appearance of image distortion may be reduced and active area of the viewed image increased.

The sub-pixels of each pixel may be aligned in the transverse direction. The pitch of the sub-pixels of each colour component across the pixels in the transverse direction may be the same for each colour component. The pitch of the sub-pixels of each colour component across the pixels in the transverse direction varies between the colour components in a manner that compensates for chromatic aberration between light of the colour components. Advantageously the complexity and cost of fabrication of the spatial light modulator may be reduced.

According to an eighth aspect of the present disclosure, there is provided an anamorphic near-eye display apparatus according to any one of the third to seventh aspects, wherein: the extraction waveguide comprises: a front guide surface; a polarisation-sensitive reflector opposing the front guide surface; and an extraction element disposed outside the polarisation-sensitive reflector, the extraction element comprising: a rear guide surface opposing the front guide surface; and the array of extraction features; the anamorphic near-eye display apparatus is arranged to provide light guided along the extraction waveguide in the first direction with an input linear polarisation state before reaching the polarisation-sensitive reflector; and the optical system further comprises a polarisation conversion retarder disposed between the polarisation-sensitive reflector and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has an orthogonal linear polarisation state that is orthogonal to the input linear polarisation state; the polarisation-sensitive reflector is arranged to reflect light guided in the first direction having the input linear polarisation state and to pass light guided in the second direction having the orthogonal linear polarisation state, so that the front guide surface and the polarisation-sensitive reflector are arranged to guide light in the first direction, and the front guide surface and the rear guide surface are arranged to guide light in the second direction; and the array of extraction features is arranged to extract light guided along the extraction waveguide in the second direction towards an eye of a viewer through the front guide surface, the array of extraction features distributed along the extraction waveguide so as to provide exit pupil expansion in the transverse direction.

According to a ninth aspect of the present disclosure, there is provided a head-worn display apparatus comprising an anamorphic near-eye display apparatus according to any one of the third to eighth aspects and a head-mounting arrangement arranged to mount the anamorphic near-eye display apparatus on a head of a wearer with the anamorphic near-eye display apparatus extending across at least one eye of the wearer.

The optical system of any of the first to ninth aspects of the present disclosure may further comprise: an input waveguide arranged to receive light from the transverse anamorphic component; a partially reflective mirror, the input waveguide arranged to guide light from the transverse anamorphic component to the partially reflective mirror along the input waveguide, and the partially reflective mirror arranged to reflect at least some of that light; an intermediate waveguide arranged to receive at least some of the light reflected by the partially reflective mirror, a lateral anamorphic component having positive optical power in the lateral direction, the intermediate waveguide arranged to guide the light received from the partially reflective mirror to the lateral anamorphic component along the intermediate waveguide in a first direction; a light reversing reflector that is arranged to reflect light that has been guided along the intermediate waveguide in the first direction so that the reflected light is guided along the intermediate waveguide in a second direction opposite to the first direction to the partially reflective mirror, the partially reflective mirror arranged to transmit at least some of that light; and wherein the extraction waveguide is arranged to receive at least some of the light transmitted by the partially reflective mirror that has been guided in the second direction along the intermediate waveguide. Light that is passed by the input waveguide and intermediate waveguide does not pass through light extraction elements. Advantageously stray light may be reduced.

According to a tenth aspect of the present disclosure, there is provided an anamorphic directional illumination device comprising: an illumination system comprising a light source array, the illumination system arranged to output light; and an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises: a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises at least one extraction feature, the at least one extraction feature arranged to transmit light guided along the extraction waveguide in the first direction and to extract light guided along the extraction waveguide in the second direction, and the lateral anamorphic component comprises: a reflective linear polariser disposed between the light reversing reflector and the at least one extraction feature; and a polarisation conversion retarder disposed between the reflective linear polariser and the light reversing reflector, the polarisation conversion retarder arranged to convert a polarisation state of light passing therethrough between a linear polarisation state and a circular polarisation state. Aberrations of the lateral anamorphic component may be improved. Fidelity of optical cones and field of illumination may be increased. Higher contrast illumination of external scenes may be provided. Reduced glare and increased luminance may be achieved.

According to an eleventh aspect of the present disclosure, there is provided an anamorphic directional illumination device comprising: an illumination system comprising a light source array, the illumination system arranged to output light; and an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises: a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises at least one extraction feature, the at least one extraction feature arranged to transmit light guided along the extraction waveguide in the first direction and to extract light guided along the extraction waveguide in the second direction, and the transverse anamorphic component comprises: a partially reflective surface; a reflective linear polariser disposed in series with the partially reflective surface, wherein at least one of the partially reflective surface and the reflective linear polariser has positive optical power in the transverse direction; and a polarisation conversion retarder disposed between the partially reflective surface and the reflective linear polariser, the polarisation conversion retarder arranged to convert a polarisation state of light passing therethrough between a linear polarisation state and a circular polarisation state. Advantageously the fidelity of light cones output may be improved. Higher contrast illumination of external scenes may be provided. Reduced glare and increased luminance may be achieved.

According to a twelfth aspect of the present disclosure, there is provided an anamorphic directional illumination device comprising: an illumination system comprising a light source array, the illumination system arranged to output light, and an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises: a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises at least one extraction feature, the at least one extraction feature arranged to transmit light guided along the extraction waveguide in the first direction and to extract light guided along the extraction waveguide in the second direction, and wherein the lateral anamorphic component comprises a lens formed by at least one surface of an air gap formed in a waveguide. Advantageously the fidelity of light cones output may be improved. Higher contrast illumination of external scenes may be provided. Reduced glare and increased luminance may be achieved.

According to a thirteenth aspect of the present disclosure, there is provided an anamorphic directional illumination device comprising: an illumination system comprising a light source array, the illumination system arranged to output light; and an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises: a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises at least one extraction feature, the at least one extraction feature arranged to transmit light guided along the extraction waveguide in the first direction and to extract light guided along the extraction waveguide in the second direction, and the lens of the lateral anamorphic component is a Pancharatnam-Berry lens. Advantageously the fidelity of light cones output may be improved. Higher contrast illumination of external scenes may be provided. Reduced glare and increased luminance may be achieved. The compactness of the anamorphic directional illumination device may be improved.

According to a fourteenth aspect of the present disclosure, there is provided an anamorphic directional illumination device comprising: an illumination system comprising a light source array, the illumination system arranged to output light; and an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises: a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises at least one extraction feature, the at least one extraction feature arranged to transmit light guided along the extraction waveguide in the first direction and to extract light guided along the extraction waveguide in the second direction, and at least one of an input end of the extraction waveguide, the transverse anamorphic component and the light source array has a curvature in the lateral direction that compensates for field curvature of the lateral anamorphic component. Advantageously the fidelity of light cones output may be improved and the field of illumination increased. Higher contrast illumination of external scenes may be provided. Reduced glare and increased luminance may be achieved.

According to a fifteenth aspect of the present disclosure, there is provided an anamorphic directional illumination device comprising: an illumination system comprising a light source array, the illumination system arranged to output light; and an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises: a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction; an extraction waveguide arranged to receive light from the transverse anamorphic component; a lateral anamorphic component having positive optical power in the lateral direction, the extraction waveguide arranged to guide light from the transverse anamorphic component to the lateral anamorphic component along the extraction waveguide in a first direction; and a light reversing reflector that is arranged to reflect light that has been guided along the extraction waveguide in the first direction so that the reflected light is guided along the extraction waveguide in a second direction opposite to the first direction, wherein the extraction waveguide comprises at least one extraction feature, the at least one extraction feature arranged to transmit light guided along the extraction waveguide in the first direction and to extract light guided along the extraction waveguide in the second direction, and the light source array comprises an array of light sources, wherein each light source comprises sub-light sources of plural colour components and a pitch of the sub-light sources of each colour component across the light sources in the lateral direction varies between the colour components in a manner that compensates for chromatic aberration between light of the colour components. Advantageously colouration of the output light cones may be reduced. Image fidelity may be increased and field of illumination improved.

According to a sixteenth aspect of the present disclosure, there is provided a vehicle external light apparatus comprising an anamorphic directional illumination device according to any one of the tenth to fifteenth aspects. An array of illumination light cones for illumination of a road scene may be provided. The light cones may provide control of regions of the road scene that are illuminated. Illuminance may be reduced in the region of oncoming vehicles to reduce glare to oncoming drivers. Illuminance to road hazards may be increased in regions that are not around the location of drivers. Improved driver safety may be achieved.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments and automotive environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating a front perspective view of an anamorphic near-eye display apparatus;

FIG. 1B is a schematic diagram illustrating a front perspective view of the coordinate system arrangements for the anamorphic near-eye display apparatus of FIG. 1A:

FIG. 1C is a schematic diagram illustrating a side view of the operation of a near-eye display in a transverse plane;

FIG. 1D is a schematic diagram illustrating a side view of the operation of a near-eye display in a lateral plane orthogonal to the transverse plane:

FIG. 1E is a schematic diagram illustrating a front perspective view of a coordinate system mapping for the anamorphic near-eye display apparatus of FIG. 1A:

FIG. 1F is a schematic diagram illustrating a field-of-view plot of the output of the anamorphic near-eye display apparatus of FIG. 1A for polychromatic illumination:

FIG. 2A, FIG. 2B, and FIG. 2C are schematic diagrams illustrating in front view arrangements of a spatial light modulator for use in the anamorphic near-eye display apparatus of FIG. 1A comprising spatially multiplexed red, green and blue sub-pixels;

FIG. 2D is a schematic diagram illustrating in front view a spatial light modulator for use in the anamorphic near-eye display apparatus of FIG. 1A for use with temporally multiplexed spectral illumination;

FIG. 3A is a schematic diagram illustrating a side view of light input into an extraction waveguide;

FIG. 3B is a schematic diagram illustrating a side view of light propagation along a first direction in an extraction waveguide;

FIG. 3C is a schematic diagram illustrating a side view of light extraction from the anamorphic near-eye display apparatus of FIG. 1A;

FIG. 3D is a schematic diagram illustrating a schematic perspective view of an optical design for a near-eye anamorphic display apparatus;

FIG. 4A is a schematic diagram illustrating a side view of light output from an anamorphic near-eye display apparatus for a single extraction reflector;

FIG. 4B is a schematic diagram illustrating a side view of light output from an anamorphic near-eye display apparatus for multiple extraction reflectors to achieve a full ray cone input in the transverse direction into an observer's pupil;

FIG. 4C is a schematic diagram illustrating a side view of light output from an anamorphic near-eye display apparatus for multiple locations for a moving observer in the transverse direction;

FIG. 5A is a schematic diagram illustrating a front view of light output from the anamorphic near-eye display apparatus of FIG. 1A;

FIG. 5B is a schematic diagram illustrating a front view of the anamorphic near-eye display apparatus of FIG. 1A for a single pupil position:

FIG. 5C is a schematic diagram illustrating a front view of the anamorphic near-eye display apparatus of FIG. 1A for multiple pupil positions;

FIG. 6A is a schematic diagram illustrating a side view of polarised light propagation in the anamorphic near-eye display apparatus of FIG. 1A;

FIG. 6B is a schematic diagram illustrating a front view of polarised light propagation in the anamorphic near-eye display apparatus of FIG. 1A;

FIG. 6C is a schematic diagram illustrating optical axis alignment directions through the polarisation control components of FIGS. 6A-B;

FIG. 7A is a schematic diagram illustrating in front view an anamorphic near-eye display apparatus wherein the lateral anamorphic component further comprises a planar reflective polariser and a quarter wave retarder arranged between the reflective end and the reflective polariser:

FIG. 7B is a schematic diagram illustrating optical axis alignment directions through the polarisation control components of FIG. 7A;

FIG. 7C is a schematic diagram illustrating in front view an anamorphic near-eye display apparatus wherein the lateral anamorphic component further comprises a curved reflective polariser and a quarter wave retarder arranged between the reflective end and the reflective polariser;

FIG. 7D is a schematic diagram illustrating in front view an anamorphic near-eye display apparatus wherein the lateral anamorphic component further comprises a planar reflective end, a curved reflective polariser and a quarter wave retarder arranged between the planar reflective end and the reflective polariser;

FIG. 7E is a schematic diagram illustrating in front view an anamorphic near-eye display apparatus wherein the lateral anamorphic component comprises a curved reflective end, a curved reflective polariser; a quarter wave retarder arranged between the planar reflective end and the reflective polariser and a refractive lens arranged between the input end and the reflective polariser;

FIG. 7F is a schematic diagram illustrating in front view an anamorphic near-eye display apparatus wherein the lateral anamorphic component further comprises a planar reflective polariser, a quarter wave retarder arranged between the reflective end and the reflective polariser and a further quarter wave retarder arranged between the input end and the reflective polariser wherein the input linear polariser is incorporated in the extraction waveguide;

FIG. 7G is a schematic diagram illustrating optical axis alignment directions through the polarisation control components of FIG. 7F;

FIG. 7H is a schematic diagram illustrating in front view an anamorphic near-eye display apparatus wherein the lateral anamorphic component further comprises a planar reflective polariser, a quarter wave retarder arranged between the reflective end and the reflective polariser and a further half wave retarder arranged between the input end and the reflective polariser;

FIG. 7I is a schematic diagram illustrating optical axis alignment directions through the polarisation control components of FIG. 7H;

FIG. 8A is a schematic diagram illustrating in side view part of an optical system for an anamorphic near-eye display apparatus comprising a half-silvered mirror and a reflective polariser;

FIG. 8B is a schematic diagram illustrating optical axis alignment directions and polarisation states for light propagating through the polarisation control components of FIG. 8A;

FIG. 8C is a schematic diagram illustrating in side view part of an optical system for an anamorphic near-eye display apparatus comprising a half-silvered mirror and a reflective polariser;

FIG. 8D is a schematic diagram illustrating optical axis alignment directions and polarisation states for light propagating through the polarisation control components of FIG. 8C;

FIG. 8E is a schematic diagram illustrating in side view part of an optical system for an anamorphic near-eye display apparatus comprising a curved half-silvered mirror and a planar reflective polariser;

FIG. 8F is a schematic diagram illustrating in side view part of an optical system for an anamorphic near-eye display apparatus comprising a planar half-silvered mirror and a curved reflective polariser;

FIG. 9A is a schematic diagram illustrating in front view an anamorphic near-eye display apparatus comprising a lateral anamorphic component that is refractive and reflective;

FIG. 9B is a schematic diagram illustrating in front view an anamorphic near-eye display apparatus comprising a lateral anamorphic component that is a reflective end of a waveguide comprising a Fresnel reflector;

FIG. 9C is a schematic diagram illustrating in front view an anamorphic near-eye display apparatus comprising a lateral anamorphic component that is a refractive component comprising an air gap and air gap mirrors;

FIG. 9D is a schematic diagram illustrating in side view the anamorphic near-eye display apparatus of FIG. 9C;

FIG. 10A is a schematic diagram illustrating in front view an anamorphic near-eye display apparatus comprising a reflective end comprising a Pancharatnam-Berry lens;

FIG. 10B is a schematic diagram illustrating in end view the optical structure of a Pancharatnam-Berry lens:

FIG. 10C is a schematic diagram illustrating in front view an optical structure of the Pancharatnam-Berry lens of FIG. 10B;

FIG. 10D is a schematic graph illustrating the variation of phase difference with lateral position for an illustrative Pancharatnam-Berry lens of FIG. 10B;

FIG. 10E is a schematic diagram illustrating in side view the operation of the Pancharatnam-Berry lens of FIG. 10A;

FIG. 11A is a schematic diagram illustrating in front view an anamorphic near-eye display apparatus wherein an input end of the extraction waveguide has curvature in the lateral direction:

FIG. 11B is a schematic diagram illustrating in front view an anamorphic near-eye display apparatus wherein an input end of the extraction waveguide has curvature in the lateral direction and a transverse anamorphic component has curvature in the lateral direction:

FIG. 11C is a schematic diagram illustrating in front view an anamorphic near-eye display apparatus wherein an input end of the extraction waveguide has curvature in the lateral direction, a transverse anamorphic component has curvature in the lateral direction, and a spatial light modulator has curvature in the lateral direction;

FIG. 11D is a schematic diagram illustrating in front view an anamorphic near-eye display apparatus wherein an input end of the extraction waveguide has curvature in the lateral direction, a transverse anamorphic component has curvature in the lateral direction, and a spatial light modulator has curvature in the lateral direction, where the direction of curvature is in an opposite direction to that of FIG. 11C;

FIG. 11E is a schematic diagram illustrating in front view an anamorphic near-eye display apparatus wherein an input end of the extraction waveguide has curvature in the lateral direction, a transverse anamorphic component has curvature in the lateral direction, and a spatial light modulator has curvature in the lateral direction, where the direction of curvature of these components is different;

FIG. 12A is a schematic diagram illustrating in end view extraction of coloured light from an extraction waveguide illuminated by a white pixel comprising co-located red, green and blue colour sub-pixels;

FIG. 12B is a schematic diagram illustrating in front view extraction of coloured light from an extraction waveguide illuminated by a white pixel comprising co-located red, green and blue colour sub-pixels;

FIG. 12C is a schematic graph illustrating a reference array of pixel locations on the surface of a spatial light modulator;

FIG. 12D is a schematic graph illustrating the array of angular output directions corresponding to the array of pixel locations of FIG. 12C in an illustrative embodiment of an anamorphic near-eye display apparatus:

FIG. 12E is a schematic graph illustrating a region of the graph of FIG. 12D;

FIG. 13A is a schematic diagram illustrating in end view extraction of coloured light from an extraction waveguide illuminated by a white pixel comprising separated red, green and blue colour sub-pixels;

FIG. 13B is a schematic diagram illustrating in front view extraction of coloured light from an extraction waveguide illuminated by a white pixel comprising separated red, green and blue colour sub-pixels;

FIG. 13C is a schematic graph illustrating a corrected array of pixel locations on the surface of a spatial light modulator;

FIG. 13D is a schematic graph illustrating a region of the graph of FIG. 13C;

FIG. 13E is a schematic graph illustrating the array of angular output directions corresponding to the array of pixel locations of FIG. 13C in an illustrative embodiment of an anamorphic near-eye display apparatus;

FIG. 13F is a schematic diagram illustrating in front view arrangements of colour sub-pixels for first and second locations on the spatial light modulator, wherein the pitch of the sub-pixels of each colour component across the pixels in the lateral direction varies in the lateral and transverse directions;

FIG. 13G is a schematic diagram illustrating in front view arrangements of colour sub-pixels for first and second locations on the spatial light modulator, wherein the pitch of the sub-pixels of each colour component across the pixels in the lateral direction varies in the lateral direction;

FIG. 13H is a schematic diagram illustrating in front view arrangements of colour sub-pixels for first and second locations on the spatial light modulator, wherein the pitch of the pixels varies in the lateral and transverse directions;

FIG. 13I is a flowchart illustrating a method to provide calculation of the location of the array of red, green and blue colour sub-pixels of the spatial light modulator comprising c different colour sub-pixels, m pixel columns and n pixel rows;

FIG. 13J is an alternative flowchart illustrating a method to provide calculation of the location of the array of red, green and blue colour sub-pixels of the spatial light modulator comprising c different colour sub-pixels, m pixel columns and n pixel rows;

FIG. 13K is a schematic diagram illustrating in front view extraction of coloured light from an extraction waveguide illuminated by a white pixel, wherein the extraction waveguide further comprises a colour splitting diffractive optical element arranged between the light reversing reflector and the array of extraction reflectors;

FIG. 13L is a schematic diagram illustrating in front view operation of the colour splitting diffractive optical element;

FIG. 14A is a schematic diagram illustrating in side view a detail of an arrangement of an input focusing lens;

FIG. 14B is a schematic diagram illustrating in front view a detail of the arrangement of the input focusing lens of FIG. 14A;

FIG. 15A is a schematic diagram illustrating in side view a spatial light modulator arrangement for use in the anamorphic near-eye display apparatus of FIG. 1A comprising separate red, green and blue spatial light modulators and a beam combining element;

FIG. 15B is a schematic diagram illustrating in side view an illumination system for use in the anamorphic near-eye display apparatus of FIG. 1A comprising a birdbath folded arrangement;

FIG. 16 is a schematic diagram illustrating in perspective front view an alternative arrangement of an input focusing lens;

FIG. 17 is a schematic diagram illustrating in side view a spatial light modulator arrangement for use in the anamorphic near-eye display apparatus of FIG. 1A comprising a spatial light modulator comprising a laser scanner and light diffusing screen;

FIG. 18A is a schematic diagram illustrating in side view input to the extraction waveguide comprising a laser sources and scanning arrangement;

FIG. 18B is a schematic diagram illustrating in front view a spatial light modulator arrangement comprising an array of laser light sources for use in the arrangement of FIG. 18A:

FIG. 18C is a schematic diagram illustrating in side view a spatial light modulator arrangement comprising an array of laser light sources, a beam expander and a scanning mirror;

FIG. 19A is a schematic diagram illustrating a front perspective view of an anamorphic near-eye display apparatus comprising a stepped extraction waveguide;

FIG. 19B is a schematic diagram illustrating in side view the operation of the anamorphic near-eye display apparatus of FIG. 19A:

FIG. 20A is a schematic diagram illustrating in perspective front view an alternative arrangement of the anamorphic near-eye display apparatus wherein the extraction reflectors comprises plural constituent plates:

FIG. 20B is a schematic diagram illustrating in side view the operation of the anamorphic near-eye display apparatus of FIG. 20A:

FIG. 21A is a schematic diagram illustrating a front perspective view of an anamorphic near-eye display apparatus comprising a polarisation-sensitive reflector;

FIG. 21B is a schematic diagram illustrating in side view the operation of the anamorphic near-eye display apparatus of FIG. 21A for light propagating in the first direction along the extraction waveguide;

FIG. 21C is a schematic diagram illustrating in side view the operation of the anamorphic near-eye display apparatus of FIG. 21A for light propagating in the second direction along the extraction waveguide;

FIG. 21D is a schematic diagram illustrating a side view of polarised light propagation in the anamorphic near-eye display apparatus of FIG. 21A;

FIG. 21E is a schematic diagram illustrating a front view of polarised light propagation in the anamorphic near-eye display apparatus of FIG. 21A;

FIG. 21F is a schematic diagram illustrating alignment directions through the polarisation control components of FIGS. 21A-E:

FIG. 21G is a schematic diagram illustrating a side view of polarised light propagation in the anamorphic near-eye display apparatus of FIGS. 7F-G wherein the waveguide comprises a polarisation-sensitive reflector:

FIG. 21H is a schematic diagram illustrating a side view of polarised light propagation in the anamorphic near-eye display apparatus of FIGS. 7H-I wherein the waveguide comprises a polarisation-sensitive reflector;

FIG. 21I is a schematic diagram illustrating a front perspective view of an anamorphic near-eye display apparatus comprising a polarisation-sensitive reflector wherein the extraction element is a deflection element;

FIG. 21J is a schematic diagram illustrating a side view of the anamorphic near-eye display apparatus of FIG. 21I;

FIG. 21K is a schematic diagram illustrating a side view of a portion of the anamorphic near-eye display apparatus of FIG. 21I:

FIG. 22A is a schematic diagram illustrating in perspective front view an alternative arrangement of an anamorphic near-eye display apparatus comprising a diffractive optical element:

FIG. 22B is a schematic diagram illustrating in side view the operation of the anamorphic near-eye display apparatus of FIG. 22A;

FIG. 23A is a schematic diagram illustrating in perspective front view an augmented reality head-worn display apparatus comprising a right-eye anamorphic display apparatus arranged with spatial light modulator in brow position:

FIG. 23B is a schematic diagram illustrating in perspective front view an augmented reality head-worn display apparatus comprising left-eye and right-eye anamorphic display apparatuses arranged with spatial light modulator in brow position;

FIG. 23C is a schematic diagram illustrating in perspective front view an eyepiece arrangement for an augmented reality head-worn display apparatus;

FIG. 24A is a schematic diagram illustrating in perspective front view an anamorphic near-eye display apparatus with spatial light modulator in temple position:

FIG. 24B is a schematic diagram illustrating in perspective front view an augmented reality head-worn display apparatus comprising a left-eye anamorphic display apparatus arranged with spatial light modulator in temple position;

FIG. 24C is a schematic diagram illustrating in perspective front view an augmented reality head-worn display apparatus comprising left-eye and right-eye anamorphic display apparatuses arranged with spatial light modulator in temple position:

FIG. 25 is a schematic diagram illustrating in front view a virtual reality head-worn display apparatus comprising left-eye and right-eye anamorphic display apparatuses;

FIG. 26A is a schematic diagram illustrating a front perspective view of an anamorphic near-eye display apparatus:

FIG. 26B is a schematic diagram illustrating a top view of the anamorphic near-eye display of FIG. 1A:

FIG. 26C is a schematic diagram illustrating a front view of the anamorphic near-eye display of FIG. 1A:

FIG. 27A is a schematic diagram illustrating a top view of polarisation state propagation in an alternative arrangement of anamorphic near-eye display apparatus;

FIG. 27B is a schematic diagram illustrating a top view of polarisation state propagation in an alternative arrangement of anamorphic near-eye display apparatus:

FIG. 28 is a schematic diagram illustrating in front view an intermediate waveguide of an anamorphic near-eye display apparatus comprising an input waveguide, a partial mirror, an intermediate waveguide and an extraction waveguide, wherein the lateral anamorphic component further comprises a planar reflective polariser and a quarter wave retarder arranged between the reflective end and the reflective polariser;

FIG. 29A is a schematic diagram illustrating a front perspective view of an anamorphic directional illumination device; and

FIG. 29B is a schematic diagram illustrating a front perspective view of a vehicle comprising a vehicle external light apparatus comprising the anamorphic directional illumination device of FIG. 29A.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) have equivalent birefringence.

The optical axis of an optical retarder refers to the direction of propagation of a light ray in the uniaxial birefringent material in which no birefringence is experienced. This is different from the optical axis of an optical system which may for example be parallel to a line of symmetry or normal to a display surface along which a principal ray propagates.

For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials the slow axis direction is the extraordinary axis of the birefringent material. For negative dielectric anisotropy uniaxial birefringent materials the fast axis direction is the extraordinary axis of the birefringent material.

The terms half a wavelength and quarter a wavelength refer to the operation of a retarder for a design wavelength λ₀ that may typically be between 500 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components; which is related to the birefringence Δn and the thickness d of the retarder with retardance Δn. d by:

Γ=2·π·Δn·d/λ₀ eqn. 1

In eqn. 1, Δn is defined as the difference between the extraordinary and the ordinary index of refraction, i.e.

Δn=nₑ−nₒ eqn. 2

For a half-wave retarder, the relationship between d, Δn, and λₒ is chosen so that the phase shift between polarization components is Γ=π. For a quarter-wave retarder, the relationship between d. An, and λₒ is chosen so that the phase shift between polarization components is Γ=π/2.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current description, the SOP may be termed the polarisation state.

A linear SOP has a polarisation component with a non-zero amplitude and an orthogonal polarisation component which has zero amplitude. A p-polarisation state is a linear polarisation state that lies within the plane of incidence of a ray comprising the p-polarisation state and a s-polarisation state is a linear polarisation state that lies orthogonal to the plane of incidence of a ray comprising the p-polarisation state. For a linearly polarised SOP incident onto a retarder, the relative phase r is determined by the angle between the optical axis of the retarder and the direction of the polarisation component.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter wave retarder arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

Achromatic retarders may be provided wherein the material of the retarder is provided with a retardance Δn. d that varies with wavelength λ as

Δn·d/λ=κ eqn. 3

where κ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

In the present disclosure an ‘A-plate’ refers to an optical retarder utilizing a layer of birefringent material with its optical axis parallel to the plane of the layer. The optical axis direction of the optical retarder is arranged to provide retardance in correspondence to the SOP of the incident light ray, for example to convert linearly polarised light to circularly polarised light, or to convert circularly polarised light to linearly polarised light.

The structure and operation of various anamorphic near-eye display apparatuses will now be described. In this description, common elements have common reference numerals. It is noted that the disclosure relating to any element applies mutatis mutandi to each device in which the same or corresponding element is provided. Accordingly, for brevity such disclosure is not repeated. Similarly, the various features of any of the following examples may be combined together in any combination.

It would be desirable to provide an anamorphic near-eye display apparatus 100 with a thin form factor, large freedom of movement, high resolution, high brightness and wide field of view. An anamorphic near-eye display apparatus 100 will now be described.

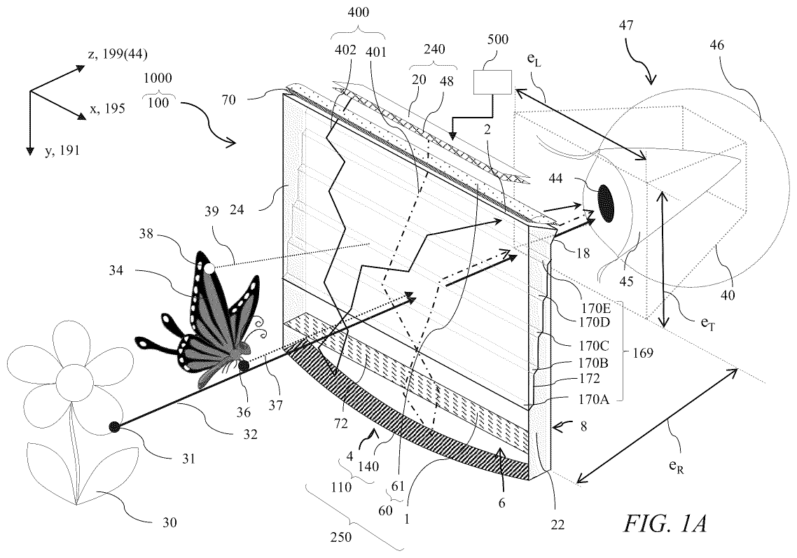

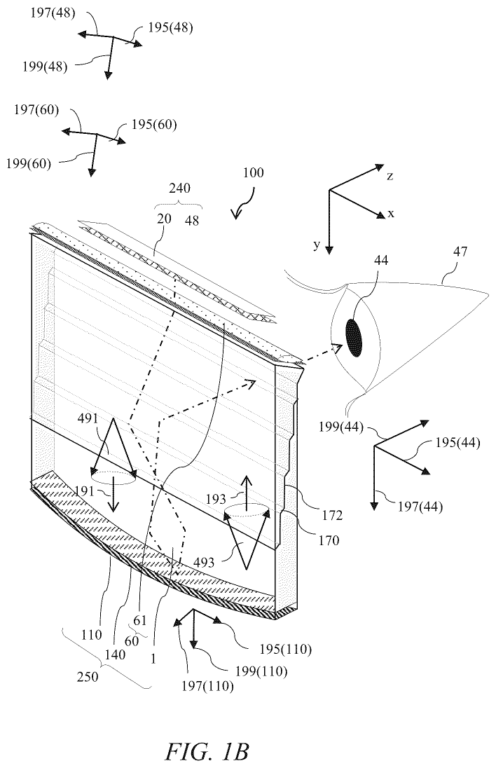

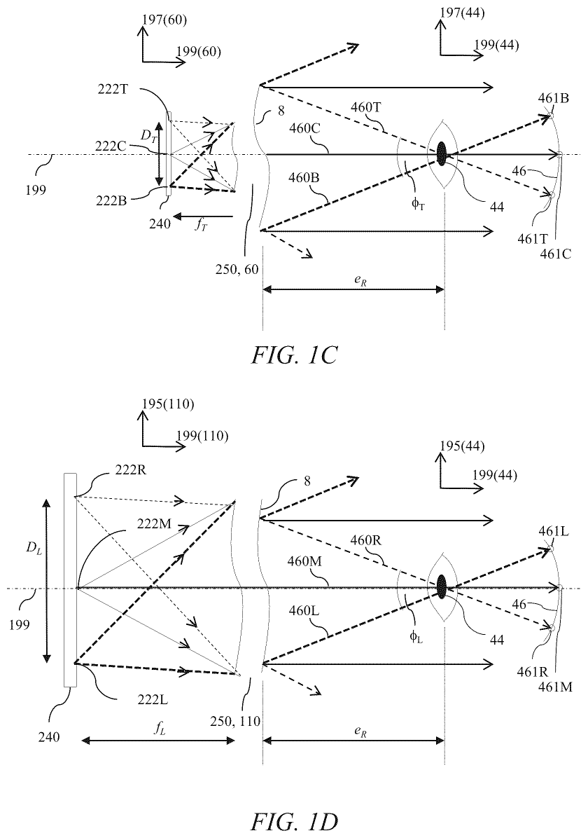

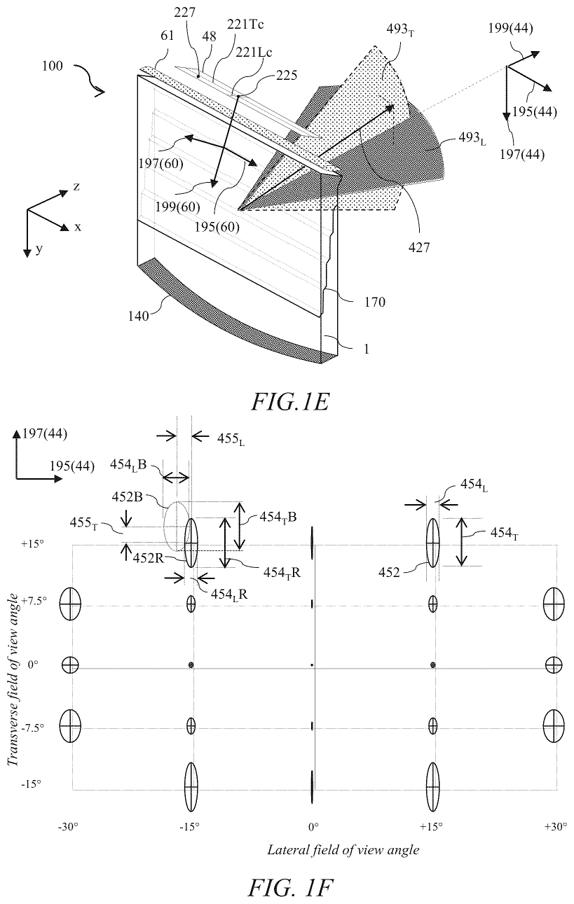

FIG. 1A is a schematic diagram illustrating a front perspective view of an anamorphic near-eye display apparatus 100; and FIG. 1B is a schematic diagram illustrating a front perspective view of the coordinate system arrangements for the anamorphic near-eye display apparatus 100 of FIG. 1A.

FIG. 1A illustrates an anamorphic directional illumination device 1000 which is an anamorphic near-eye display apparatus 100. In the present description, an anamorphic near-eye display apparatus 100 is provided near to an eye 45, to provide light to the pupil 44 of the eye 45 of an observer 47. In an illustrative embodiment, the eye 45 may be arranged at a nominal viewing distance e_{R} of between 5 mm and 100 mm and preferably between 8 mm and 20 mm from the output surface of the anamorphic near-eye display apparatus 100. Such displays are distinct from direct view displays wherein the viewing distance is typically greater than 100 mm. The nominal viewing distance e_{R} may be referred to as the eye relief.

The anamorphic near-eye display apparatus 100 comprises an illumination system 240 arranged to provide output light comprising illumination from a spatial light modulator 48 and an optical system 250 arranged to direct light from the illumination system 240 to the eye 45 of an observer 47. The illumination system 240 is arranged to output light rays 400 including illustrative light rays 401, 402 that are input into the optical system 250.

In operation, it is desirable that the spatial pixel data provided on the spatial light modulator 48 is directed to the pupil 44 of the eye 45 as angular pixel data. The lens of the observer's eye 45 relays the angular spatial data to spatial pixel data at the retina 46 of the eye 45 such that an image is provided by the anamorphic near-eye display apparatus 100 to the observer 47.

The pupil 44 is located in a spatial volume near to the anamorphic near-eye display apparatus 100 commonly referred to as the exit pupil 40, or eyebox. When the pupil 44 is located within the exit pupil 40, the observer 47 is provided with a full image without missing parts of the image, that is the image does not appear to be vignetted at the observer's retina 46. The shape of the exit pupil 40 is determined at least by the anamorphic imaging properties of the anamorphic near-eye display apparatus and the respective aberrations of the anamorphic optical system. The exit pupil 40 at a nominal eye relief distance e_{R} may have dimension e_{L} in the lateral direction 195 and dimension e_{T} in the transverse direction 197. The maximum eye relief distance e_{Rmax} refers to the maximum distance of the pupil 44 from the anamorphic near-eye display apparatus 100 wherein no image vignetting is present. In the present embodiment, increasing the size of the exit pupil 40 refers to increasing the dimensions e_{L}, e_{T}. Increased exit pupil 40 achieves an increased viewer freedom and an increase in e^{Rmax} as will be described further hereinbelow.

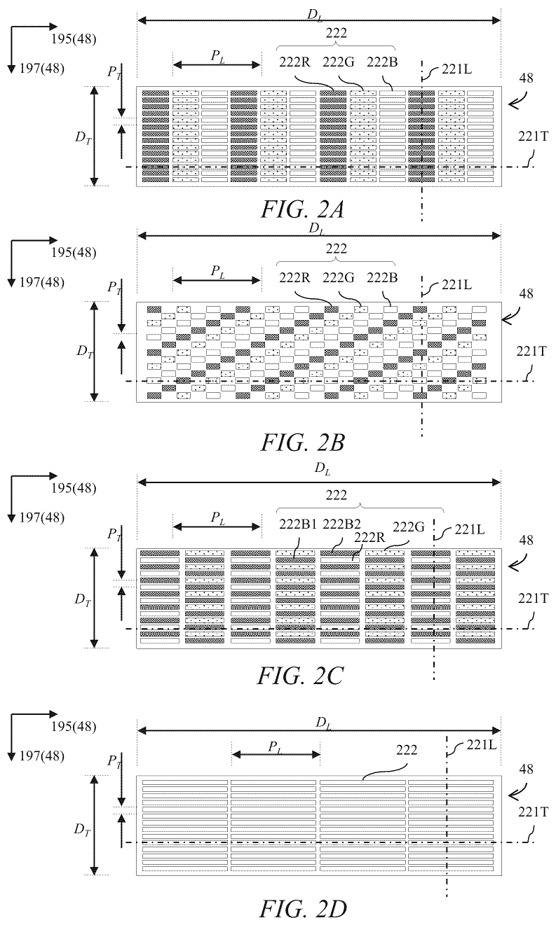

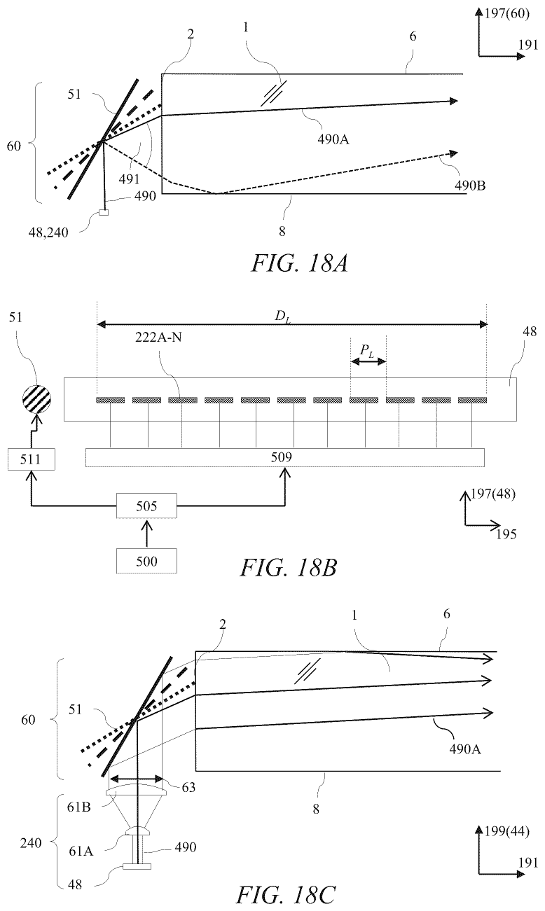

The spatial light modulator 48 comprises pixels 222 distributed at least in the lateral direction 195 as will be described further hereinbelow, for example in FIGS. 2A-D and FIG. 18A. In the illustrative embodiment of FIG. 1A, the illumination system 240 comprises a transmissive spatial light modulator 48 comprising an array of spatially separated pixels 222 distributed in a lateral direction 195(48) and transverse direction 197(48). In the embodiment of FIG. 1A, the spatial light modulator 48 is a TFT-LCD and illumination system 240 further comprises a backlight 20 arranged to illuminate the spatial light modulator 48.

The anamorphic near-eye display apparatus 100 further comprises a control system 500 arranged to operate the illumination system 240 to provide light that is spatially modulated in accordance with image data representing an image.

The optical system 250 comprises a transverse lens 61 that forms a transverse anamorphic component 60 in the embodiment of FIG. 1A, as discussed below. The transverse lens 61 comprises a cylindrical lens in this example.

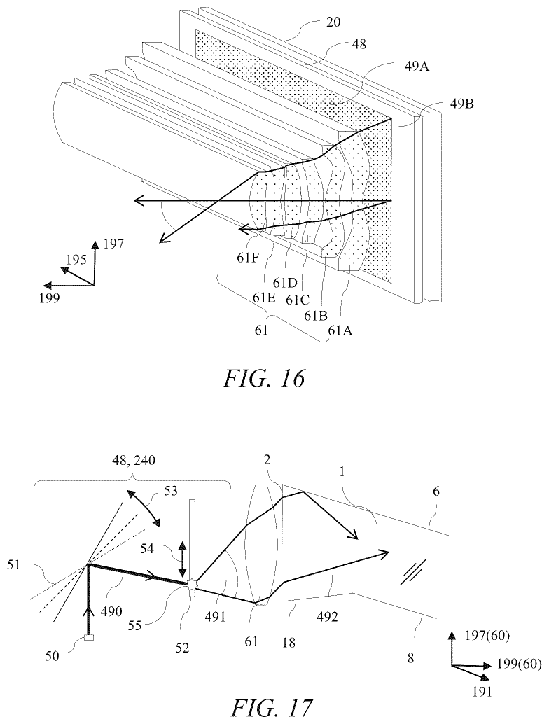

In the present disclosure, the term lens most generally refers to a single lens element or most commonly a compound lens (group of lens elements) as will be described hereinbelow in FIG. 16 for example; and is arranged to provide optical power. A lens may comprise a single refractive surface, multiple refractive surfaces, or reflective surfaces such that the lens may comprise a catadioptric lens element that combines refractive and reflective surfaces. A lens may further or alternatively comprise diffractive optical elements. A transverse lens is a lens that provides optical power in the transverse direction and may provide substantially no optical power in the lateral direction. A transverse lens may be termed a cylindrical lens, although the profile in cross section of the surface or surfaces providing optical power may be different to a segment of a circle, for example paraboloidal, elliptical or aspheric.

The transverse lens 61 in the embodiment of FIG. 1A is extended in a lateral direction 195(60) parallel to the lateral direction 195(48) of the spatial light modulator 48. The transverse anamorphic component 60 has positive optical power in a transverse direction 197(60) that is parallel to the direction 197(48) and orthogonal to the lateral direction 195(60); and no optical power in the lateral direction 195(60). The transverse anamorphic component 60 is arranged to receive light rays 400 from the spatial light modulator 48. The optical system 250 is arranged so that light output from the transverse anamorphic component 60 is directed in directions that are distributed in the transverse direction 197(60).

Mathematically expressed, for any location within the anamorphic near-eye display apparatus 100, the optical axis direction 199 may be referred to as the O unit vector, the transverse direction 197 may be referred to as the T unit vector and the lateral direction 195 may be referred to as the L unit vector wherein the optical axis direction 199 is the crossed product of the transverse direction 197 and the lateral direction 195:

O=T×L eqn.4

Various surfaces of the anamorphic near-eye display apparatus 100 transform or replicate the optical axis direction 199; however, for any given ray the expression of eqn. 4 may be applied.

The optical system 250 further comprises an extraction waveguide 1 arranged to guide light rays 400 in cone 491 from the transverse anamorphic component 60 to a lateral anamorphic component 110 along the extraction waveguide 1 in a first direction 191. The extraction waveguide 1 has opposing rear and front guide surfaces 6, 8 that are planar and parallel. The extraction waveguide 1 further has an input end 2 extending in the lateral and transverse directions 195(60), 197(60), the extraction waveguide 1 being arranged to receive light 400 from the illumination system 240 through the input end 2. The input end 2 extends in the lateral direction 195 between edges 22, 24 of the extraction waveguide 1, and extends in the transverse direction between opposing rear and front guide surfaces 6, 8 of the extraction waveguide 1.

The optical system 250 further comprises a light reversing reflector 140 arranged to reflect the light rays 400 in light cones 491 that have been guided along the extraction waveguide 1 so that the reflected light rays 400 in light cone 493 is guided along the extraction waveguide 1 in a second direction 193 opposite to the first direction 191 and so that reflected cone 493 is guided back through the extraction waveguide 1.

In the embodiment of FIG. 1A, the light reversing reflector 140 is a reflective end 4 of the extraction waveguide 1. Furthermore, the light reversing reflector 140 forms the lateral anamorphic component 110. In particular, the reflective end 4 of the extraction waveguide 1 has a curved shape in the lateral direction 195 that provides positive optical power, affecting the light rays in cone 491 in the lateral direction 195(110), and no power in the transverse direction 197(110). The optical system 250 is thus arranged so that light output from the lateral anamorphic component 110 is directed in directions that are distributed in the transverse direction 197(110) and the lateral direction 195(110). The curved shape of the reflective end 4 may be a shape that is the cross section of a sphere, ellipse, parabola or other aspheric shape to achieve desirable imaging of light rays from the spatial light modulator 48 to the pupil 44 of the eye 45 as will be described further hereinbelow.

The extraction waveguide 1 comprises an array of extraction reflectors 170 disposed internally within the extraction waveguide 1, the extraction reflectors 170 being arranged to transmit light guided 400 along the extraction waveguide 1 in the first direction 191 and to extract light guided along the extraction waveguide 1 in the second direction 193 towards an eye 45 of a viewer. The array of extraction reflectors 170 are distributed along the extraction waveguide 1 so as to provide exit pupil expansion.

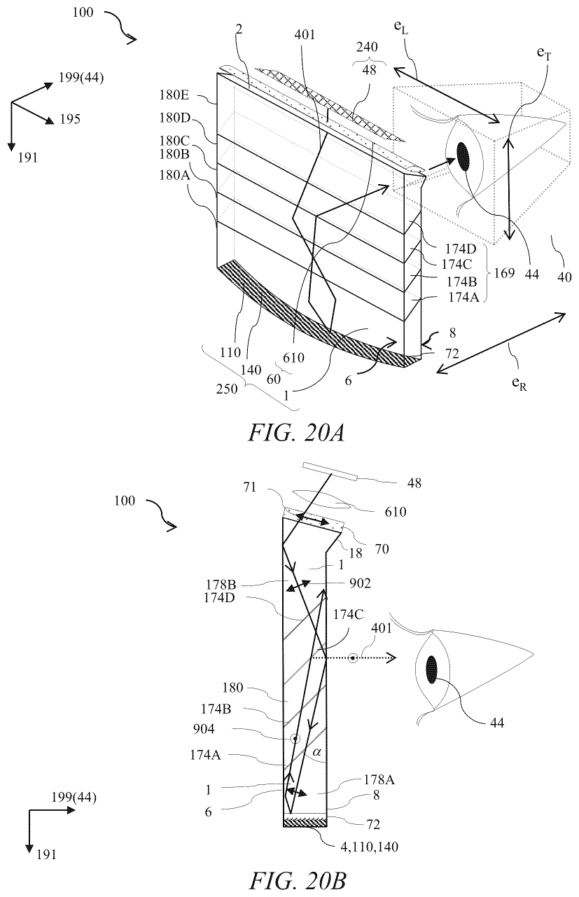

The extraction reflectors 170 are an example of reflective extraction features 169 and each comprises a set of layers that are reflective layers as will be described further hereinbelow. In other embodiments, such as described in FIGS. 20A-D, the function of the extraction reflectors 170 may be performed by any of the other forms of extraction features described herein, for example reflective extraction features 169 that are diffractive features, comprising phase gratings for example.

The extraction waveguide 1 is further arranged to receive light cone 493 from the transverse anamorphic component 60 and the lateral anamorphic component 110; and comprises an array of extraction reflectors 170A-E disposed internally within the extraction waveguide 1. The extraction reflectors 170 are inclined with respect to the first and second directions 191, 193 along the optical axis 199 of the extraction waveguide 1. The extraction reflectors 170 extend partially across the extraction waveguide 1 between the opposing rear and front guide surfaces 6, 8.

The extraction waveguide 1 comprises intermediate surfaces 172 extending along the extraction waveguide between adjacent pairs of extraction reflectors 170. In the embodiment of FIG. 1A, intermediate surfaces 172 are arranged between pairs of extraction reflectors 170A-B, 170B-C, 170C-D and 170D-E.

The extraction reflectors 170 are arranged to transmit at least some of light cone 491 guided along the extraction waveguide 1 in the first direction 191 and to extract at least some of light cone 493 guided back along the extraction waveguide 1 in the second direction 193 towards an eye 45 of a viewer 47 as will be described further hereinbelow.

The coordinate system and principle of operation of the anamorphic near-eye display apparatus 100 will now be further described. The optical system 250 has an optical axis 199 and has anamorphic properties in a lateral direction 195 and in a transverse direction 197 that are perpendicular to each other and perpendicular to the optical axis 199.

FIG. 1B illustrates the variation of optical axis 199 direction, lateral direction 195 and transverse direction 197 as light rays propagate through the optical system 250. In the present description, the lateral and transverse directions 195, 197 are defined relative to the optical axis 199 direction in any part of the illumination system 240 or optical system 250, and are not in constant directions in space. In the embodiment of FIG. 1B, the transverse direction 197(60) illustrates the transverse direction 197 at the transverse anamorphic component 60 formed by the transverse lens 61; the transverse direction 197(110) illustrates the transverse direction 197 at the lateral anamorphic component 110; and the transverse direction 197(44) illustrates the transverse direction 197 at the eye 45 of the observer 47. The transverse anamorphic component 60 has lateral direction 195(60) that is the same as the lateral direction 195(110) of the lateral anamorphic component 110 and the lateral direction 195(44) at the pupil 44 of the eye 45. The Euclidian coordinate system illustrated by x, y, z directions is invariant, whereas the transverse direction 197, lateral direction 195 and optical axis direction 199 may be transformed at various optical components, in particular by reflection from optical components, of the anamorphic near-eye display apparatus 100.

Further features of the arrangement of FIG. 1A will now be described.

The optical system 250 may comprise an input linear polariser 70 disposed between the spatial light modulator 48 and the extraction reflectors 170 of the extraction waveguide 1. In FIG. 1A, the input linear polariser 70 is arranged between the transverse anamorphic component 60 and the extraction waveguide 1. The input linear polariser 70 is an absorbing polariser such as a dichroic iodine polariser arranged to transmit a linear polarisation state and absorb the orthogonal polarisation state.

Further the optical system 250 may comprise a polarisation conversion retarder 72 disposed between the light reversing reflector 140 and the array of extraction reflectors 170. Polarisation conversion retarder 72 may be an A-plate with an optical axis direction arranged to convert linearly polarised light to circularly polarised light and circularly polarised light to linearly polarised light. In the embodiment of FIG. 1A, polarisation conversion retarder 72 is arranged with a light guiding portion of the extraction waveguide 1 arranged between the polarisation conversion retarder 72 and the light reversing reflector 140. Advantageously variations in flatness of the polarisation conversion retarder 72 do not provide image blur. In the alternative embodiment of FIG. 1B, the light reversing reflector 140 is arranged on the polarisation conversion retarder 72. Advantageously complexity of assembly may be reduced.

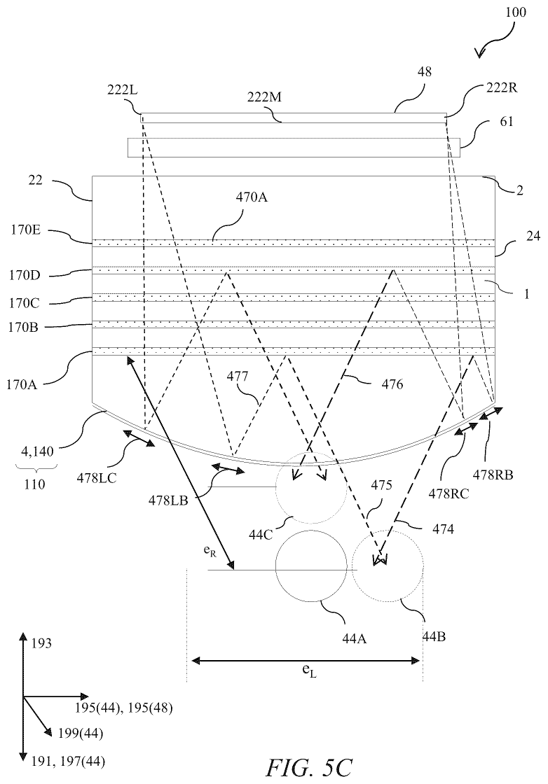

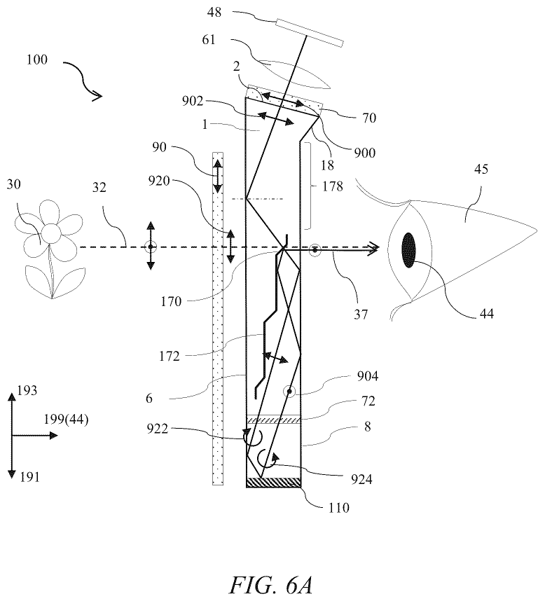

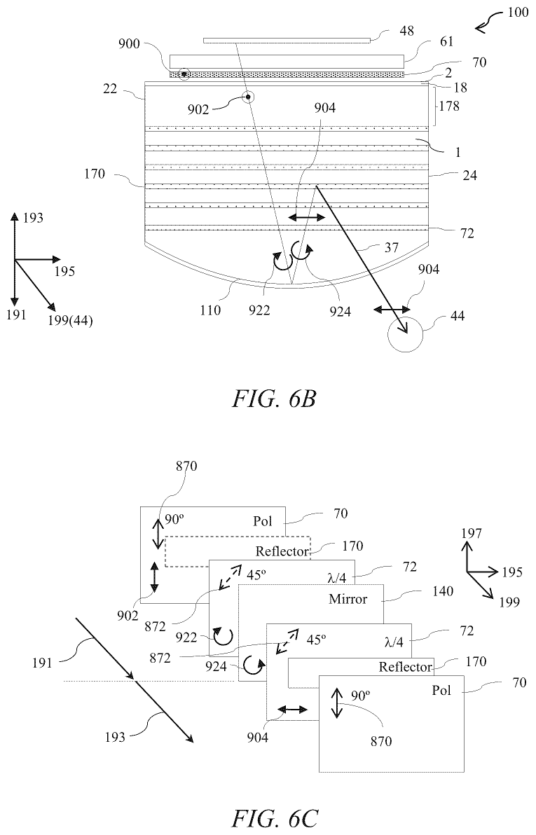

The operation of the input linear polariser 70 and polarisation conversion retarder 72 will be described further with respect to at least FIGS. 6A-F hereinbelow.

In operation extraction waveguide 1 is arranged to guide light rays 400 between the opposing rear and front guide surfaces 6, 8 as illustrated by the zig-zag paths of guided rays 401, 402.

In the first direction 191 at least some of the light rays 400 propagate through the extraction reflectors 170. Waveguide 1 further comprises a reflective end 4 arranged to receive the guided light rays 401, 402 from the input end 2. The lateral anamorphic component 110 comprises the reflective end 4 of the extraction waveguide 1 with a reflective material provided on the reflective end 4. The reflective material may be a reflective film such as ESR™ from 3M or may be an evaporated or sputtered metal material. In the embodiment of FIG. 1A, the lateral anamorphic component 110 is thus a curved mirror with positive optical power in the lateral direction 195 and no optical power in the transverse direction 197.

For light cone 493 propagating in the second direction 193, the extraction reflectors 170 are oriented to extract light guided back along the extraction waveguide 1 through the second light guiding surface 8 and towards the pupil 44 of eye 45 arranged in eyebox 40.

The operation of the anamorphic near-eye display apparatus 100 as an augmented reality display will now be further described.

The extraction waveguide 1 is transmissive to light that passes through the intermediate surfaces 172 such that on-axis real image point 31 on a real-world object 30 is directly viewed through the extraction waveguide 1 by light ray 32. Similarly virtual image 34 with aligned on-axis virtual pixel 36 is desirably viewed with virtual ray 37. Such virtual ray 37 is provided by on-axis light ray 401 after reflection from extraction reflector 170C to the pupil 44 of eye 45. Similarly off-axis virtual ray 39 for viewing of virtual pixel 38 is provided by off-axis ray 402 after reflection from the extraction reflector 170D. An augmented reality display with advantageously high transmission of external light rays 32 may be provided.

The imaging properties of the anamorphic near-eye display apparatus 100 will now be further described using an unfolded schematic representation wherein said transformations of coordinates are removed for purposes of explanation.

FIG. 1C is a schematic diagram illustrating a side view of the operation of an anamorphic near-eye display apparatus 100 in a transverse plane, and FIG. 1D is a schematic diagram illustrating a side view of the operation of an anamorphic near-eye display apparatus 100 in a lateral plane orthogonal to the transverse plane, and FIG. 1E is a schematic diagram illustrating a front perspective view of the mapping of the coordinate system for the anamorphic near-eye display apparatus 100 of FIG. 1A. Features of the embodiment of FIGS. 1C-E not discussed in further detail may be assumed to correspond to the features with equivalent reference numerals as discussed above, including any potential variations in the features.

For illustrative purposes, in FIGS. 1C-D, the variation of optical axis direction 199 as illustrated in FIGS. 1A-B is omitted. FIGS. 1C-D illustrate the principle of operation of the anamorphic near-eye display apparatus 100 of FIG. 1A in unfolded illustrative arrangements to achieve a near-eye image with lateral and transverse fields of view ϕ_{T} and ϕ_{L} that are the same to the observer 47, that is for illustrative purposes a square image is provided to the retina 46. The pupil 44 is shown as at the common viewing distance e_{R} from the output light guiding surface 8 of the optical system 250.

FIG. 1C illustrates the transverse imaging property of the anamorphic near-eye display apparatus 100. Illumination system 240 is provided with top, centre and bottom illuminated pixels 222T, 222C, 222B across the transverse direction 197 with light rays output into the transverse anamorphic component 60 with optical power only in the transverse direction that collimates the output from each pixel 222L, 222C, 222R and directs towards the eye 45. Light rays 460T pass through the pupil 44 of the eye 45 onto the retina 46 of the eye 45 and create an off-axis image point 461T. Light rays 460C pass onto the retina 46 and create centre image point 461C and light rays 460B pass onto the retina 46 and create off-axis image point 461B.

FIG. 1D illustrates the lateral imaging property of the anamorphic near-eye display apparatus 100. Illumination system 240 is provided with right, middle and left illuminated pixels 222L, 222M, 222R across the lateral direction 195 with light rays output into the lateral anamorphic component 110 with optical power only in the lateral direction that collimates the output from each pixel 222L, 222M, 222R and directs towards the pupil 44 of the eye 45. Light rays 460L pass through the pupil 44 of the eye 45 onto the retina 46 of the eye 45 and create an off-axis image point 461L. Light rays 460M pass onto the retina 46 and create image point 461M and light rays 460R pass onto the retina 46 and create an image point 461R.

The observer perceives a magnified virtual image with the optical system 250 arranged between the virtual image 34 and the eye 45, with the same field of view ϕ in each of lateral and transverse directions 195, 197.

In the anamorphic near-eye display apparatus 100 of the present embodiments, the distance f_{T} between the first principal plane of the transverse anamorphic component 60 of the optical system 250 is different to the distance f_{L} between the first principal plane of the lateral anamorphic component 110 of the optical system 250. Similarly, for a square output field of view (ϕ_{T} is the same as ϕ_{L}), the separation D_{T} of pixels 222T, 222B in the transverse direction is different to the separation D_{L} of pixels 222R, 222L in the lateral direction 195.

In the present description, the lateral angular magnification M_{L} provided by the lateral anamorphic component 110 of the optical system 250 may be given as

M_{L}=ϕp_{L}/P_{L} eqn. 5
and the transverse angular magnification M_{T} provided by the transverse anamorphic component 60 of the optical system 250 may be given as:

M_{T}=ϕp_{L}/P_{T} eqn. 6

where ϕp_{L} is the angular size of a virtual pixel 36 seen by the eye in the lateral direction 195, P_{L} is the pixel pitch in the lateral direction 195, ϕp_{T} is the angular size of a virtual pixel 36 seen by the eye in the transverse direction 197, and P_{T} is the pixel pitch in the transverse direction 197. In the case that the angular virtual pixels 36 are square, then ϕp_{L} and ϕp_{T} are equal and the angular magnification provided by the lateral anamorphic component 110 may be given as:

M_{L}=M_{T}*P_{T}/P_{L} eqn. 7

The angular magnification M_{L}, M_{T} of the lateral and transverse anamorphic optical elements 110, 60 is proportional to the respective optical power K_{L}, K_{T} of said elements 60, 110. The spatial light modulator 48 may comprise pixels 222 having pitches P_{L}, P_{T} in the lateral and transverse directions 195, 197 with a ratio P_{L}/P_{T} that is the same as K_{T}/K_{L}, being the inverse of the ratio of optical powers of the lateral and transverse anamorphic optical elements 110, 60.

The output coordinate system is illustrated in FIG. 1E wherein output light from a central pixel 225 is directed along optical axis 199(60) through the transverse anamorphic component 60 and into the extraction waveguide 1, from which it is visible along the optical axis 199(44) at the pupil 44.

The row 221Tc of pixels 222 through the central pixel 225 that is extended in the lateral direction 195 is output as fan 493_{L} of rays, each ray representing the angle at which a virtual pixel 38 is provided to the pupil 44 across the lateral direction 195.

The column 221Lc of pixels 222 through the central pixel 225 that is extended in the transverse direction 197 is output as fan 493_{T} of rays, each ray representing the angle at which a virtual pixel 38 is provided to the eye 45 across the transverse direction 197.

For a pixel 227 arranged in a quadrant of the spatial light modulator 48 an output ray 427 is provided to the pupil 44 that is imaged first by the transverse anamorphic component 60 and then by the lateral anamorphic component 110.

Illustrative imaging properties of the anamorphic near-eye display apparatus 100 of FIG. 1A will now be described.

FIG. 1F is a schematic diagram illustrating a field-of-view plot of the output of the anamorphic near-eye display apparatus 100 of FIG. 1A for polychromatic illumination.

FIG. 1F is a graph of the transverse viewing angle against the lateral viewing angle. The lateral field of view ϕ_{L} is 60 degrees and the transverse field of view ϕ_{T} is 60 degrees.

Points with 0 degrees lateral field of view lie in the transverse light cone 493_{L}, while points with 0 degrees transverse field of view lie in the transverse light cone 493_{T}. The relative aberrations at various image points are illustrated by blur point spread functions 452.

The lateral size 454_{L} and transverse size 454_{T} of the blur PSF 452 is determined by aberrations of the optical system 250. The elliptical blur PSF 452 is an illustrative profile of the relative blurring from a point at a pixel 227 on the spatial light modulator 48 when output as an angular cone to the eye 45 and thus represents the relative PSF size and location at the retina 46 of the eye 45 in the lateral and transverse directions 195, 197.

For illustrative purposes the blur point spread function (PSF) 452 is illustrated in FIG. 1F as an ellipse with lateral and transverse sizes 454_{L}, 454_{T}. More generally the shape of the blur PSF may be circular, elliptical, comatic, astigmatic or other profile, which may include scatter artefacts. The blur elliptical PSF 452 profile as illustrated may be used to describe the weighted blur PSF 452 in the lateral and transverse directions 195, 197. For illustrative reasons, the sizes 454_{T}, 454_{L} of the blur PSF 452 are illustrated as magnified on the scale of the plot of FIG. 1F, and do not represent the actual angular size of the blurring of each angular pixel at the pupil 44.

The sizes 454_{T}R, 454_{L}R of the blur PSF 452R for red pixels 222R may be different to the sizes 454_{T}B, 454_{L}B for the blur PSF 452B for blue pixels 222B. Further the centre of gravity of the blur PSF 452B may be displaced in lateral and transverse directions 195, 197 by colour blur 455_{L}, 455_{T} respectively.

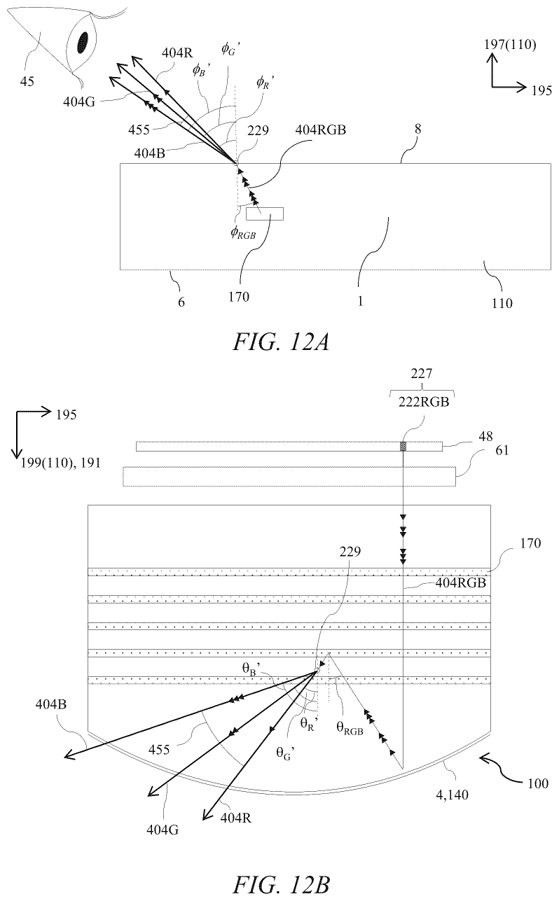

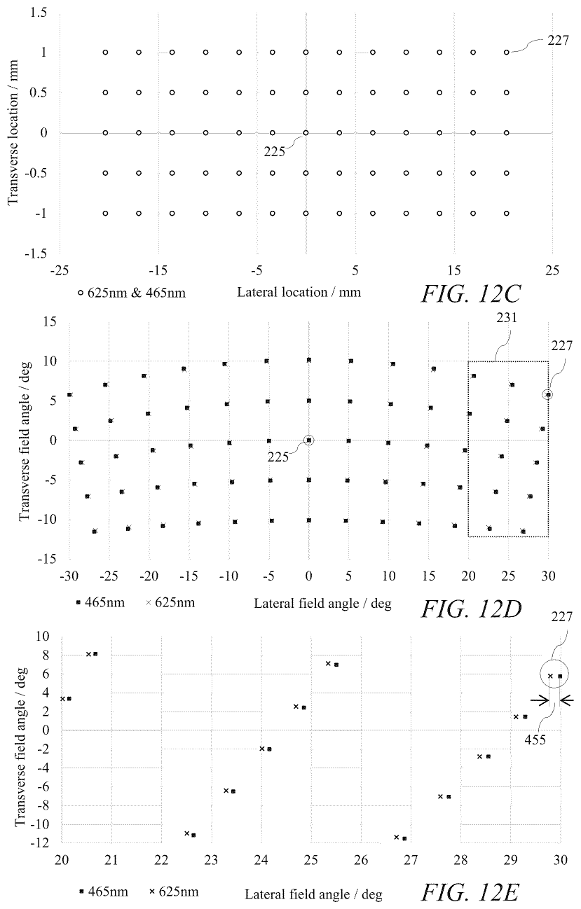

Chromatic aberration for an illustrative anamorphic near-eye display apparatus 100 is described further in FIGS. 12A-E hereinbelow.

Illustrative arrangements of pixels 222 of the spatially multiplexed spatial light modulator 48 will now be described.

FIGS. 2A-C are schematic diagrams illustrating in front view a spatial light modulator 48 for use in the anamorphic near-eye display apparatus 100 of FIG. 1A comprising spatially multiplexed red, green and blue sub-pixels 222R, 222G, 222B. Features of the embodiments of FIGS. 2A-C not discussed in further detail may be assumed to correspond to the features with equivalent reference numerals as discussed above, including any potential variations in the features.

The spatial light modulator 48 may be a transmissive spatial light modulator 48 such as an LCD as illustrated in FIG. 1A. Alternatively the spatial light modulator 48 may be a reflective spatial light modulator 48 such as Liquid Crystal on Silicon (LCOS) or a Microoptoelectromechanical (MOEMS) array of micro-mirrors such as the DMD from Texas Instruments. Alternatively the spatial light modulator 48 may be an emissive spatial light modulator 48 using material systems such as OLED or inorganic micro-LED. A silicon backplane may be provided to achieve high speed addressing of high resolution arrays of pixels 222.

In FIGS. 2A-C, the pixels 222 of the spatial light modulator 48 are distributed in the lateral direction 195(48) and also distributed in the transverse direction 197(48) so that the light output from the transverse anamorphic component 60 is directed in the directions that are distributed in the transverse direction 197 and the light output from the lateral anamorphic component 110 is directed in the directions that are distributed in the lateral direction 195 when output towards the pupil 44 of the eye 45.

White pixels 222 comprising red, green and blue sub-pixels 222R, 222G, 222B are provided spatially separated in the lateral direction 195 and the sub-pixels 222R, 222G, 222B are elongate with a pitch P_{L} in the lateral direction that is greater than the pitch P_{T} in the transverse direction 197.

Considering FIGS. 1C-D and the embodiments of FIGS. 2A-D, it may be desirable to provide square white pixels in the final perceived virtual image 34. The pitch P, is magnified by the lateral anamorphic component to an angular size ϕ_{L} (with spatial pitch δ_{L} at the retina 46) and the pitch P_{T} is magnified by the transverse anamorphic component to an angular size ϕ_{L} (with spatial pitch δ_{L} at the retina 46). The pitches P_{L}, P_{T} may be determined by said different angular magnifications to advantageously achieve square angular pixels from the anamorphic near-eye display apparatus 100.

The pixels 222 are arranged as columns 221L, wherein the columns 221L are distributed in the lateral direction 195, and the pixels along the columns 221L are distributed in the transverse direction 197; and the pixels 222 are further arranged as rows 221T, wherein the rows 221T are distributed in the transverse direction 197, and the pixels along the rows 221T are distributed in the lateral direction 195.

In FIG. 2A, the sub-pixels 222R, 222G, 222B are distributed in columns of red, green, and blue pixels. Advantageously vertical and horizontal image lines may be provided with high fidelity.

In the alternative embodiment of FIG. 2B, the sub-pixels 222R, 222G, 222B are distributed along diagonal lines. Advantageously reproduction of natural imagery may be improved in comparison to the embodiment of FIG. 2A.

The sub-pixels 222R, 222G, 222B may be provided by white light emission and patterned colour filters, or may be provided by direct emission of respective coloured light. The present embodiments comprise sub-pixel 222 pitch P_{L} that is larger than other known arrangements comprising a symmetric input lens for thin waveguides.

In the alternative embodiment of FIG. 2C, multiple blue pixels 222B1 and 222B2 may be provided. The blue pixels 222B1, 222B2 may be driven with reduced current for a desirable output luminance. Advantageously the lifetime of the pixels may be improved, for example when the spatial light modulator 48 is provided by an OLED microdisplay. In other embodiments, additional or alternative white pixels (for example with no colour filters) or a fourth colour such as yellow may be provided. Colour gamut and/or brightness and efficiency may advantageously be achieved.

FIG. 2D is a schematic diagram illustrating in front view a spatial light modulator 48 for use in the anamorphic near-eye display apparatus 100 of FIG. 1A with pixels 222 for use with temporally multiplexed spectral illumination. Features of the embodiment of FIG. 2D not discussed in further detail may be assumed to correspond to the features with equivalent reference numerals as discussed above, including any potential variations in the features.

The spatial light modulator 48 may be used for monochromatic illumination. In alternative embodiments wide colour gamut imagery may be provided by time sequential illumination, for example by red, green and blue illumination in synchronisation with red, green and blue image data provided on the spatial light modulator 48. Advantageously image resolution may be increased.

In comparison to non-anamorphic image projectors in which equal angular magnification is provided between the lateral direction 195 and transverse direction 197, the present embodiments provide pixel pitch P_{L} that is substantially increased in size for a given angular image size and magnification in the transverse direction 197. Such increased size may advantageously achieve increased brightness, increased efficiency and reduced alignment tolerances for the spatial light modulator 48 and illumination system 240.

In colour filter type spatial light modulators 48, the size of colour filters may be increased. Advantageously cost and complexity of colour filters may be reduced. The aperture ratio of the pixels 222 may be increased. In direct emission displays the size of the emitting region may be increased. Advantageously cost and complexity of fabricating the pixels may be reduced and brightness increased. In inorganic micro-LED spatial light modulators 48, efficiency loss due to recombination losses at the edges of pixels may be reduced and system efficiency and brightness advantageously increased.

Input of light into the anamorphic near-eye display apparatus 100 of FIG. 1A will now be further described.

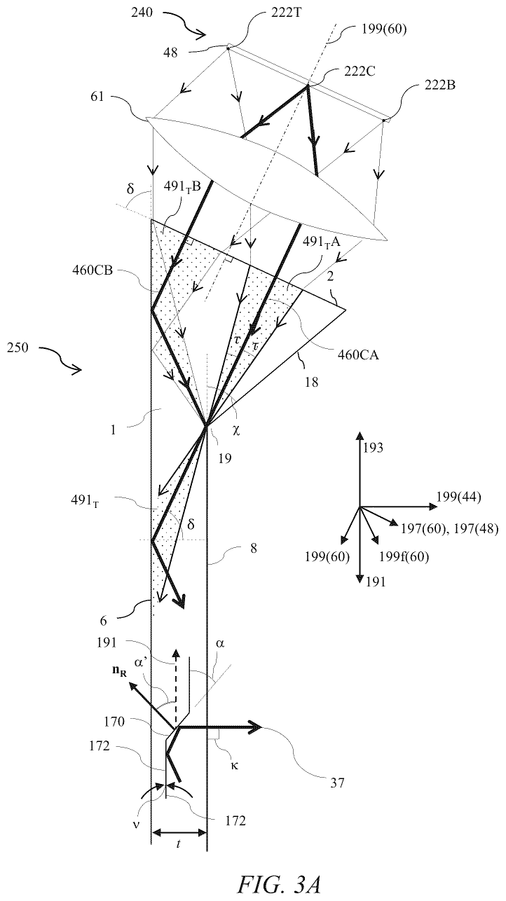

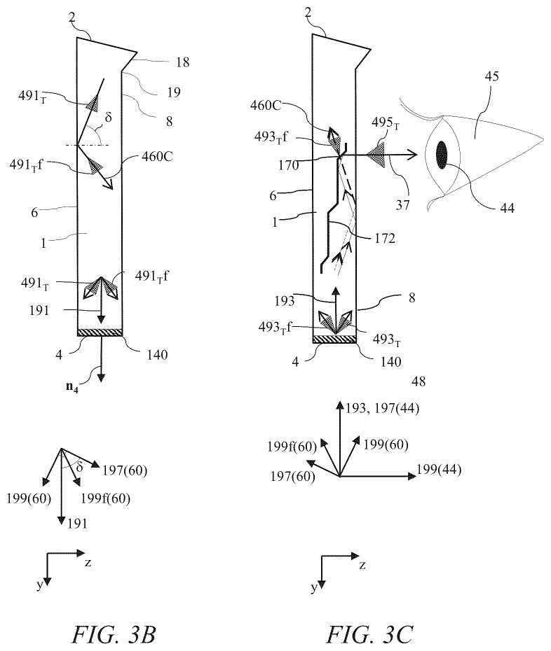

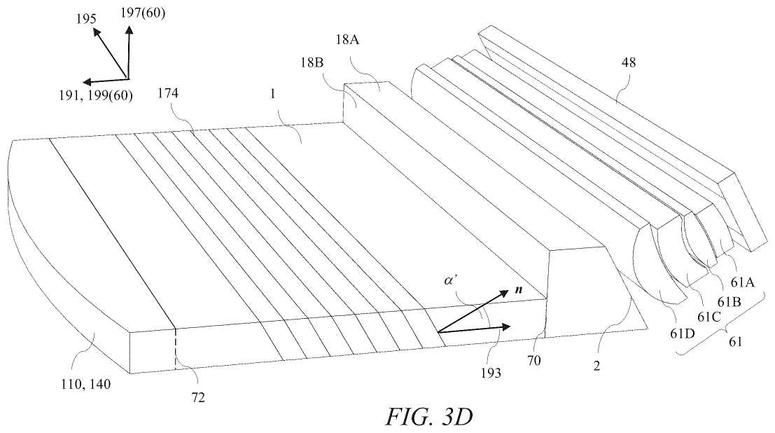

FIG. 3A is a schematic diagram illustrating a side view of light input into the extraction waveguide 1; FIG. 3B is a schematic diagram illustrating a side view of light propagation along the first direction 191 in the extraction waveguide 1; FIG. 3C is a schematic diagram illustrating a side view of light extraction from the extraction waveguide 1; and FIG. 3D is a schematic diagram illustrating a schematic perspective view of an optical design for an anamorphic near-eye display apparatus 100. Features of the embodiments of FIGS. 3A-D not discussed in further detail may be assumed to correspond to the features with equivalent reference numerals as discussed above, including any potential variations in the features.

The input of transverse light cones 491_{T} into the extraction waveguide 1 will now be described with reference to FIG. 3A.

In the illustrative embodiment of FIG. 3A, the input end 2 of the extraction waveguide 1 is inclined, in particular having a surface normal that is inclined at angle δ with respect to the surface normal to the rear and front guide surfaces 6, 8, that is the input end 2 is inclined at angle F with respect to the first and second directions 191, 193 along the extraction waveguide 1.

Spatial light modulator 48 and transverse anamorphic component 60 formed by the transverse lens 61 are inclined at the angle δ with respect to the normal to the rear and front guide surfaces 6, 8. The direction of the optical axis 199(60) through the transverse anamorphic component 60 is thus inclined with respect to the first and second directions 191, 193 along the extraction waveguide 1. The optical axis 199(60) direction is typically parallel to the surface normal of the input end 2, such that the optical axis direction 199(60) is inclined at the angle 90-δ with respect to the first and second direction 191, 193. Referring to FIG. 1F, advantageously improved aberrations may be achieved and the size 454 of the pixel blur PSF 452 may be reduced in at least the transverse direction 197.

The optical system 250 further comprises a tapered surface 18 that is a surface inclined at angle δ provided near the input end 2 to direct light bundles in the transverse direction 197 from the transverse anamorphic component 60 into the extraction waveguide 1 at desirable angles of propagation. The tapered surface 18 is arranged between the input end 2 and the light guiding surface 8, with surface normal direction inclined at an angle δ with respect to the surface normal to the light guiding surface 8. In alternative embodiments, the tapered surface 18 may be arranged on the first light guiding surface 6.

TABLE 1 shows an illustrative embodiment of the geometry of the arrangement of FIG. 3A for an extraction waveguide 1 refractive index of 1.5.

TABLE 1

| | Illustrative |
|---|---|
| Angle compared to direction 191 along the waveguide | embodiment |
| Input side 2 inclination δ | 60° |
| Tapered surface 18 inclination χ | 44° |
| Cone 491_{T} half angle in the material of the waveguide, τ | 10° |
| Extraction reflector 170 tilt angle α | 60° |
| Intermediate surface 172 tilt angle ν | 0° |
| Angle of incidence of central output ray 460 C. at | 90° |
| output surface, 8 κ | |

Central pixel 222C provides illumination to the transverse anamorphic component 60 with illustrative light rays 460CA, 460CB. Light ray 460CA is input through the input end 2 without deflection and is directed to just miss the interface 19 of the tapered surface 18 and the second light guiding surface 8, and is thus undeflected. Light ray 460CB is however incident on the region of the first light guiding surface 6 opposite the tapered surface 18 and is reflected by total internal reflection to the same interface 19, at which it is just totally internally reflected, such that the rays 460CA, 460CB overlap and are guided in the first direction 191 along the extraction waveguide 1.

The extraction reflectors 170 desirably have a surface normal direction n_{R} that is inclined with respect to the direction 191 along the waveguide by an angle α′ (which in FIG. 3A is 90-x) in the range 20 to 40 degrees, preferably by an angle in the range 25 to 35 degrees and most preferably by an angle in the range 27.5 degrees to 32.5 degrees. Advantageously such an arrangement reduces stray light rays.

In alternative embodiments, the extraction reflectors may have an angle α′ that is in the range 50 to 70 degrees, preferably have an angle in the range 55 to 65 degrees and most preferably have an angle in the range 57.5 degrees to 62.5 degrees. Such arrangement directs light ray 460C through the light guiding surface 8 when the ray has not reflected from the intermediate surface 172 after reflection from the light guiding surface 8.

The embodiment of TABLE 1 illustrates a design for refractive index of 1.5. The refractive index of the extraction waveguide 1 may be increased, for example to a refractive index of 1.7 or greater. Advantageously the size of the light cone ϕ_{T} may be increased and a larger angular image seen in the transverse direction.

The outer pixels 222T, 222B in the lateral direction 195(48) define the outer limit of light cones 491_{T}A, 491_{T}B that propagate at angles T either side of rays 460CA, 460CB. The tapered surface 18 is provided such that the whole of the light cone 491_{T}A is not deflected near to the input end 2, advantageously achieving reduced cross-talk and high efficiency. After the light cones 491_{T}A, 491_{T}B pass the interface 19, then they recombine to propagate along the extraction waveguide 1.

The propagation of transverse light cones 491_{T} along the extraction waveguide 1 in the first direction 191 will now be described with reference to FIG. 3B for which the extraction reflectors 170 are omitted for clarity of explanation.

Considering FIG. 3B, the propagation of light rays in cone 491 that are distributed in the transverse direction 197 are illustrated. On-axis light ray 37 from a central pixel 222 of the spatial light modulator 48 is directed through the transverse anamorphic component 60 into the extraction waveguide 1.

The direction of the optical axis 199(60) through the transverse anamorphic component 60 is inclined at angle δ that is inclined at angle 90-δ to the first direction 191 along the extraction waveguide 1.

After the interface 19, the light cone 491_{T} is incident on the first light guiding surface 6 with an angle of incidence δ and is reflected by total internal reflection such that a replicated light cone 491_{T}f is provided propagating along the extraction waveguide 1 in the direction 191.

FIG. 3C illustrates the propagation of corresponding reflected light cones 493_{T}, 493_{T}f after reflection at the light reversing component 140. In the transverse direction, the lateral anamorphic component 110 has no optical power and has a surface normal direction n₄ that is desirably parallel to the first directions 191, 193. The visibility of artefacts arising from stray light including double images and ghost images may be reduced.

The reflected light cones 493_{T}, 493_{T}f propagate along the second direction 193 with angle r about optical axes 199(60) and 199f(60). Corresponding transverse directions 197(60), 197f(60) are also indicated.

Both cones 493_{T}, 493_{T}f comprise image data that between the cones 493_{T}, 493_{T}f is flipped about the direction 191 and thus provides degeneracy of ray directions for a given pixel 222 on the spatial light modulator 48. It is desirable to remove such degeneracy so that only one of the cones 493_{T}, 493_{T}f is extracted and a secondary image is not directed to the pupil 44 of the eye 45.

Central output light ray 37 propagates by total internal reflection of opposing surfaces 6, 8 until it is incident on an intermediate surface 172 at which at least some light is reflected, and then at extraction reflector 170 at which at least some light is further reflected as will be described further hereinbelow such that light cone 493_{T} is preferentially directed towards the second light guiding surface 8. After refraction at the light guiding surface 8, light in the cone 495_{T} is extracted towards the eye 45, with a cone angle that has increased size compared to the cone 493_{T}.

The extraction reflectors 170A-E are inclined at the same angle, a such that for each of the light extraction reflectors 170A-E of FIG. 1A, the light cones 493_{T} are parallel and image blur for light extracted to the pupil 44 from different extraction reflectors 170 across the waveguide is advantageously reduced.

By way of comparison, the light cone 493_{T}f around central light rays 460C which are incident on the surface 8 and then are directly incident on extraction reflector 170 without first reflecting from the intermediate surface 72 have an angle of incident that is different to the angle of incident 6. The difference in angle of incidence provides for preferential transmission through the extraction reflector 170, and light cone 493_{T}f is not directed towards the eye 45. Degeneracy is reduced or removed and image cross-talk advantageously reduced.

The inclined input end 2 and inclined transverse anamorphic component 60 thus provide cones 493_{T}, 493_{T}f that are not overlapping with one of said cones preferentially extracted towards the eye 45 and the other cone preferentially retained within the extraction waveguide. The tilted input end 2 and tilted transverse anamorphic component 60 thus advantageously achieve a single image visible to the eye 45 and double images are minimised. In some of the illustrative embodiments hereinbelow, the surface normal of the input end 2 is not inclined to the first and second directions 191, 193, however that is to simplify the illustrations hereinbelow rather than a typical arrangement.

In alternative embodiments (not shown), the central output ray 37 may be inclined to the surface normal to the light guiding surface 8, for example to adjust the angular location of the centre of the field of view of the extracted light cone 495_{T}.

In the alternative embodiment of FIG. 3D, for extraction of light, the waveguide 1 comprises extraction features that are reflective extraction reflectors 174 disposed internally within the extraction waveguide 1 and extending the entire way between the front and rear light guiding surfaces 6, 8. This is an alternative to the extraction reflectors 170 shown in FIG. 1 that extend partially across the extraction waveguide 1 between the opposing rear and front guide surfaces 6, 8, although such extraction features 170 as shown in FIG. 1A could alternatively be employed.

In the alternative embodiment of FIG. 3D, the tapered surface 18 is provided by two surfaces 18A, 18B. Such surfaces 18A, 18B may be arranged to transmit or absorb light that is incident thereon. Advantageously the visibility of stray light rays that are incident onto the surfaces 18A, 18B may be reduced. Image contrast may be improved. FIG. 3D further illustrates compound lens 61 comprising component lenses 61A-D and has surface profiles that are representative of the optical design used for FIGS. 12A-E described hereinbelow.

The extraction reflectors may have a surface normal direction n that may be inclined with respect to the direction along the waveguide 193 by an angle α′ in the range 20 to 40 degrees, preferably by an angle α′ in the range 25 to 35 degrees and most preferably by an angle α′ in the range 27.5 degrees to 32.5 degrees. Said desirable surface normal n directions may reduce the visibility of a flipped image in the transverse direction 197. Such reduction of visibility is for example as illustrated in FIG. 3C by light cone 493_{T}f that would comprise the flipped image and is not extracted and light cone 495_{T} that comprises the un-flipped image.

Exit pupil 40 expansion in the transverse direction 197 will now be described.

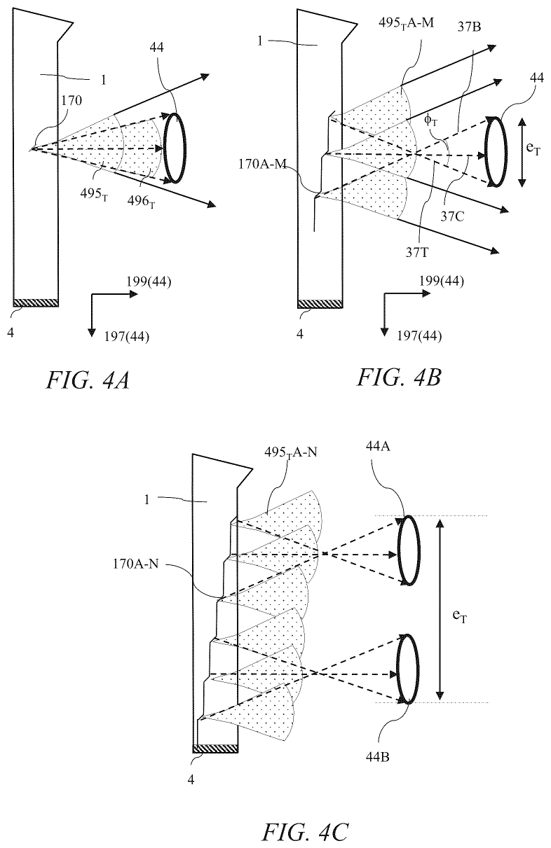

FIG. 4A is a schematic diagram illustrating a side view of light output from the anamorphic near-eye display apparatus 100 for a single extraction reflector 170; FIG. 4B is a schematic diagram illustrating a side view of light output from the anamorphic near-eye display apparatus 100 for multiple extraction reflectors 170A-N to achieve a full ray cone input in the transverse direction 197(44) into the observer's pupil 44; and FIG. 4C is a schematic diagram illustrating a side view of light output from the anamorphic near-eye display apparatus 100 for multiple locations for a moving observer 47 in the transverse direction 197(44). Features of the embodiments of FIGS. 4A-C not discussed in further detail may be assumed to correspond to the features with equivalent reference numerals as discussed above, including any potential variations in the features.

The array of extraction reflectors 170 are distributed along the extraction waveguide 1 so as to provide exit pupil 40 expansion that is increasing the size e_{T} of the eyebox 40 in the transverse direction 197 as will now be described.

The extraction reflectors 170 extend partially across the extraction waveguide 1 between opposing rear and front guide surfaces 6, 8 of the extraction waveguide 1 with successively shifted positions. The successively shifted positions are arranged along the waveguide in the direction 191. In other words, in the transverse direction 197 the extraction reflectors 170 extend partially across the extraction waveguide 1 with successively shifted positions.

Considering FIG. 4A, a single extraction reflector 170 is arranged to output light cone 495-r towards the pupil 44. However, the limited size of the pupil 44 determines that only those light rays within the partial light cone 496_{T} are received by the eye 45 and the field of view of the image observed on the retina in the transverse direction 197(44) is smaller than that input into the extraction waveguide 1. It would be desirable to increase the field of view of observation.

Considering FIG. 4B, multiple extraction reflectors 170A-M are provided sufficient to provide light rays 37C, 37T, 37B from the full cone 495_{T}. The pupil 44 has a height greater than the pitch of the extraction reflectors 170. For example the pitch of the extraction reflectors 170 may be 1 mm and the nominal diameter of the pupil 44 may be 3 mm to 6 mm. The pupil receives light from multiple extraction reflectors 170A-M, and the field of view ϕ_{T} observed is the same as that input into the extraction waveguide 1 at the input end. The exit pupil 40 has a size e_{T} that is the same as the pupil 44 height in this limiting case.

Considering FIG. 4C, further extraction reflectors 170A-N are provided sufficient to provide movement of the pupil 44 between pupil 44A location and pupil 44B location. In this manner eE_{T} is increased and exit pupil expansion in the transverse direction is achieved. A transverse field of view r is provided over an extended pupil 44 location advantageously achieving increased comfort of use and full image visibility.

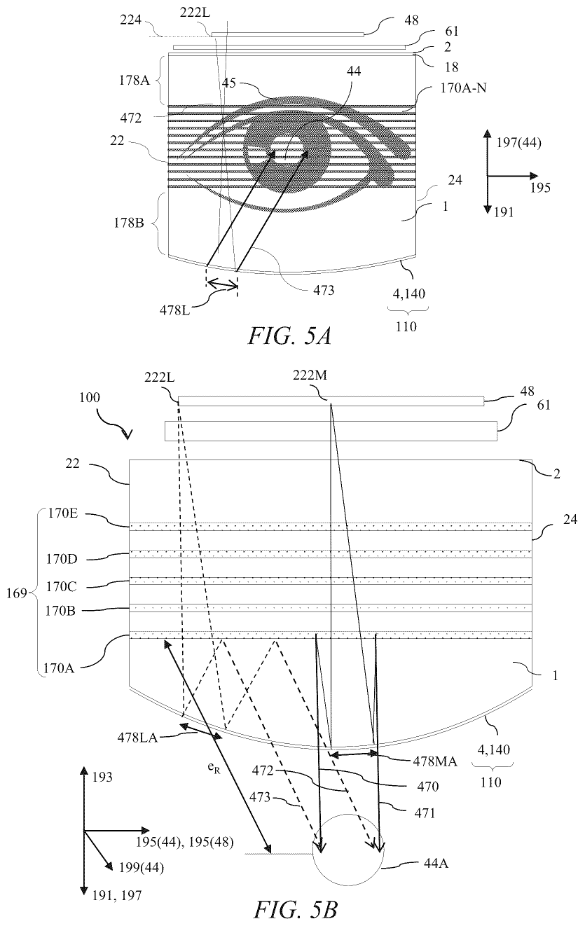

As will be described in FIGS. 5A-E hereinbelow, the lateral anamorphic component 110 further provides exit pupil 40 expansion in the lateral direction 195, that is increasing the size e_{L} of the eyebox 40 in the lateral direction 195.

The imaging properties of the anamorphic near-eye display apparatus 100 in the lateral direction 195 will now be considered further.

FIGS. 5A-C are schematic diagrams illustrating front views of light output from the anamorphic near-eye display apparatus of FIG. 1A. Features of the embodiments of FIGS. 5A-C not discussed in further detail may be assumed to correspond to the features with equivalent reference numerals as discussed above, including any potential variations in the features.

FIG. 5A illustrates that a non-extracting light guiding region 178A is arranged between the tapered surface 18 and the first extraction reflector 170 of the array of extraction reflectors 170A-N; and a non-extracting light guiding region 178B is arranged between the array of extraction reflectors 170A-N and the lateral anamorphic component 110. Non-extracting guiding sections 178A, 178B may provide increased height of the extraction waveguide 1 in the first direction 191 without extraction reflectors 170. Efficiency of extraction is advantageously improved, and aberrational performance of the lateral anamorphic component 110 is further improved.

In the embodiment of FIG. 5A, the eye 45 is aligned in plan view and out-of-plane rays are not shown, however such a description provides an insight into the operation of the anamorphic near-eye display apparatus 100 in the lateral direction 195. More than one extraction reflector 170 overlays the pupil 44 of the eye 45. For example, the pitch of the extraction reflector 170 is 1 mm and three to six extraction reflectors 170 are provided across the pupil 44 of the eye 45 depending on the dilation of the pupil 44 of the eye 45. Advantageously luminance variation with eye position 45 may be reduced.

The pupil 44 sees the off-axis rays from pixel 222L at the edge of the spatial light modulator 48 after reflection from a region 478L of the lateral anamorphic component 110, which is the reflective end 4 of the extraction waveguide 1. While the lateral anamorphic component 110 in its entirety is a relatively fast optical element and thus prone to aberrations, particularly from its edges, the region 478 of the lateral anamorphic component 110 that is directing light into the pupil 44 for any one eye 45 location is small, and thus aberrations from the lateral anamorphic component 110 are correspondingly reduced. Considering FIG. 1F, desirably small lateral size 454_{L}, of the blur PSF 452 may be achieved.

In the embodiment of FIG. 5B, the eye 45 is aligned with out-of-plane rays to illustrate exit pupil 40 expansion in the lateral direction 195.

Light rays 470, 471 are directed from a central pixel 222M across the lateral direction 195 of the spatial light modulator 48 and transmitted through the transverse anamorphic component 60 formed by the transverse lens 61 without optical power in the lateral direction 195 and into the extraction waveguide 1. Said light rays 470, 471 propagate in the first direction 191 of the extraction waveguide 1 to the light reversing reflector 140 which provides positive optical power in the lateral direction 195 by means of the reflective end 4 which provides the lateral anamorphic component 110.

Such light rays 470, 471 are reflected in the extraction waveguide 1 in the second direction 193 from the region 478MA of the lateral anamorphic component 110 and at the extraction reflector 170A is reflected away from the plane of the extraction waveguide 1 to the pupil 44 of the eye 45A at the viewing distance e_{g}. The eye 45 collects the rays 470, 471 and directs them to the same point on the retina 46 to provide a virtual pixel location as described elsewhere herein.

Similarly for off-axis pixel 222L offset in the lateral direction 195(48), at the edge of the spatial light modulator 48 provides rays 472, 473 that are directed into the extraction waveguide 1, reflected at region 478LA of the lateral anamorphic component 110 and reflected by extraction reflector 170A to the eye 45A to provide an off-axis image point in the lateral direction 195(44) on the retina 46.

The lateral anamorphic component 110 has a positive optical power that provides collimated optical rays from each image point 222L, 222M in the lateral direction 195. In this manner the lateral distribution of field points are provided across the retina 46 by means of the optical power of the lateral anamorphic component 110, while the transverse anamorphic component 60 has optical power to provide the transverse distribution of field points across the retina 46. At diagonal field angles, such as illustrated in FIG. 1E with regards to the imaging of pixel 227, the field points are provided by a combination of the lateral and transverse optical powers of the lateral anamorphic component 110 and transverse anamorphic component 60 respectively.

FIG. 5C illustrates exit pupil expansion in the lateral direction 195 and in the transverse direction 197. Rays 474, 475 for pixels 222R, 222L are directed to pupil 44B by reflection from regions 478RB, 478LB respectively of the lateral anamorphic component 110. Pupil 44B is offset from the pupil 44A in the lateral direction 195, wherein the rays 474, 475 are reflected at least by the extraction reflector 170A. The width e_{L} of the exit pupil 40 is thus increased by the relatively large width of the lateral anamorphic component 110 allowing the regions 478 to be arranged over a desirable width. The viewing freedom of the eye 45 in the exit pupil 40 is increased, advantageously increasing viewing comfort for the eye 45 while achieving full field of view in the lateral direction.

FIG. 5C further illustrates the pupil expansion in the transverse direction 197. Light that is reflected from extraction reflectors 170D is directed to pupil 44C that has a different height to the pupil 44A, as discussed hereinbefore with respect to FIG. 4C.

Polarised light propagation in the illustrative embodiment of FIG. 1A will now be described.

FIG. 6A is a schematic diagram illustrating a side view of polansed light propagation in the anamorphic near-eye display apparatus 100 of FIG. 1A; FIG. 6B is a schematic diagram illustrating a front view of polarised light propagation in the anamorphic near-eye display apparatus 100 of FIG. 1A; and FIG. 6C is a schematic diagram illustrating optical axis alignment directions and polarisation states for light propagating through the unfolded polarisation control components of FIGS. 6A-B. Features of the embodiments of FIGS. 6A-C not discussed in further detail may be assumed to correspond to the features with equivalent reference numerals as discussed above, including any potential variations in the features.

As described above with respect to FIG. 1A, the optical system comprises an input linear polariser 70 disposed between the spatial light modulator 48 and the array of extraction reflectors 170. A polarisation conversion retarder 72 is disposed between the light reversing reflector 140 and the array of extraction reflectors 170.

In the alternative embodiment of FIGS. 6A-C, the optical system 250 comprises an input linear polariser 70 disposed between the spatial light modulator 48 and the array of extraction reflectors 170 and a polarisation conversion retarder 72 disposed between the light reversing reflector 140 and the array of extraction reflectors 170, the polarisation conversion retarder 72 being arranged to convert a polarisation state of light passing therethrough between a linear polarisation state 902, 904 and a circular polarisation state 922, 924 respectively. The polarisation conversion retarder 72 has a retardance of a quarter wavelength at a wavelength of visible light, for example 550 nm; that is the polarisation conversion retarder 72 may be a quarter wave retardation at a visible wavelength such as 550 nm and may comprise a stack of composite retarders arranged to achieve the operation of a quarter wave retarder over an increased spectral band, for example comprising a Pancharatnam stack.

FIG. 6C further illustrates the arrangement of optical axis direction 872 of polarisation conversion retarder 72; and the linear polarisation state electric vector transmission axes 870 of the input linear polariser 70. For illustrative purposes, the geometry is unfolded after reflection at the light reversing reflector 140. Further, in the optical axis alignment diagrams of the present description, the aspect ratio of the elements 70, 72, 140 is reduced for illustrative purposes; in an illustrative embodiment, said elements may have a transverse direction 197 length of 5 mm and a lateral direction 195 length of 40 mm.

FIG. 6C illustrates the propagation of polarisation states and the alignment of various optical components. Polariser 70 has electric vector transmission direction 870 at 90 degrees, such that linear polarisation state 902 is transmitted and passes through reflector 170 to polarisation conversion retarder 72 with optical axis direction 872 to output circular polarisation state 922. Circular polarisation state 924 is reflected from the mirror (shown as an illustrative unfolded geometry) that provides a π phase shift and then linear polarisation state 904 is output onto reflector 170. Linear polariser 70 is arranged to absorb the back reflected light with polarisation state 904.

FIGS. 6A-C illustrate that input linear polariser 70 is arranged to pass light that is in a p-polarisation state in the extraction waveguide; that is a polarisation state 902 has an electric vector transmission direction 900 that provides a p-polarised linear polarisation state 902 that is in the plane of the cross section of the extraction waveguide 1 and out of the plane of the rear and front guide surfaces 6, 8, that is in the plane in which the output light rays 37 are distributed in the transverse direction 197.

Output light ray 37 is guided in the first direction 191 by total internal reflection at opposing rear and front guide surfaces 6, 8 towards the lateral anamorphic component 110 comprising light reversing reflector 140, which in the embodiment of FIG. 1A and FIG. 6A comprises the end 4 of the extraction waveguide 1 and a reflective coating.

As will be described further hereinbelow, the p-polarised state 902 is at least in part and preferably preferentially transmitted through the extraction reflectors 170 and intermediate surfaces 172.

The polarisation conversion retarder 72 is provided between the extraction reflectors 170A-E and the light reversing reflector 140. Polarised light ray 37 is converted to a left-hand circular polarisation state 922 and a n phase shift occurring on reflection at the light reversing reflector 140 provides a reflected right-hand circular polarisation state 924. The polarisation conversion retarder 72 outputs s-polarised polarisation state 904 that propagates along light ray 37 back up the extraction waveguide 1 in the second direction 193.

The polarisation conversion retarder 72 most generally serves to provide the polarisation modification to provide conversion from polarisation state 902 to polarisation state 904 for light ray 37. The polarisation conversion retarder 72 may have a retardance of a quarter wavelength at a wavelength of 550 nm or may be tuned for another visible wavelength for example to match the peak luminance of a monochrome display. The retardance of the polarisation conversion retarder 72 may be different to a quarter wavelength, but selected to provide the same effect. For example, the polarisation conversion retarder 72 may have a retardance of three quarter wavelengths or five quarter wavelengths, for example. The polarisation conversion retarder 72 may comprise a stack of retarders to provide desirable phase modification over an increased spectral range, for example with a Pancharatnam retarder stack (which is different to the Pancharatnam-Berry lens described hereinbelow). Advantageously colour uniformity may be increased. The polarisation conversion retarder 72 may be provided with additional retarder layers to increase the field of view of the quarter wave retarder function, to achieve increased uniformity across the field of view of observation.

In FIG. 1A, the polarisation conversion retarder 72 is arranged between the extraction waveguide 1 and the lateral anamorphic component 110 that is the light reversing reflector 140. The polarisation conversion retarder 72 may be attached to the curved reflective end 4 of the waveguide. Advantageously cost and complexity of assembly may be reduced. In the alternative embodiment of FIG. 6B, the polarisation conversion retarder 72 is arranged across a chord of the lateral anamorphic component 110. Such an arrangement may be suitable for an extraction waveguide 1 wherein the light reversing reflector is assembled as a separate component to the extraction region of the waveguide comprising extraction reflectors 170.

As will be described further herein below, the s-polarised state 904 is preferentially reflected by the extraction reflectors 170 and intermediate surfaces 172 and output towards the pupil 44 of the eye 45.

Unpolarised light from real-world objects 30 is directed through the extraction waveguide 1. Optional polariser 90 with p-polarised electric vector transmission direction 90 may be provided that transmits the linear polarisation state 920 and may be arranged so that the extraction waveguide 1 is arranged between the object 30 and the eye 45. Polariser 90 may provide a sunglasses function and reduce background object luminance in comparison to the luminance of the anamorphic near-eye display apparatus 100. Further light rays 32 may be preferentially transmitted through the extraction reflectors 170 rather than reflected at the extraction reflectors 170. Advantageously image contrast of overlayed virtual images may be increased and double imaging reduced.

It would be desirable to improve aberrations from the lateral anamorphic component 110.

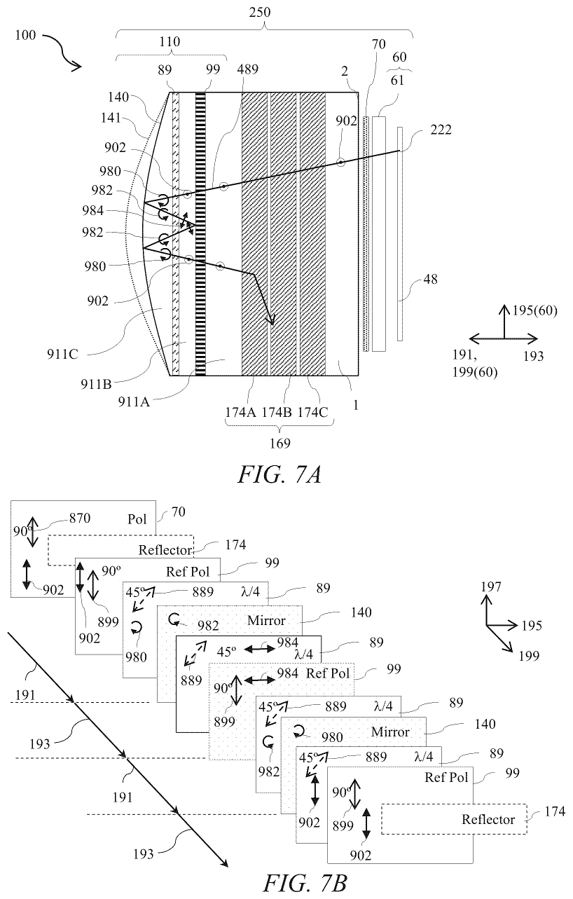

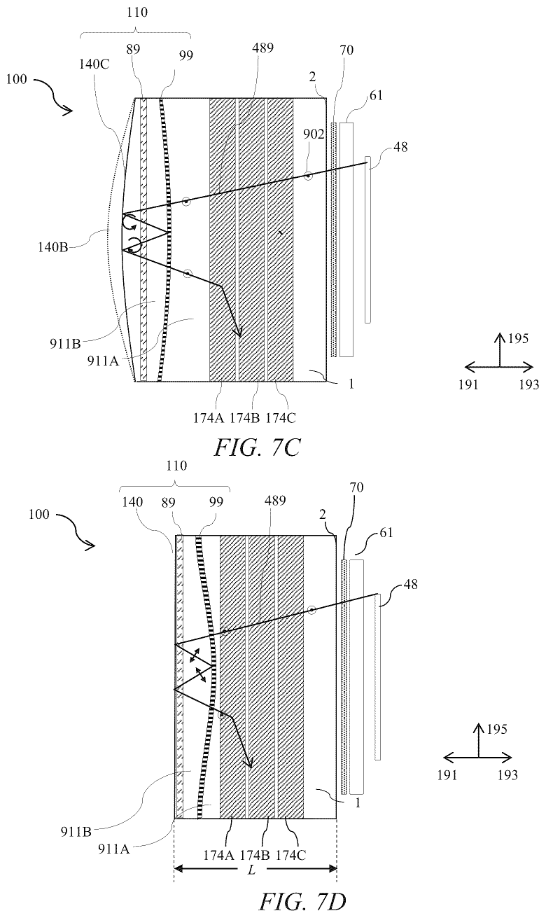

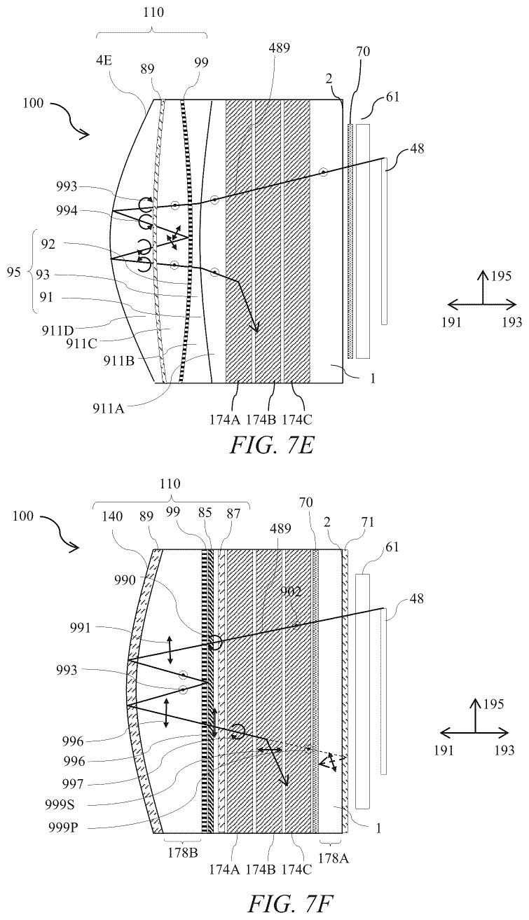

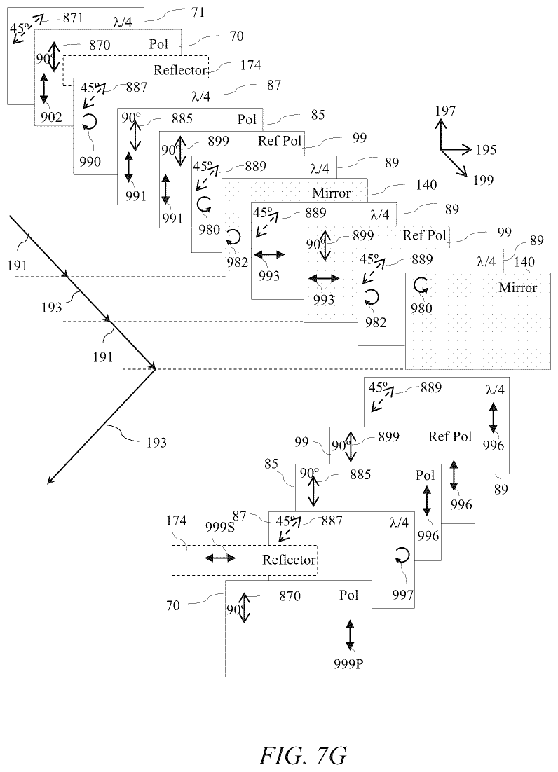

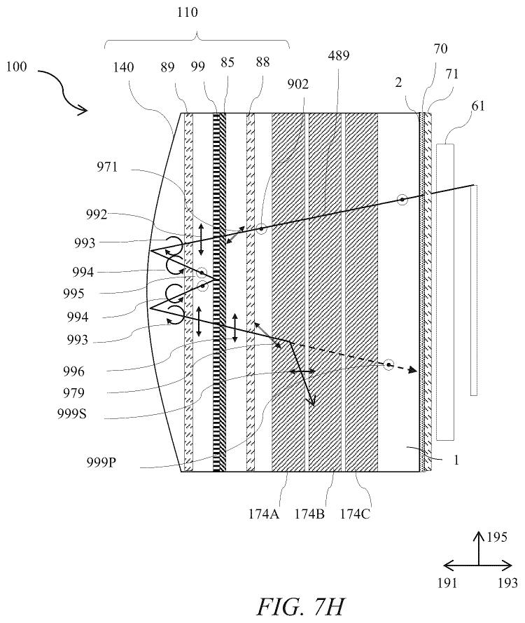

FIG. 7A is a schematic diagram illustrating in front view an anamorphic near-eye display apparatus 100 wherein the lateral anamorphic component 110 further comprises a planar reflective linear polariser 99 and a polarisation conversion retarder 89 arranged between the light reversing reflector 140 that is the reflective end 4, and the reflective linear polariser 99; and FIG. 7B is a schematic diagram illustrating optical axis alignment directions through the polarisation control components of FIG. 7A. Features of the embodiment of FIGS. 7A-B not discussed in further detail may be assumed to correspond to the features with equivalent reference numerals as discussed above, including any potential variations in the features.

The alternative embodiment of FIG. 7A illustrates an anamorphic near-eye 45 display apparatus 100 comprising: an illumination system 240 comprising a spatial light modulator 48, the illumination system 240 being arranged to output light; and an optical system 250 arranged to direct light from the illumination system 240 to a viewer's eye 45. The optical system 250 has an optical axis 199 and has anamorphic properties in a lateral direction 195 and a transverse direction 197 that are perpendicular to each other and perpendicular to the optical axis 199. The spatial light modulator 48 comprises pixels 222 distributed in the lateral direction 195. The optical system 250 comprises: a transverse anamorphic component 60 having positive optical power in the transverse direction 197, wherein the transverse anamorphic component 60 is arranged to receive light from the spatial light modulator 48 and the illumination system 240 is arranged so that light output from the transverse anamorphic component 60 is directed in directions that are distributed in the transverse direction 197. The extraction waveguide 1 is arranged to receive light rays 489 for respective pixels 222 and from the transverse anamorphic component 60. The lateral anamorphic component 110 has positive optical power in the lateral direction 195 and the extraction waveguide 1 is arranged to guide light from the transverse anamorphic component 60 to the lateral anamorphic component 110 along the extraction waveguide 1 in a first direction 191. The light reversing reflector 140 is arranged to reflect light that has been guided along the extraction waveguide 1 in the first direction 191 so that the reflected light is guided along the extraction waveguide 1 in a second direction 193 opposite to the first direction 191, wherein the extraction waveguide 1 comprises an array of extraction features 169 comprising extraction reflectors 174A-C, the extraction features 169 being arranged to transmit light guided along the extraction waveguide 1 in the first direction 191 and to extract light guided along the extraction waveguide 1 in the second direction 193 towards an eye 45 of a viewer, the array of extraction features 169 being distributed along the extraction waveguide 1 so as to provide exit pupil 40 expansion. The extraction reflectors 174A-C are disposed internally within the extraction waveguide 1 and extending the entire way between the front and rear light guiding surfaces 6, 8, as shown in FIG. 3. This is an alternative to the extraction reflectors 170 shown in FIG. 1 that extend partially across the extraction waveguide 1 between the opposing rear and front guide surfaces 6, 8, although such extraction features 170 as shown in FIG. 1 could alternatively be employed.

In the alternative embodiment of FIG. 7A, the lateral anamorphic component 110 comprises: a reflective linear polariser 99 disposed between the light reversing reflector 140 and the array of extraction reflectors 174A-C wherein the light reversing reflector 140 is curved in the lateral direction 195; and a polarisation conversion retarder 89 disposed between the reflective linear polariser 99 and the light reversing reflector 140, the polarisation conversion retarder 89 being arranged to convert a polarisation state of light passing therethrough between a linear polarisation state and a circular polarisation state.

The reflective linear polariser 99 is arranged between waveguide parts 911A, 911B and the polarisation conversion retarder 89 is arranged between waveguide parts 911B, 911C. In alternative embodiments such as illustrated in FIG. 7F hereinbelow, the polarisation conversion retarder 89 may be arranged on the reflective linear polariser 99 or on the light reversing reflector 140 such that the waveguide part 911C is omitted.

In FIG. 7B, illustrative arrangements of optical axis direction 889 of polarisation conversion retarder 89 respectively is illustrated; and the linear polarisation state transmission axes 870, 899 of polarisers 70, 99 respectively. For illustrative purposes, the geometry is unfolded after reflection at the light reversing reflector 140.

Considering light ray 489, input linear polariser 70 provides p-polarisation state 902 in the waveguide 1. Light ray 489 is transmitted by reflective linear polariser 99. The polarisation conversion retarder 89 has a retardance of a quarter wavelength at a wavelength of visible light; that is the polarisation conversion retarder 89 may be a quarter wave retardation at a visible wavelength such as 550 nm and may comprise a stack of composite retarders arranged to achieve the operation of a quarter wave retarder over an increased spectral band, for example comprising a Pancharatnam stack. The retardance of the polarisation conversion retarder 89 may be different to a quarter wavelength, but selected to provide the same effect. For example, the polarisation conversion retarder 89 may have a retardance of three quarter wavelengths or five quarter wavelengths, for example.

The optical system 250 further comprises an input linear polariser 70 disposed between the spatial light modulator 48 and the array of extraction reflectors 174A-C, wherein the input linear polariser 70 and the reflective linear polariser 99 of the lateral anamorphic component 110 are arranged to pass a common polarisation state.

Reflective linear polariser 99 may be a wire grid polariser or a multilayer polariser film such as 3M APF reflective polariser and may be bonded between parts 911A, 911B of the extraction waveguide 1.

The polarisation conversion retarder 89 of FIG. 7A outputs a circular polarisation state 980. After reflection at the light reversing reflector 140, the circular polarisation state 982 is provided due to the phase shift at reflection and is converted to s-polarisation state 984 that is reflected by reflective linear polariser 99. Light ray 489 is then reflected a second time by the light reversing reflector 140 to provide polarisation state 902 that is transmitted through the reflective linear polariser 99 and reflected by the extraction reflectors 174A-C. Thus the polarisation conversion retarder 89 has a different function to the polarisation conversion retarder 72 of FIG. 6A for example.

The light ray 489 is thus incident twice onto the light reversing reflector 140. Such an arrangement may reduce the sag of the light reversing reflector 140 in comparison to the light reversing reflector 141 that would be used if the reflective linear polariser 99 and polarisation conversion retarder 89 were omitted. Aberrations of the optical system may be reduced and MTF increased. Further the optical power is achromatic, minimising colour blur. Advantageously the eye 45 may see reduced image blur for off-axis viewing directions. Field of view may be increased for high image quality.

In alternative embodiments to those described elsewhere herein, the polarisation state 902 may be provided by another polarisation state such as a linearly polarised s-polarisation state or a circular polarisation state for example. Corresponding polarisation states that propagate through the system may be provided, to achieve a similar operation. The polarisation state 902 may be provided to achieve desirably low glare for light exiting from the waveguide 1 away from the eye 45 of the viewer 47 and efficient reflection from reflective extraction reflectors 174 after reflection from the light reversing reflector 140. Further improvement of aberrations as described hereinbelow may be achieved.

FIG. 7C is a schematic diagram illustrating in front view an anamorphic near-eye display apparatus 100 wherein the lateral anamorphic component 110 further comprises a curved reflective linear polariser 99 and a polarisation conversion retarder 89 arranged between the light reversing reflector 140 that is the reflective end 4, and the reflective linear polariser 99. Features of the embodiment of FIG. 7C not discussed in further detail may be assumed to correspond to the features with equivalent reference numerals as discussed above, including any potential variations in the features.

In comparison to the embodiment of FIG. 7A, in the alternative embodiment of FIG. 7C, the reflective polarizer 99 is curved in the lateral direction 195. Reflections take place in series from surface 140C, then surface 99 and then surface 140C again. Optical power is provided at each reflection so that the curvature of each surface can be reduced to achieve the desired optical power of the lateral anamorphic component 110. Aberrations of the optical system may be further reduced and MTF increased. Further the optical power is achromatic, minimising colour blur. Advantageously the eye 45 may see reduced image blur for off-axis viewing directions. The light reversing reflectors 140 of the present embodiments may be aspheric. Field of view may be further increased for high image quality.

Further, the reflective linear polariser 99 may be provided in manufacture by means of curving the surface of the reflective linear polariser 99 about a single axis. Distortions of the reflective linear polariser 99 may be advantageously reduced.

FIG. 7D is a schematic diagram illustrating in front view an anamorphic near-eye display apparatus 100 wherein the lateral anamorphic component 110 further comprises a planar light reversing reflector 140 that is the reflective end 4, a curved reflective linear polariser 99 and a polarisation conversion retarder 89 arranged between the planar light reversing reflector 140 that is the reflective end 4, and the reflective linear polariser 99; and FIG. 7E is a schematic diagram illustrating in front view an anamorphic near-eye display apparatus 100 wherein the lateral anamorphic component 110 comprises a curved light reversing reflector 140 that is the reflective end 4, a curved reflective linear polariser 99; a polarisation conversion retarder 89 arranged between the planar light reversing reflector 140 that is the reflective end 4, and the reflective linear polariser 99 and a refractive lens arranged between the input end 2 and the reflective linear polariser 99. Features of the embodiments of FIGS. 7D-E not discussed in further detail may be assumed to correspond to the features with equivalent reference numerals as discussed above, including any potential variations in the features.

In the alternative embodiment of FIG. 7D, the light reversing reflector 140 is not curved in the lateral direction 195 and is planar; and the reflective linear polariser 99 is arranged to provide the optical power of the lateral anamorphic component 110. Advantageously the length L of the extraction waveguide 1 may be reduced for a desirable focal length of the light reversing reflector. Aberrations may advantageously be improved in a smaller package.

Further the reflective linear polariser 99 may have a profile that has an aspheric shape to advantageously achieve improved aberrations.

In the alternative embodiment of FIG. 7E, the polarisation conversion retarder 89 is curved in the lateral direction and is arranged between waveguide parts 911C, 911D that have different refractive indices and/or different dispersions of refractive index with wavelength. Advantageously further correction of aberrations may be achieved.

The alternative embodiment of FIG. 7E further shows refractive lens 95 comprising surface 91 between waveguide parts 911A, 911B, surface 92 of the reflective linear polariser 99 and material 93 that has a different refractive index to the material of the waveguide part 911A. Such an arrangement may further provide increased control of aberrations. Off-axis field of view for desirable image blur may be further increased.

The embodiments of FIGS. 7A-G show that the same polarisation state 902 propagates in the first and second directions 191, 193 in the waveguide 1. It may be desirable to reduce stray light.

FIG. 7F is a schematic diagram illustrating in front view an anamorphic near-eye display apparatus 100 wherein the lateral anamorphic component 110 further comprises an absorbing polariser 85; a reflective linear polariser 99; a polarisation conversion retarder 89 arranged between the light reversing reflector 140 that is the reflective end 4, and the reflective linear polariser 99; a polarisation control retarder 87 arranged between the input end 2 and the reflective linear polariser 99; and FIG. 7G is a schematic diagram illustrating propagation of illustrative polarisation states through the polarisation control components of FIG. 7F. Features of the embodiments of FIGS. 7F-G not discussed in further detail may be assumed to correspond to the features with equivalent reference numerals as discussed above, including any potential variations in the features.

In the alternative embodiment of FIG. 7F, the optical system 250 comprises an input linear polariser 70 disposed between the spatial light modulator 48 and the array of extraction reflectors 170 and the lateral anamorphic component 110 further comprises: a polarisation control retarder 87 disposed between the reflective linear polariser 99 and the array of extraction reflectors 170, the polarisation control retarder 87 being arranged to change a polarisation state of light passing therethrough; and an absorbing linear polariser 85 disposed between the polarisation control retarder 87 and the reflective linear polariser 99, wherein the absorbing linear polariser 85 and the reflective linear polariser 99 are arranged to pass a common linear polarisation state that is a component of the polarisation state output from the polarisation control retarder 87 in the direction along the waveguide 1.

In FIG. 7F the polarisation control retarder 87 has a retardance of a quarter wavelength retarder at a wavelength of visible light such as 550 nm and may be a Pancharatnam retarder. Polarisation control retarder 87 is arranged to convert a polarisation state of light passing therethrough between a linear polarisation state 902, 997 and a circular polarisation state 990, 998. Polarisation control retarder 87 has a retardance and optical axis direction 887 arranged to provide said conversion.

The optical system 250 comprises an input linear polariser 70 disposed between the spatial light modulator 48 and the array of extraction reflectors 170 and polarisation conversion retarder 89 is curved in the lateral direction 195.

In FIG. 7G, illustrative arrangements of optical axis directions 871, 887, 889 of quarter wave retarders 71, 87, 89 respectively are illustrated; and the linear polarisation state transmission axes 870, 885, 899 of polarisers 70, 85, 99 respectively. For illustrative purposes, the geometry is unfolded after reflection at the light reversing reflector 140. At least some of the quarter wave retarders 71, 87, 89 may have a quarter wave retardation at a visible wavelength such as 550 nm and may comprise a stack of composite retarders arranged to achieve the operation of a quarter wave retarder over an increased spectral band, for example comprising a Pancharatnam stack.

Considering the propagation of polarisation states along the ray 489 in FIG. 7F then the linear polarisation state is converted to circular polarisation state 990 before the absorbing polariser 85 that has an electric vector transmission direction parallel to the electric vector transmission direction of the reflective linear polariser 99.

Half of the light is transmitted through the reflective linear polariser 99 and polarisation states 991, 992, 993, 994, 995, 996, 997 are provided by the various reflections and passes through polarisation conversion retarder 89 as described for FIG. 7A hereinabove. The polarisation control retarder 87 provides circular polarisation state 998, with some light with polarisation state 999S reflected by polarisation-sensitive extraction reflectors 174A-C, while the light with polarisation state 999P is transmitted to the input end 2.

As described elsewhere herein, the polarisation conversion retarder 71 may be arranged to reflect the residual transmitted light to be absorbed at input linear polariser 70. Advantageously visibility of the unextracted light is reduced.

FIG. 7F further illustrates alternative arrangements of polariser and retarder locations. Such alternative illustrative arrangements of polariser and retarder locations may be provided together or individually in other embodiments as described elsewhere herein.

In the alternative embodiment of FIG. 7F, the input linear polariser 70 is not arranged at the input end 2, and a region 178 of extraction waveguide 1 is provided between the input end 2 and the input linear polariser 70. In operation, the linear polariser 70 is arranged near to the extraction reflector 174C and provides improved polarisation state uniformity for input light ray 489 before incidence onto the extraction reflectors 174C. Further polariser 85 is arranged close to the extraction reflector 174A.

In the regions 178A, 178B, there may for example be some residual birefringence in the bulk material of the extraction waveguide 1 that may cause some polarisation state modification to an input linear polarisation state. The arrangement of FIG. 7F achieves a more uniform polarisation state 902 for light ray 489 incident onto the extraction reflectors 174A-C. Advantageously uniformity may be increased and light lost as glare to the external environment reduced.

Further the polarisation conversion retarder 89 is curved and arranged on the light reversing reflector 140. Advantageously complexity of fabrication is reduced.

FIG. 7H is a schematic diagram illustrating in front view an anamorphic near-eye display apparatus 100 wherein the lateral anamorphic component 110 further comprises an absorbing polariser 85, a planar reflective linear polariser 99; a polarisation conversion retarder 89 arranged between the light reversing reflector 140 that is the reflective end 4, and the reflective linear polariser 99; and a further quarter wave retarder 87 arranged between the input end 2 and the reflective linear polariser 99; and FIG. 7I is a schematic diagram illustrating propagation of illustrative polarisation states through the polarisation control components of FIG. 7H. Features of the embodiments of FIGS. 7H-I not discussed in further detail may be assumed to correspond to the features with equivalent reference numerals as discussed above, including any potential variations in the features.

By way of comparison with FIGS. 7F-G, in the alternative embodiments of FIGS. 7H-1, the polarisation control retarder 87 has a retardance of a half wavelength at a wavelength of visible light and is arranged to rotate the linear polarisation state, for example between linear polarisation state 902 and linear polarisation state 971 and between linear polarisation state 998 and linear polarisation state 979.

Polarisation control retarder 87 has a retardance and optical axis direction 887 arranged to provide a linear polarisation state 971 inclined at 45 degrees to the electric vector transmission direction of the reflective linear polariser 99 and absorbing polariser 85. Half of the light is transmitted as polarisation state 992 which as described in FIG. 7F provides a linear polarisation state 998 that is transmitted through the reflective linear polariser 99 and absorbing polariser 85. Polarisation control retarder 87 converts this to 45 degrees linear state 979. Some light with polarisation state 999S is reflected by polarisation-sensitive extraction reflectors 174A-C, while the light with polarisation state 999P is transmitted to the input end 2.

The polarisation control retarder 87 may have a half wave retardance at a visible wavelength such as 550 nm and may comprise a stack of composite retarders arranged to achieve the operation of a half wave retarder over an increased spectral band, for example comprising a Pancharatnam stack.

It may be desirable to improve the aberrations and/or reduce the size of the transverse anamorphic component 60.

Various alternative arrangements of extraction features will now be described. In general the extraction features from different embodiments are interchangeable. That is, the extraction features provided in any of the embodiments described above may be replaced by any of the alternative arrangements of extraction features described elsewhere herein, including the examples below.

The extraction features 169 may comprise extraction reflectors 170 that extend partially across the extraction waveguide 1 between front and rear guide surfaces 8, 6 of the extraction waveguide 1, for example as illustrated in FIG. 1A. In an alternative, the extraction features may be reflective extraction reflectors 174A-C disposed internally within the extraction waveguide 1 and extending entirely across the extraction waveguide 1 between the front and rear light guiding surfaces 6, 8, for example as illustrated in FIG. 3D and FIGS. 7A-I. In both those alternatives, the extraction reflectors 170, 174 may comprise intermediate surfaces spaced apart by a partially reflective coating. The partially reflective coating may comprise at least one dielectric layer. The extraction reflectors 170, 174 may have a surface normal direction that is inclined with respect to the direction along the waveguide by an angle α in the range 20 to 40 degrees, preferably by an angle in the range 25 to 35 degrees and most preferably by an angle in the range 27.5 degrees to 32.5 degrees.

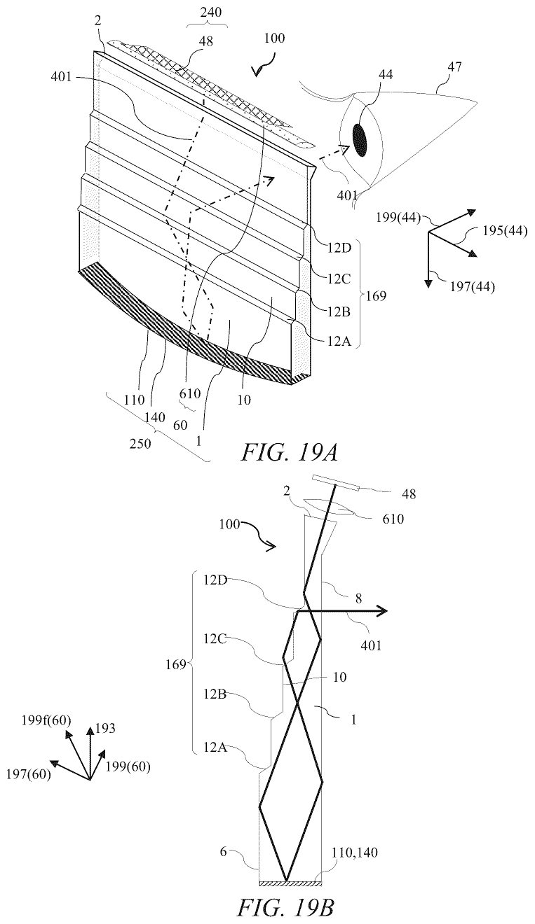

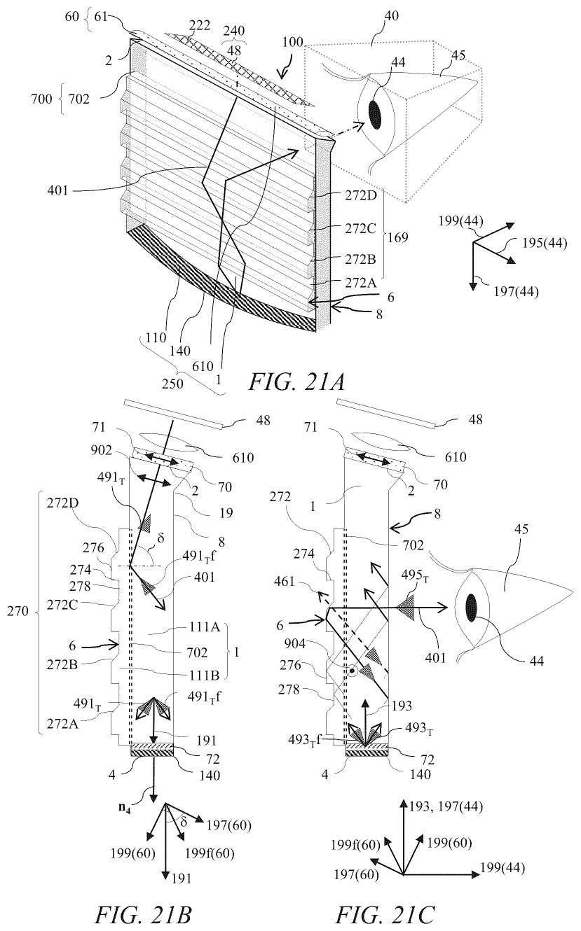

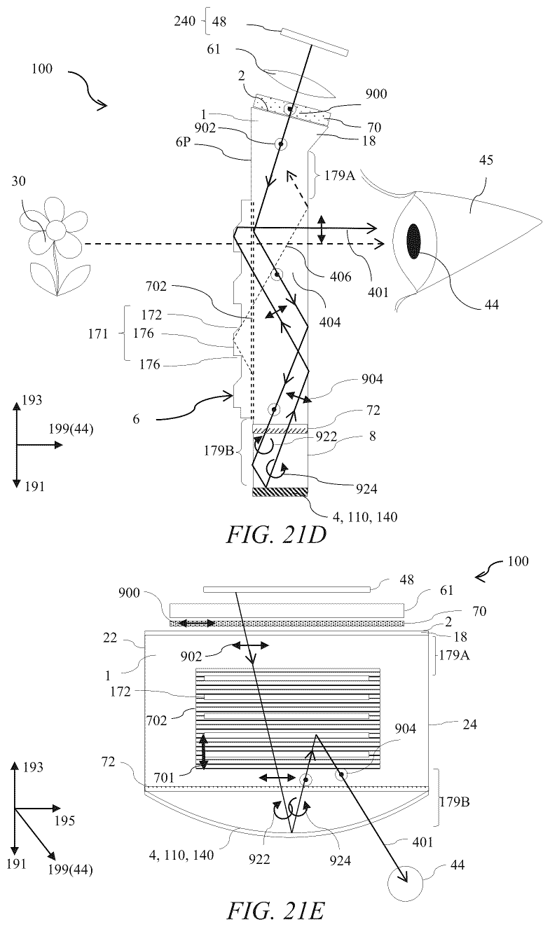

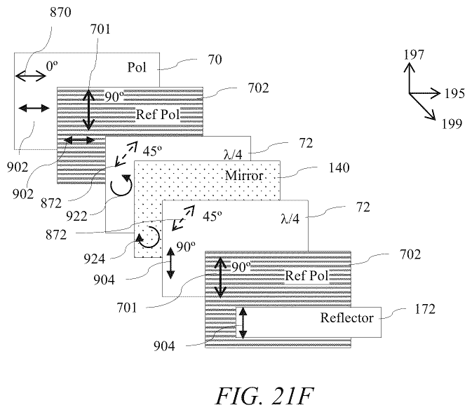

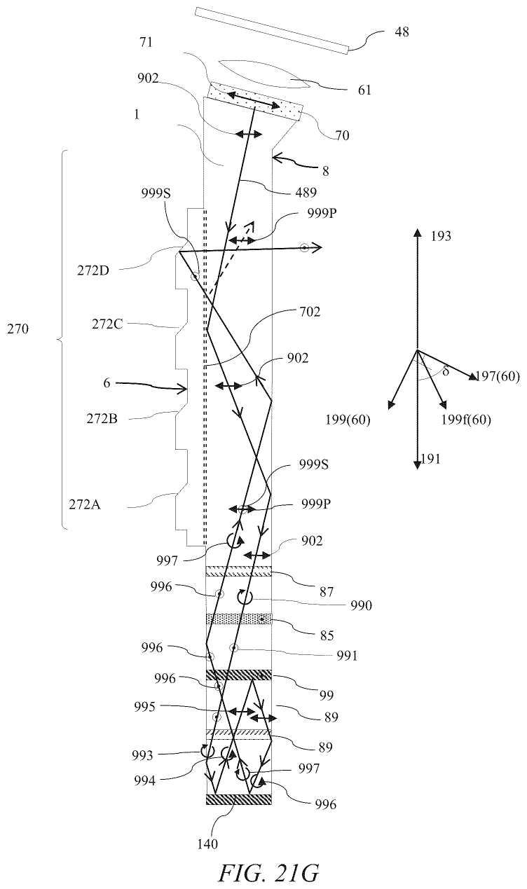

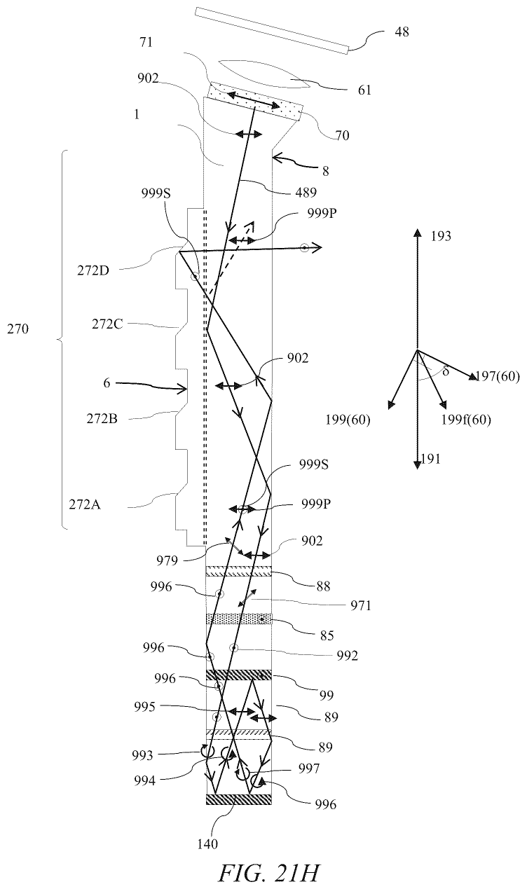

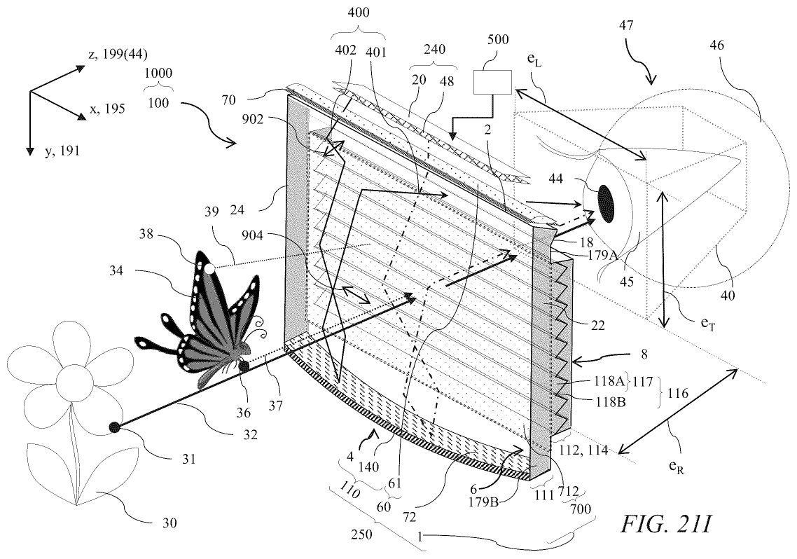

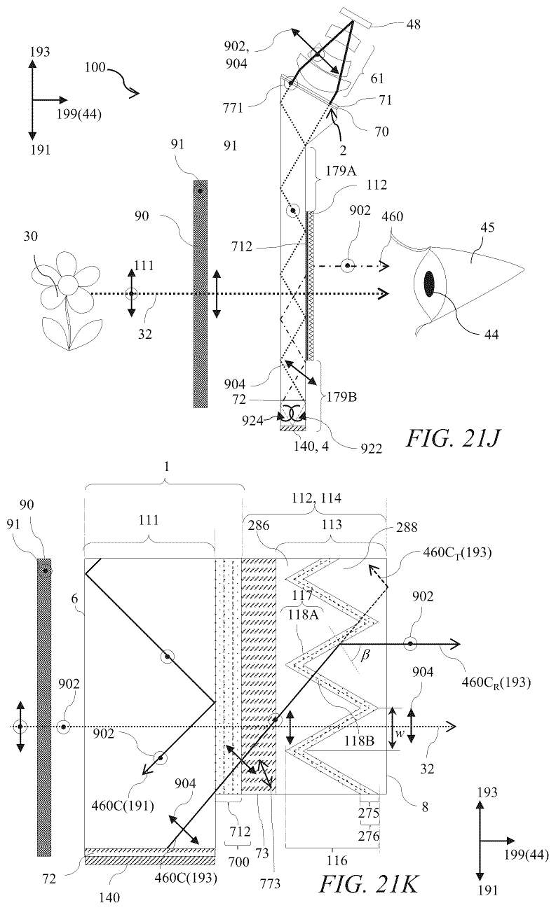

In another alternative, the extraction waveguide 1 may have a front guide surface 8 and a rear guide surface 6, and the rear guide surface 6 comprises extraction facets 12, 172 that are the extraction features 169, each extraction facet 12, 172 being arranged to reflect light guided in the second direction 193 towards an eye 45 of a viewer through the front guide surface 8, for example as illustrated in FIGS. 19A-B and FIGS. 21A-F hereinbelow.

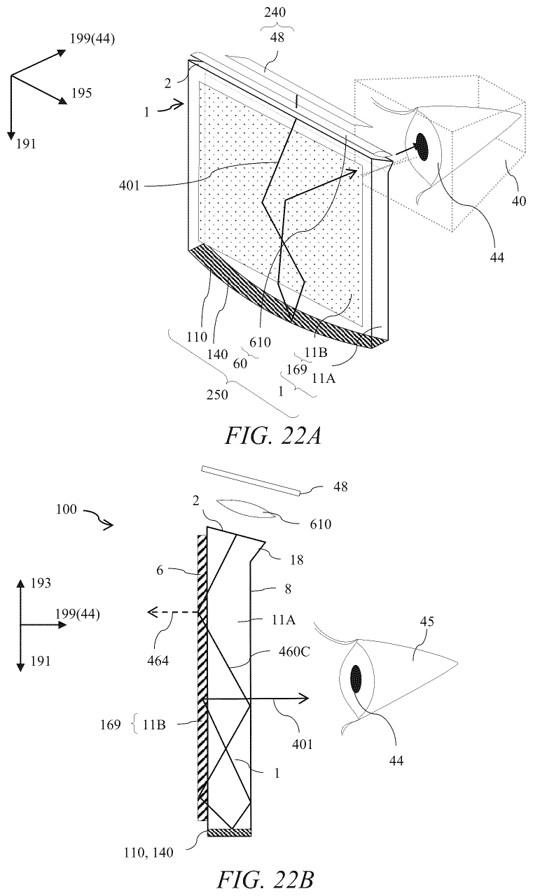

In yet another alternative, the extraction waveguide 1 has a front guide surface 8 and a rear guide surface 6, and the rear guide surface 6 comprises a diffractive optical element 11B comprising the extraction features 169, for example illustrated in FIG. 22A.

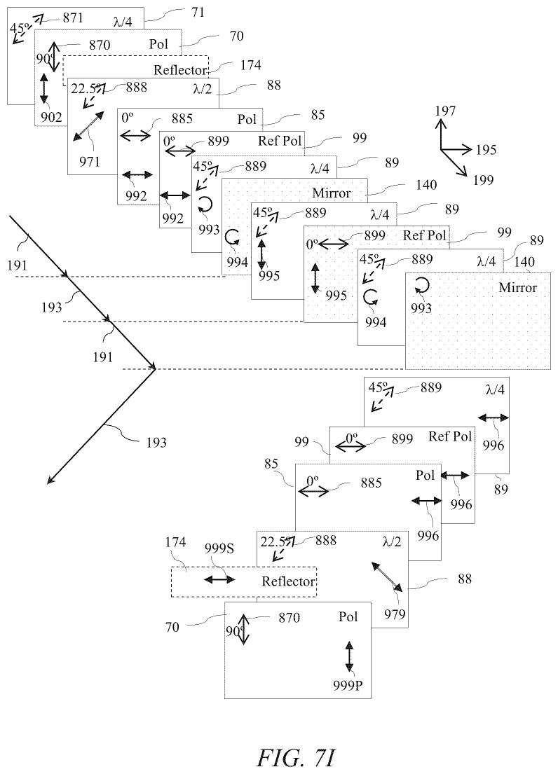

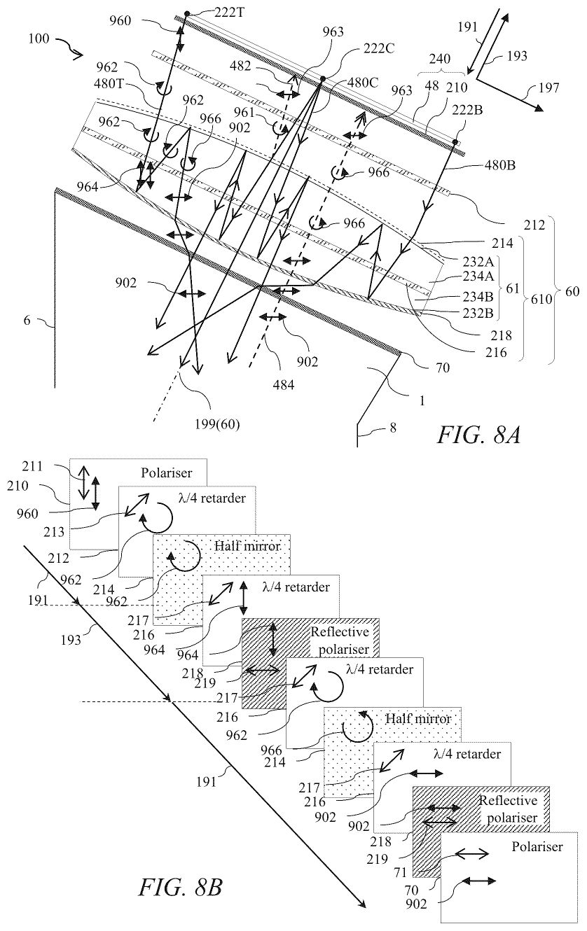

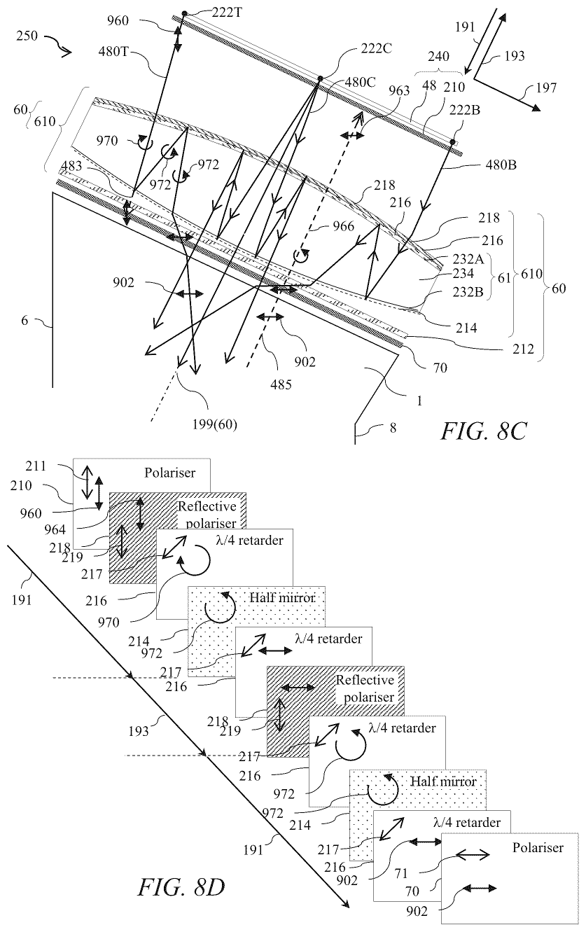

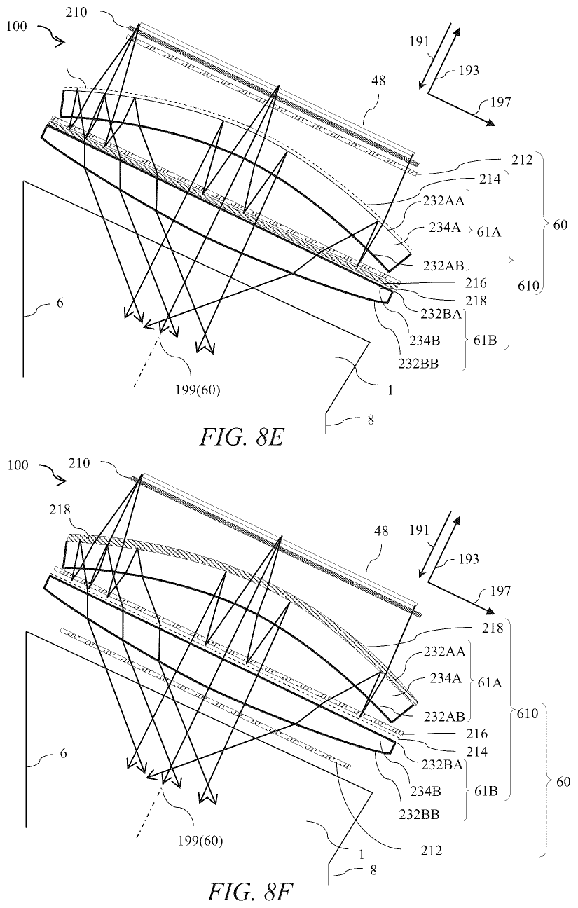

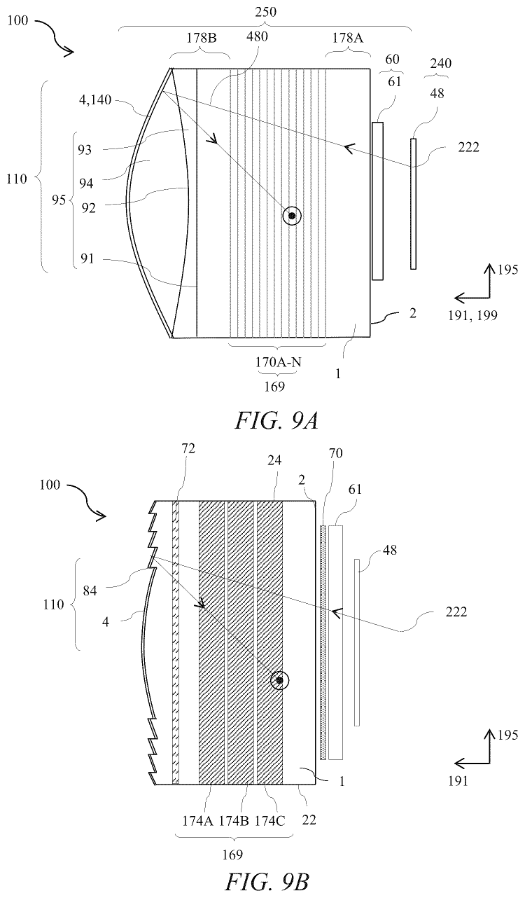

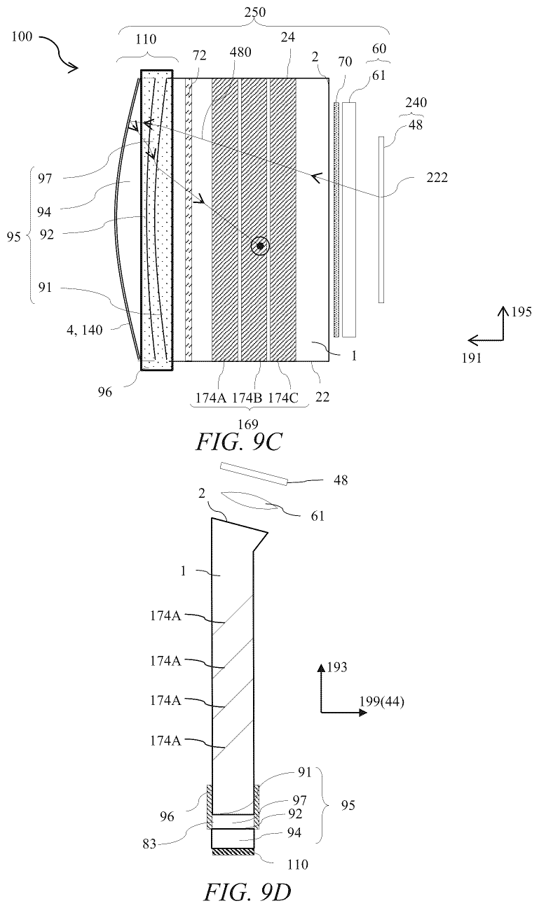

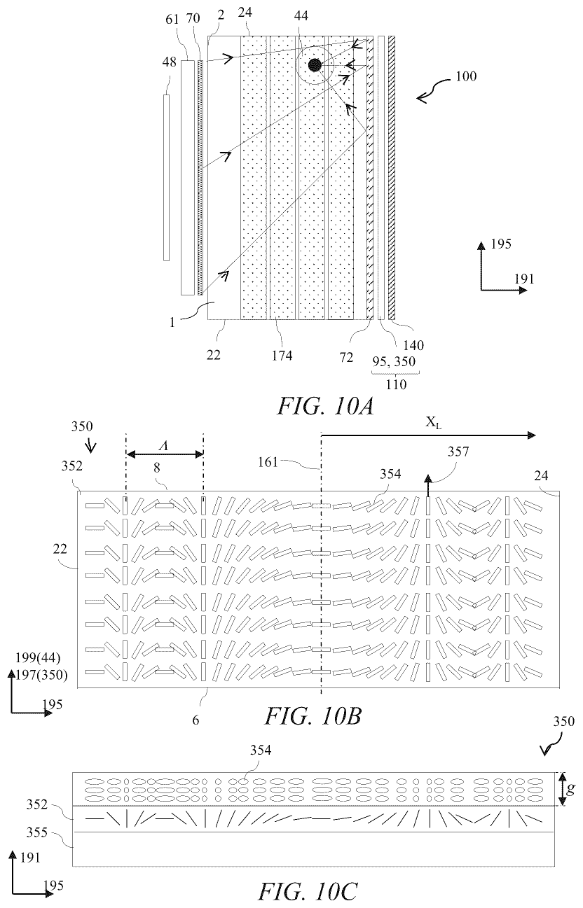

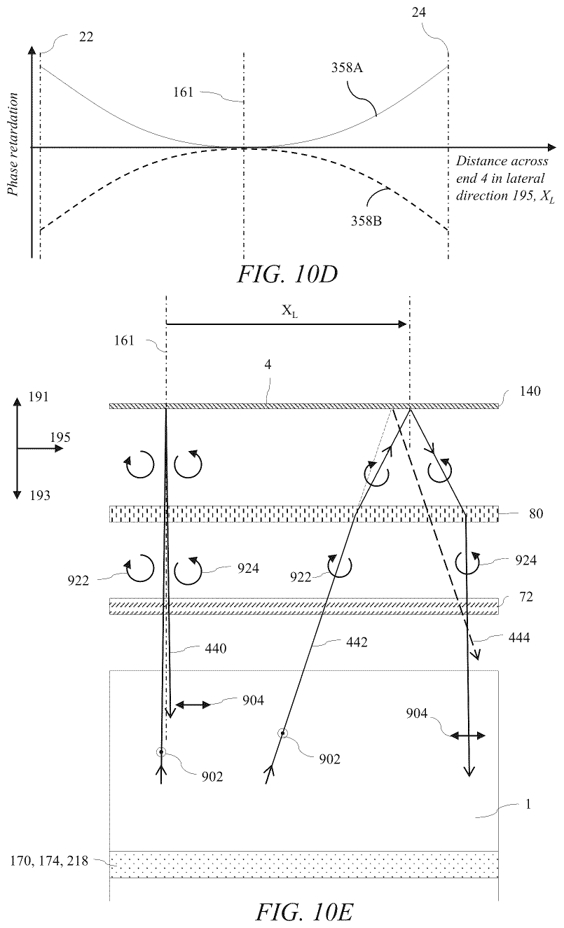

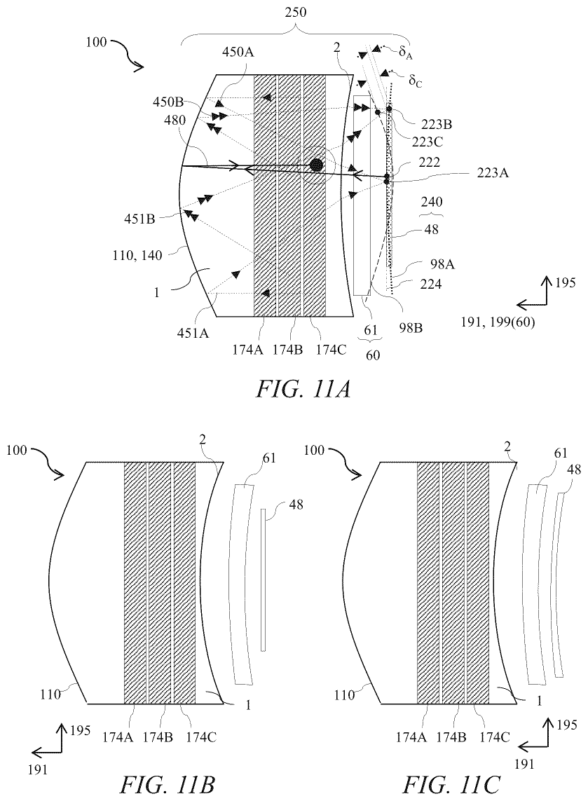

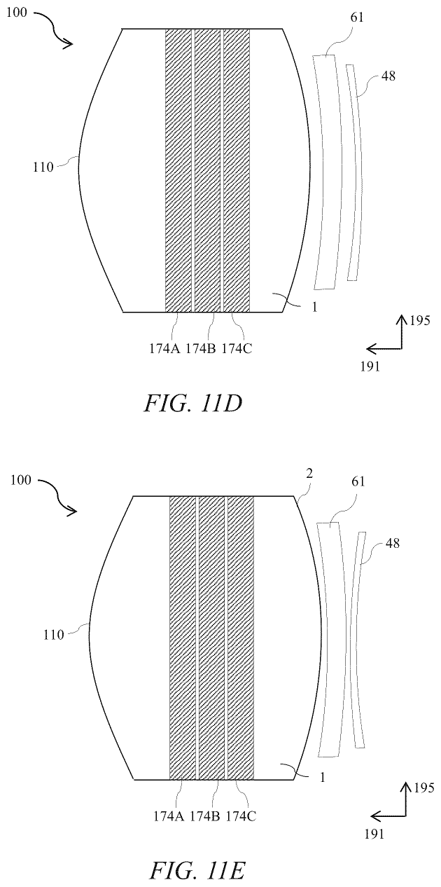

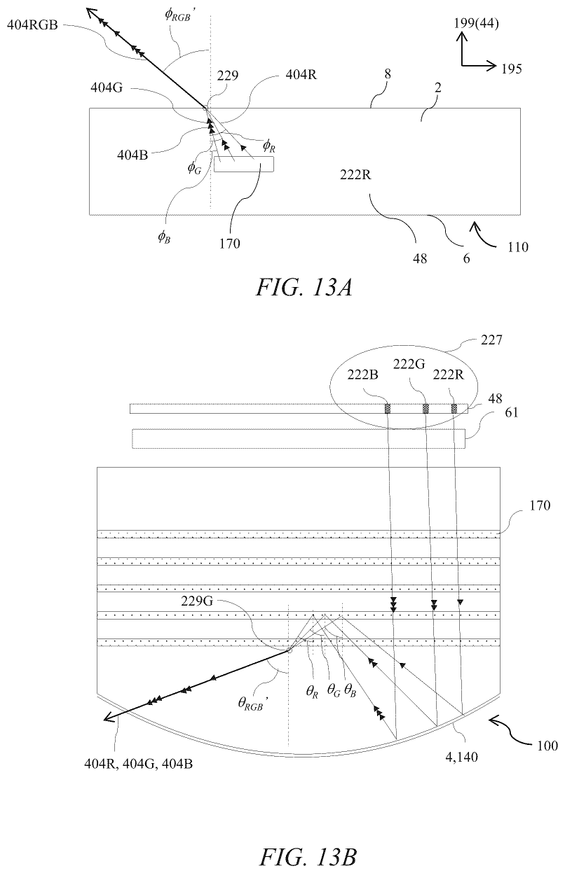

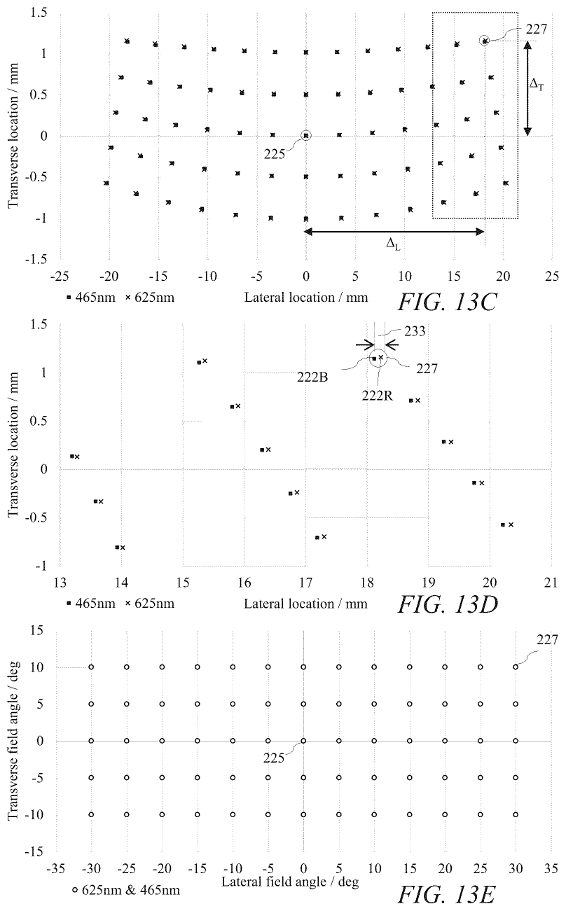

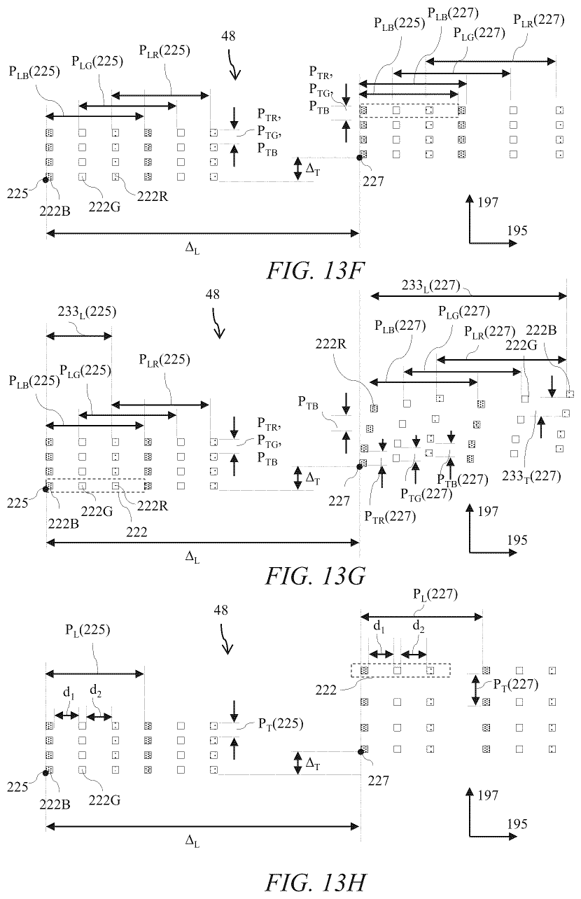

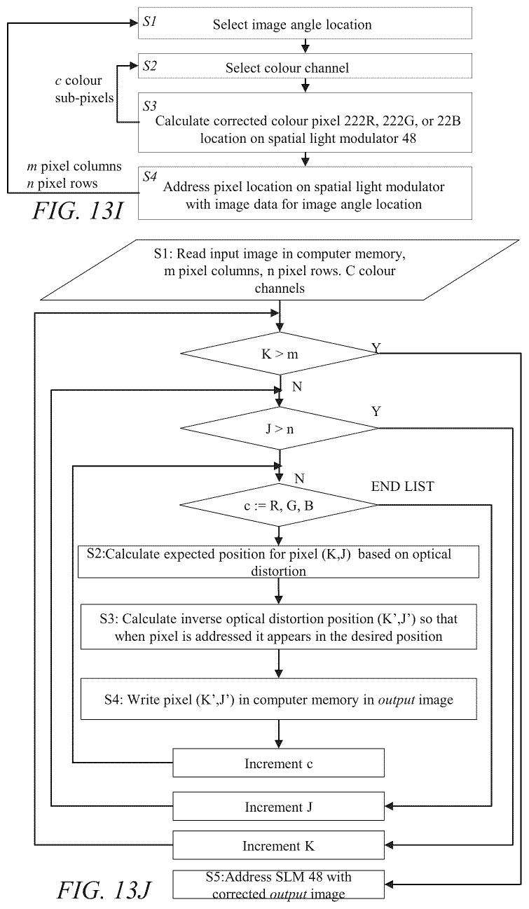

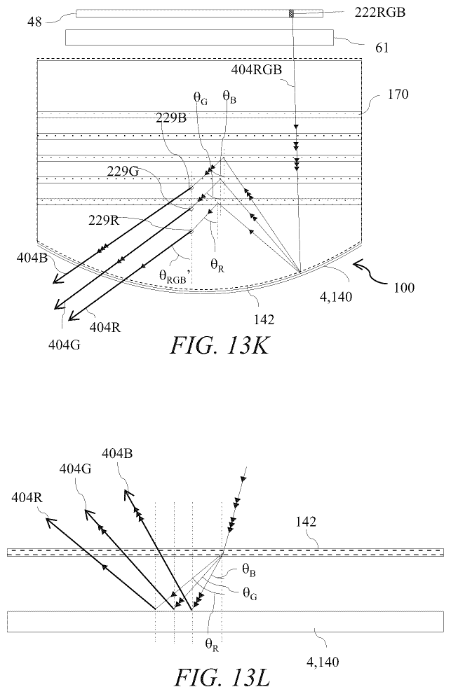

Any of these alternative arrangements of extraction features 169 may be provided in the extraction waveguides 1 for the embodiments of FIGS. 8A-F, FIGS. 9A-D, FIGS. 10A-F, FIGS. 11A-E, and FIGS. 13A-K disclosed hereinbelow.

FIG. 8A is a schematic diagram illustrating in side view part of an optical system 250 for an anamorphic near-eye display apparatus 100 comprising a half-silvered mirror 214 and a reflective polariser 218; and FIG. 8B is a schematic diagram illustrating optical axis alignment directions and polarisation states for light propagating through the polarisation control components of FIG. 8A. Features of the embodiment of FIGS. 8A-B not discussed in further detail may be assumed to correspond to the features with equivalent reference numerals as discussed above, including any potential variations in the features.

The alternative embodiment of FIG. 8A illustrates an anamorphic near-eye 45 display apparatus 100 comprising: an illumination system 240 comprising a spatial light modulator 48, the illumination system 240 being arranged to output light; and an optical system 250 arranged to direct light from the illumination system 240 to a viewer's eye 45. The optical system 250 has an optical axis 199 and has anamorphic properties in a lateral direction 195 and a transverse direction 197 that are perpendicular to each other and perpendicular to the optical axis 199. The spatial light modulator 48 comprises pixels 222 distributed in the lateral direction 195, illustrated by top pixel 222T, central pixel 222C and bottom pixel 222B. The optical system 250 comprises: a transverse anamorphic component 60 having positive optical power in the transverse direction 197, wherein the transverse anamorphic component 60 is arranged to receive light from the spatial light modulator 48 and the illumination system 240 is arranged so that light output from the transverse anamorphic component 60 is directed in directions that are distributed in the transverse direction 197. The extraction waveguide 1 is arranged to receive light rays 480T, 480C, 480B for respective pixels 222T, 222C, 222B and from the transverse anamorphic component 60. The lateral anamorphic component 110 (not shown in FIGS. 8A-B but for example as illustrated in FIG. 1A) has positive optical power in the lateral direction 195 and the extraction waveguide 1 is arranged to guide light from the transverse anamorphic component 60 to the lateral anamorphic component 110 along the extraction waveguide 1 in a first direction 191. The light reversing reflector 140 (not shown) is arranged to reflect light that has been guided along the extraction waveguide 1 in the first direction 191 so that the reflected light is guided along the extraction waveguide 1 in a second direction 193 opposite to the first direction 191, wherein the extraction waveguide 1 comprises an array of extraction features 169 (not shown), the extraction features 169 being arranged to transmit light guided along the extraction waveguide 1 in the first direction 191 and to extract light guided along the extraction waveguide 1 in the second direction 193 towards an eye 45 of a viewer, the array of extraction features 169 being distributed along the extraction waveguide 1 so as to provide exit pupil 40 expansion.

The transverse anamorphic component 60 comprises a light transmitting optical stack 610 comprising a partially reflective surface 214; a reflective linear polariser 218 and a polarisation conversion retarder 216.

The partially reflective surface 214 may comprise for example a partially transmissive metal layer that is formed on the surface 232A of a transmissive member 234A of a refractive lens 61. The reflective linear polariser 218 may be of the types as described elsewhere hereinabove.

In the embodiment of FIGS. 8A-B the polarisation conversion retarder 216 is disposed after the partially reflective surface 214 in a direction of transmission of light from the spatial light modulator 48 and disposed between the partially reflective surface 214 and the reflective linear polariser 218.

At least one of the partially reflective surface 214 and the reflective linear polariser 218 has positive optical power in the transverse direction 197. In the illustrative embodiment of FIG. 8A, each of the partially reflective surface 214 and the reflective linear polariser 218 are curved to provide positive optical power in the transverse direction 197 for light rays 480T, 480C, 480B.

The polarisation conversion retarder 216 is arranged to convert a polarisation state of light passing therethrough between a linear polarisation state and a circular polarisation state. For example linear polarisation state 964 is converted to circular polarisation state 962 or circular polarisation state 966 is converted to linear polarisation state 902.

The transverse anamorphic component 60 further comprises at least one lens element 61 comprising transmissive members 234A, 234B with respective outer surface 232A, 232B arranged on each side of the polarisation conversion retarder 216.

The at least one of the partially reflective surface 214 and the reflective linear polariser 218 that has positive optical power in the transverse direction 197 has no optical power in the lateral direction 195. Advantageously the partially reflective surface 214 and/or the reflective linear polariser 218 may be provided as a film that may be conveniently formed with a single plane of curvature without distortion of the film. For example the film may be conveniently adhered to a cylindrical surface with low cost and complexity and without degradation of the optical properties of the film.

The propagation of light rays 480T, 480C, 480B will now be described.

Considering the light rays 480T, 480C, 480B of FIG. 8A, the spatial light modulator 48 may be arranged to output linearly polarised light from respective pixels 222T, 222C, 222B respectively and most typically the illumination system 240 further comprises an output polariser 210 disposed between the spatial light modulator 48 and the transverse optical component 60, the output polariser 210 being arranged to output linearly polarised light with polarisation state 960.

The extraction waveguide 1 has an input end 2 extending in the lateral and transverse directions 195, 197, the extraction waveguide 1 being arranged to receive light from the illumination system 240 through the input end 2, and the transverse anamorphic component 60 is disposed between the spatial light modulator 48 and the input end 2 of the extraction waveguide 1.

The transverse anamorphic component 60 comprises a further polarisation conversion retarder 212 that is disposed before a partially reflective surface 214 and a reflective linear polariser 218 in a direction 191 of transmission of light from the spatial light modulator 48, which is arranged to convert the linear polarisation state 960 to a circular polarisation state 962. Polarisation conversion retarder 212 may be optically bonded to the linear polariser 210, advantageously reducing reflections and stray light.

At incidence on the partially reflective surface 214, some of the light ray 480T. 480C, 480B is transmitted and refracted while some light is reflected as light ray 482 with polarisation state 961 because of the a phase shift at reflection at the partially reflective surface 214. The partially reflective surface 214 of FIG. 8A is curved to provide refractive power in the transverse direction. Advantageously some optical power may be provided by the surface 232 curvature.

The circular polarisation state 962 is converted to linear polarisation state 964 by the polarisation conversion retarder 216. In the embodiment of FIG. 8A the polarisation conversion retarder 216 is arranged between transparent members 234A, 234B of lens 61. Advantageously image degradation from distortions of the flatness of the polarisation conversion retarder 216 may be reduced.

Light rays 480T, 480C, 480B are reflected at the reflective linear polariser 218 that is curved to provide optical power in the lateral direction 197 with wide spectral bandwidth. Linear polarisation state 964 is further converted to circular polarisation state 962 by a second pass through the polarisation conversion retarder 216; some of the light is reflected from partially reflective surface 214 with polarisation state 966; transmitted by a third pass through the polarisation conversion retarder 216 to provide polarisation state 902 that is transmitted by the reflective linear polariser 218. The curvature of the surface 232B of the lens 61 further provides refractive optical power at the output into air.

Clean-up polariser 70 may be provided to input polarisation state 902 into the input end 2 of the extraction waveguide 1.

In the embodiment of FIG. 8A, reflective optical power is provided by reflection and refraction at the curved partial reflective surface 214 and the reflective linear polariser 218. The profiles of the surfaces 232A, 232B may be arranged to provide desirable reduction of aberrations, reducing image blur and distortion and to further achieve reduced thickness of the transverse anamorphic component 60 in comparison to refractive lens 61 as described elsewhere herein.

The anamorphic near-eye display apparatus 100 may further comprise a linear polariser 70 arranged between the transverse anamorphic component 60 and the input end 2 of the extraction waveguide 1.

FIG. 8C is a schematic diagram illustrating in side view part of an optical system 250 for an anamorphic near-eye display apparatus 100 comprising a half-silvered mirror 214 and a reflective polariser 218; and FIG. 8D is a schematic diagram illustrating optical axis alignment directions and polarisation states for light propagating through the polarisation control components of FIG. 8C. Features of the embodiment of FIGS. 8C-D not discussed in further detail may be assumed to correspond to the features with equivalent reference numerals as discussed above, including any potential variations in the features.

In the alternative embodiment of FIGS. 8C-D the transverse anamorphic component 60 comprises a further polarisation conversion retarder 212 that is disposed after the partially reflective surface 214 and the reflective linear polariser 218 in a direction 191 of transmission of light from the spatial light modulator 48. The propagation of polarisation states 960, 970, 972, 902 are illustrated accordingly.

In comparison to the embodiment of FIG. 8A, the polarisation conversion retarder 216 is arranged on the surface 232A of a lens 61 transparent body 234 and between the reflective linear polariser 218 and the body 234. Advantageously the complexity of assembly may be reduced. The retarder 212 may further be arranged on the polariser 70, advantageously reducing surface reflections and stray light. The retarder 212 is distant from the spatial light modulator 48 so that the heating of the retarder 212 may be reduced, advantageously increasing lifetime.

Alternative arrangements of transverse anamorphic component 60 will now be described.

FIG. 8E is a schematic diagram illustrating in side view part of an optical system 250 for an anamorphic near-eye display apparatus 100 comprising a curved half-silvered mirror 214 and a planar reflective polariser 218; and FIG. 8F is a schematic diagram illustrating in side view part of an optical system 250 for an anamorphic near-eye display apparatus 100 comprising a planar half-silvered mirror 214 and a curved reflective polariser 218. Features of the embodiments of FIGS. 8E-F not discussed in further detail may be assumed to correspond to the features with equivalent reference numerals as discussed above, including any potential variations in the features.

In the alternative embodiment of FIG. 8E only the partially reflective surface 214 is curved and arranged on surface 232AA of a first lens 61A that further comprises curved surface 232AB and transparent body 234A. The surface 232BA of lens 61B is planar and has a curved surface 232BB of transparent body 234B. Reflective linear polariser 218 and polarisation conversion retarder 216 is arranged on the planar surface 232BA. Optical power is provided by refraction at surfaces 232AA, 232AB, 232BA and 232BB as well as reflection from the partially reflective surface 214 that is curved. The additional refractive surfaces 232AB, 232BA may be arranged to further improve aberrations. The material of the transparent body 234A may be different to the material of the transparent body 234B to advantageously achieve reduced chromatic aberrations.

By way of comparison, in the alternative embodiment of FIG. 8F only the reflective linear polariser 218 is curved and arranged on surface 232AA of a first lens 61A. Partially reflective surface 214 and polarisation conversion retarder 216 is arranged on the planar surface 232BA. Optical power is provided by refraction at surfaces 232AA, 232AB, 232BA and 232BB as well as reflection from the reflective linear polariser 218 that is curved.

FIGS. 5E-F further illustrate that polariser 70 may be omitted, advantageously reducing cost.

It would be desirable to improve the aberrational performance of an anamorphic near-eye display apparatus 100, for example reducing the image blur for off-axis directions.

FIG. 9A is a schematic diagram illustrating in front view an anamorphic near-eye display apparatus 100 wherein the lateral anamorphic component 110 comprises a curved reflective end 4 and further refractive components, in particular surfaces 91, 92 and intermediate materials 93, 94, that form part of the extraction waveguide 1 and are disposed between the reflective end 4 and the reflective extraction features 169. Features of the embodiment of FIG. 9A not discussed in further detail may be assumed to correspond to the features with equivalent reference numerals as discussed above, including any potential variations in the features.

FIG. 9A illustrates that the lateral anamorphic component 110 further comprises a lens 95 comprising in this example surfaces 91, 92 and intermediate materials 93, 94. The lens 95 may be arranged with rear and front guide surfaces 6, 8 that are co-planar with the opposing light guide surfaces 6, 8 of the waveguide. Advantageously high efficiency may be achieved.

In operation, the lens 95 may be arranged to provide improved aberrations in the lateral direction 195 over a wider exit aperture e_{L}. Thus the image blur 454 as illustrated in FIG. 1F may advantageously be reduced.

In the alternative embodiment of FIG. 9A, the extraction waveguide 1 is illustrated with stepped extraction reflectors 170, although the embodiments of FIGS. 9A-B are not limited to the stepped extraction reflectors 170 and any other reflective extraction features 169 described hereinbefore may be provided as alternatives.

It may be desirable to reduce the size of the reflective end.

FIG. 9B is a schematic diagram illustrating in front view an anamorphic near-eye display apparatus 100 wherein the lateral anamorphic component 110 comprises the reflective end 4 of the waveguide, which is formed in this example as a Fresnel reflector 97. Features of the embodiment of FIG. 9B not discussed in further detail may be assumed to correspond to the features with equivalent reference numerals as discussed above, including any potential variations in the features.

Fresnel reflector 84 is arranged to advantageously remove the sag of a domed reflective end 4 as illustrated in FIG. 9A.

In the alternative embodiment of FIG. 9B, the extraction waveguide 1 is illustrated with extraction reflectors 174 arranged between plural plates 180 although the other extraction reflectors described hereinbefore may be provided as alternatives.

It would be desirable to increase the optical power of the lens 95 illustrated in FIG. 9A, to achieve increased reduction of image blur.

FIG. 9C is a schematic diagram illustrating in front view an anamorphic near-eye display apparatus 100 wherein the lateral anamorphic component 110 comprises a refractive component 95 comprising an air gap and air gap mirrors 96; and FIG. 9D is a schematic diagram illustrating in side view the anamorphic near-eye display apparatus 100 of FIG. 9C. Features of the embodiments of FIGS. 9C-D not discussed in further detail may be assumed to correspond to the features with equivalent reference numerals as discussed above, including any potential variations in the features.

The alternative embodiment of FIG. 9A illustrates an anamorphic near-eye 45 display apparatus 100 comprising: an illumination system 240 comprising a spatial light modulator 48, the illumination system 240 being arranged to output light; and an optical system 250 arranged to direct light from the illumination system 240 to a viewer's eye 45. The optical system 250 has an optical axis 199 and has anamorphic properties in a lateral direction 195 and a transverse direction 197 that are perpendicular to each other and perpendicular to the optical axis 199. The spatial light modulator 48 comprises pixels 222 distributed in the lateral direction 195. The optical system 250 comprises: a transverse anamorphic component 60 comprising lens 61 having positive optical power in the transverse direction 197, wherein the transverse anamorphic component 60 is arranged to receive light from the spatial light modulator 48 and the illumination system 240 is arranged so that light output from the transverse anamorphic component 60 is directed in directions that are distributed in the transverse direction 197. The extraction waveguide 1 is arranged to receive light rays 480 for respective pixels 222 and from the transverse anamorphic component 60. The lateral anamorphic component 110 has positive optical power in the lateral direction 195 and the extraction waveguide 1 is arranged to guide light from the transverse anamorphic component 60 to the lateral anamorphic component 110 along the extraction waveguide 1 in a first direction 191. The light reversing reflector 140 is arranged to reflect light that has been guided along the extraction waveguide 1 in the first direction 191 so that the reflected light is guided along the extraction waveguide 1 in a second direction 193 opposite to the first direction 191, wherein the extraction waveguide 1 comprises an array of extraction features 169 comprising extraction reflectors 170A-N, the extraction features 169 being arranged to transmit light guided along the extraction waveguide 1 in the first direction 191 and to extract light guided along the extraction waveguide 1 in the second direction 193 towards an eye 45 of a viewer, the array of extraction features 169 being distributed along the extraction waveguide 1 so as to provide exit pupil 40 expansion.

In the alternative embodiment of FIGS. 9C-D, the lateral anamorphic component 110 comprises a lens 95 formed by at least one surface 91, 92 of an air gap 97 formed in the waveguide. Advantageously aberrations in the lateral direction may be reduced in comparison to the arrangement of FIG. 1A for example. Modulation transfer function may be increased and image blur reduced. Image contrast for fine details may be increased and image realism advantageously improved.

The air gap 97 has edges 83, and the anamorphic near-eye display apparatus 100 further comprises reflectors that are air gap mirrors 96 extending across the edges 83 of the air gap 97. The air gap mirrors 96 provide trapping of guiding light in the region of the air gap 97. Advantageously efficiency is increased and spatial uniformity improved.

The waveguide in which the air gap 97 is formed is the extraction waveguide 1 and the light reversing reflector 140 is a reflective end 4 of the extraction waveguide 1. The lateral anamorphic component 110 further comprises the light reversing reflector 140. Advantageously size and complexity is reduced and efficiency increased.

By comparison with FIG. 9A, in the alternative embodiment of FIG. 9C, the intermediate material 93 is replaced by an air gap 97 with surfaces 91, 92 facing the air gap 97. The refractive power of the surfaces 91, 92 may be modified, advantageously providing increased control of aberrations in the lateral direction 195. The surfaces 91, 92 may have circular, elliptical or other aspheric top view profiles to advantageously maximise image performance directed to the eye 45.

It would be desirable to reduce the size of the lateral anamorphic component 110. Alternative arrangements of lateral anamorphic component 110 comprising Pancharatnam-Berry lenses will now be described.

FIG. 10A is a schematic diagram illustrating in front view an anamorphic near-eye display apparatus 100 comprising a reflective end 4 comprising a Pancharatnam-Berry lens 350. Features of the embodiment of FIG. 10A not discussed in further detail may be assumed to correspond to the features with equivalent reference numerals as discussed above, including any potential variations in the features.

In the alternative embodiment of an anamorphic near-eye display apparatus 100 of FIG. 10A, the lens 95 of the lateral anamorphic component 110 is a Pancharatnam-Berry lens 350 and the light reversing reflector 140 is a planar mirror. Thus the Pancharatnam-Berry lens 350 is arranged between the extraction waveguide 1 and reflective end 4.

In the alternative embodiment of FIG. 10A, the extraction waveguide 1 is illustrated with extraction reflectors 174 arranged between plural plates 180 although the other extraction reflectors described hereinbefore may be provided as alternatives.

In operation, the Pancharatnam-Berry lens 350 provides optical power in the lateral direction 195(350) and no optical power in the transverse direction 197(350). The Pancharatnam-Berry lens 350 thus provides a similar operation to the curved reflective end 4 and curved reflective ends 4 with lens 95 described hereinabove. In alternative embodiments, not shown, the reflective end 4 may comprise a curved mirror and the optical power of the lateral anamorphic component 110 may be shared between the Pancharatnam-Berry lens 350 and the curved reflective end 4. Advantageously aberrations may be improved.

FIG. 10B is a schematic diagram illustrating in end view the optical structure of a Pancharatnam-Berry lens 350; FIG. 10C is a schematic diagram illustrating in front view the optical structure of the Pancharatnam-Berry lens of FIG. 10B. Features of the embodiment of FIGS. 10B-C not discussed in further detail may be assumed to correspond to the features with equivalent reference numerals as discussed above, including any potential variations in the features.

The alternative embodiments of FIG. 10B and FIG. 10C illustrate a Pancharatnam-Berry lens 350 comprising liquid crystal molecules 354 arranged on alignment layer 352 and support substrate 355. The alignment layer 352 provides component 357 of the liquid crystal molecule 354 director direction (typically the direction of the extraordinary index) that varies across the Pancharatnam-Berry lens 350 in the lateral direction 195. In the transverse direction 197(350) there is no variation of the component 357 of the director direction and so no phase modulation is provided by the Pancharatnam-Berry lens 350.

During manufacture, the alignment layer 352 may be formed for example by exposure and curing of a photoalignment layer with circularly polarised light with the desirable phase profile to achieve a variation of the optical axis direction 357. More specifically, an interference pattern is created between two oppositely circularly polarized wavefronts that creates locally linear polarized light whose orientation varies in the plane of the alignment layer to provide the desired alignment profile by the alignment layer 352. The alignment layer is thus oriented with linear polarized light to provide an optical axis direction 357 in the layer of liquid crystal material 354 that provides desirable optical power profile.

The layer of liquid crystal material 354 may have a thickness g that has a half wave thickness at a desirable wavelength of light, for example 550 nm. The liquid crystal material 354 may be a cured liquid crystal material such as a liquid crystal polymer or may be a nematic phase liquid crystal material arranged between opposing alignment layers.

FIG. 10D is a schematic graph illustrating the variation of phase difference with lateral position for an illustrative Pancharatnam-Berry lens of FIG. 10B. FIG. 10D illustrates the profile 358A of phase retardation across the Pancharatnam-Berry lens 350 across the end 4 in the lateral direction 195 for a monochromatic circularly polarised planar wave incident onto the Pancharatnam-Berry lens 350. The pitch A of the profile of phase across the Pancharatnam-Berry lens 350 varies across the lateral direction 195 to achieve said profile 358A, with a large pitch at the location 161 which may be the centre of the Pancharatnam-Berry lens 350 and reducing pitch A either side. As illustrated in FIG. 10B, the liquid crystal material director rotates across the pitch A, which for the circularly polarised incident light provides the phase difference and hence deflection of the incident wavefront.

At one location 161 of the Pancharatnam-Berry lens 350 that is typically the centre of the end 4 of the extraction waveguide 1, the liquid crystal molecules 354 are aligned such that there is no relative phase difference. Profile 358A illustrates the phase modulation for a first circular polarisation state (which may be right-handed circular polarisation state) and profile 358B illustrates the phase modulation for a second circular polarisation state orthogonal to the first polarisation state (which may be left-handed circular polarisation state).

FIG. 10E illustrates in front view the operation of a portion of a Pancharatnam-Berry lens 350 to provide the lateral anamorphic component 110 across the end 4 of the extraction waveguide 1 in the lateral direction 195. Features of the embodiment of FIG. 10E not discussed in further detail may be assumed to correspond to the features with equivalent reference numerals as discussed above, including any potential variations in the features.

The light rays 440, 442 incident onto the Pancharatnam-Berry lens 350 propagating along the direction 191 of the extraction waveguide 1 are polarised with the linear polarisation state 902.

For light ray 440 at the location 161, the incident polarisation state 902 is transmitted by the polarisation control retarder 72 with phase difference to provide circularly polarised state 922. The Pancharatnam-Berry lens 350 uses the polarisation control retarder 72 that is the same as the retarder used to optimise the transmission and reflectivity to polarised light of the dielectric layers of the extraction reflectors 170, 174, advantageously achieving improved efficiency.

The Pancharatnam-Berry lens 350 provides no relative phase modulation at the location 161, so that the reflection of light ray 440 from the light reversing reflector 140 provides the orthogonally circularly polarised state 924 that is transmitted as polarisation state 924 along the direction 193 back towards the extraction reflectors 169 that may be reflectors such as extraction reflectors 170, 174, 218 as described hereinabove.

For light ray 442 at the location offset by distance X_{L} in the lateral direction 195 from the location 161, the incident polarisation state 902 is again transmitted by the polarisation control retarder 72 with phase difference to provide circularly polarised state 922. The Pancharatnam-Berry lens 350 provides a gradient of phase difference so that the ray 442 representing a planar phase front is deflected in comparison to an illustrative undeflected ray 444. After reflection from the light reversing reflector 140, a further phase shift is provided by the Pancharatnam-Berry lens 350 so that the light ray 442 undergoes a further deflection. The reflected ray 442 propagating in the direction 193 along the extraction waveguide 1 is parallel to the returning ray 440. Thus the Pancharatnam-Berry lens 350, light reversing reflector 140 and polarisation control retarder 72, achieve the desirable optical function of the lateral anamorphic component 110.

Advantageously the physical size of the lateral anamorphic component 110 is reduced and a more compact arrangement achieved. The phase profile may further provide correction for aberrations of the lateral anamorphic component 110.

In other embodiments, plural Pancharatnam-Berry lenses 350 or Pancharatnam-Berry lenses 350 in combination with refractive lenses 95, for example as illustrated in FIG. 9A that may be separated in the direction 191 along the extraction waveguide 1 may be provided. Improved control of aberrations may be achieved and exit pupil 40 expanded in the lateral direction 195. Advantageously the blur PSF 452 of FIG. 1F may have a reduced lateral blur size 454_{L}.

It may be desirable to reduce image blur at higher lateral field angles.

FIG. 11A is a schematic diagram illustrating in front view an anamorphic near-eye display apparatus 100 wherein the input end 2 of the extraction waveguide 1 has curvature in the lateral direction 195. Features of the embodiment of FIG. 11A not discussed in further detail may be assumed to correspond to the features with equivalent reference numerals as discussed above, including any potential variations in the features.

The alternative embodiment of FIG. 11A illustrates an anamorphic near-eye 45 display apparatus 100 comprising: an illumination system 240 comprising a spatial light modulator 48, the illumination system 240 being arranged to output light; and an optical system 250 arranged to direct light from the illumination system 240 to a viewer's eye 45.

The optical system 250 has an optical axis 199 and has anamorphic properties in a lateral direction 195 and a transverse direction 197 that are perpendicular to each other and perpendicular to the optical axis 199. The spatial light modulator 48 comprises pixels 222 distributed in the lateral direction 195.

The optical system 250 comprises: a transverse anamorphic component 60 having positive optical power in the transverse direction 197, wherein the transverse anamorphic component 60 is arranged to receive light from the spatial light modulator 48 and the illumination system 240 is arranged so that light output from the transverse anamorphic component 60 is directed in directions that are distributed in the transverse direction 197.

The extraction waveguide 1 is arranged to receive light rays 489 for respective pixels 222 and from the transverse anamorphic component 60.

The lateral anamorphic component 110 has positive optical power in the lateral direction 195 and the extraction waveguide 1 is arranged to guide light from the transverse anamorphic component 60 to the lateral anamorphic component 110 along the extraction waveguide 1 in a first direction 191.

The light reversing reflector 140 is arranged to reflect light that has been guided along the extraction waveguide 1 in the first direction 191 so that the reflected light is guided along the extraction waveguide 1 in a second direction 193 opposite to the first direction 191, wherein the extraction waveguide 1 comprises an array of extraction features 169 comprising extraction reflectors 174A-C, the extraction features 169 being arranged to transmit light guided along the extraction waveguide 1 in the first direction 191 and to extract light guided along the extraction waveguide 1 in the second direction 193 towards an eye 45 of a viewer, the array of extraction features 169 being distributed along the extraction waveguide 1 so as to provide exit pupil 40 expansion.

Returning to the description of FIG. 5A and by way of comparison with the present embodiment, FIG. 5A illustrates an input end 2, transverse anamorphic component 60 and spatial light modulator 48 with pixels 222 lying on pixel surface 224 that has no curvature in the lateral direction 195.

In practice, aberrations of the lateral anamorphic component 110 have Petzval field curvature with an illustrative curved field surface 98B shown in FIG. 11A that is separated by distance δ from the pixel surface 224 that varies. Image pixels 222 on surface 224 that are more widely separated in the direction 191 from the field surface 98B have reduced modulation transfer function (MTF), appearing more blurry. Considering the field surface 98B then pixels 222 that are off-axis in the lateral direction 195 may be perceived with increased image blur in comparison to pixels 222 that are on-axis.

It would be desirable to provide pixels 222 of the spatial light modulator 48 that are on a field surface 98A that is close to the pixel surface 224 of the illumination system 240 across the spatial light modulator 48 in the lateral direction 195.

Considering the embodiment of FIG. 11A, the curved input end 2 of the extraction waveguide provides a modified field surface 98A.

In operation, light ray 480 is an illustrative light ray for output light from pixel 222 on the transverse anamorphic component 60 that is directed towards the eye 45 of an observer. Indicative light rays 450A. 451A, 450B, 451B illustrate light rays that would propagate from the eye 45 towards the spatial light modulator 48 if a light source were to be arranged at a location corresponding to the retina 46 of the eye 45. Indicative light rays 450A, 451A form indicative image point 223A and indicative light rays 450B, 451B form indicative image point 223B where indicative image points 223A, 223B lie in the surface 98A.

Considering the point of best focus 223B, the separation δ_{AB} of the surface 98A from the plane of the pixels 222 of the spatial light modulator 48 is reduced across the field of view in comparison to the separation 6B provided by surface 98B that would provide a point of best focus 223C.

In the alternative embodiment of FIG. 11A, the input end 2 of the extraction waveguide 1 thus has a curvature in the lateral direction 195 that compensates for Petzval field curvature of the lateral anamorphic component 110. Thus the desirable field surface 98A provided by FIG. 11B is more closely aligned to the pixel plane 224 of the spatial light modulator 48. MTF for off-axis field points is increased and advantageously image blur is reduced.

Alternative embodiments to reduce field curvature will now be described.

FIG. 11B is a schematic diagram illustrating in front view an anamorphic near-eye display apparatus 100 wherein the input end 2 of the extraction waveguide 1 has curvature in the lateral direction 195 and the transverse anamorphic component 60 has curvature in the lateral direction 195. FIG. 11C is a schematic diagram illustrating in front view an anamorphic near-eye display apparatus 100 wherein the input end 2 of the extraction waveguide 1 has curvature in the lateral direction 195, the transverse anamorphic component 60 has curvature in the lateral direction 195, and the spatial light modulator 48 has curvature in the lateral direction 195; FIG. 11D is a schematic diagram illustrating in front view an anamorphic near-eye display apparatus 100 wherein the input end 2 of the extraction waveguide 1 has curvature in the lateral direction 195, the transverse anamorphic component 60 has curvature in the lateral direction 195 and the spatial light modulator 48 has curvature in the lateral direction 195, where the direction of curvature of each of the input end 2, the transverse anamorphic component and the spatial light modulator 48 is opposite to that of FIG. 11C; and FIG. 11E is a schematic diagram illustrating in front view an anamorphic near-eye display apparatus 100 wherein the input end 2 of the extraction waveguide 1 has curvature in the lateral direction 195, the transverse anamorphic component 60 has curvature in the lateral direction 195, and the spatial light modulator 48 has curvature in the lateral direction 195, where the direction of curvature of each of the input end 2 and the transverse anamorphic component is the opposite to that of FIG. 11C, and the direction of curvature of the spatial light modulator 48 is the same as that of FIG. 11C. Features of the embodiments of FIGS. 11B-E not discussed in further detail may be assumed to correspond to the features with equivalent reference numerals as discussed above, including any potential variations in the features.

The alternative embodiments of FIGS. 11B-E are examples illustrating the case that at least one of the input end 2 of the extraction waveguide 1, the transverse anamorphic component 60 and the spatial light modulator 48 has a curvature in the lateral direction 195 in a manner that compensates for Petzval field curvature of the lateral anamorphic component 110. The directions of curvature of respective elements 2, 60, 48 may be modified to achieve optimised image performance so that the MTF for off-axis field points is further increased and advantageously image blur is reduced.

In comparison to non-anamorphic components, the curvature may be arranged about only one axis. In particular, the spatial light modulator 48 may comprise a silicon or glass backplane. Such backplanes are not typically suitable for curvature about two axes. However in the present embodiments, single axis curvature may achieve desirable correction for field curvature. Advantageously the cost of achieving a suitably curved spatial light modulator 48 may be reduced.

Returning to the description of FIG. 1F, it would be desirable to reduce the lateral colour blur 455_{L}, and the transverse colour blur 455_{T} of the anamorphic near-eye display apparatus 100 of the present embodiments.

FIG. 12A is a schematic diagram illustrating in end view extraction of coloured light from an extraction waveguide 1 illuminated by a white pixel 222RGB comprising co-located red sub-pixel 222R, green sub-pixel 222G and blue sub-pixel 222B; and FIG. 12B is a schematic diagram illustrating in front view extraction of coloured light from an extraction waveguide 1 illuminated by a white pixel 222RGB comprising co-located red sub-pixel 222R, green sub-pixel 222G and blue sub-pixel 222B.

FIG. 12A illustrates a view of propagation of a white light ray 404RGB from a single point on an illustrative white pixel 222RGB after reflection from extraction reflector 170. The white light ray 404RGB is incident at location 229 on the front guide surface 8 and output towards the eye 45. The dispersion of the material from which the extraction waveguide 1 is formed means that for a given angle of incidence ϕ_{RGB} (with lateral and transverse direction components) output directions 404R, 404G, 404B are provided for illustrative red wavelength light (such as 625 nm), green wavelength light (such as 550 nm) and blue wavelength light (such as 465 nm) respectively, providing output directions ϕ_{R}′, ϕ_{G}′, ϕ_{B}′. For typical dispersive materials, ϕ_{R}′ is less than ϕ_{B}′. The colour blur 455 when imaged onto the retina 46 provides undesirable splitting of red, green and blue pixels.

FIG. 12B further illustrates in a different view of the propagation of a light ray 404RGB. In operation, ray 404RGB that is outputted to the eye 45 in a ray bundle that is most typically output from illustrative white pixel 222RGB in a direction close to the optical axis 199(110) direction when propagating in the first direction 191. Such operation may be referred to as telecentric operation.

Ray 404RGB is reflected by the extraction reflector 170 to the front guide surface 8 at location 229 provide the output light rays 404R, 404G, 404B separated by an angle of colour blur 455.

FIG. 12C is a schematic graph illustrating a reference array of pixel 222 locations on the surface of a spatial light modulator 48; FIG. 12D is a schematic graph illustrating the array of angular output directions corresponding to the array of pixel locations of FIG. 12C in an illustrative embodiment of an anamorphic near-eye display apparatus; and FIG. 12E is a schematic graph illustrating the region 231 of the graph of FIG. 12D.

FIG. 12C illustrates the location of reference pixels 225, 227 on a regular array and FIG. 12D illustrates corresponding angular field locations for the pixels 225, 227 for the pixels 222 at locations of FIG. 12C after imaging through an illustrative embodiment of the anamorphic near-eye display apparatus 100 with surface profiles with a structure similar to that illustrated in FIG. 3D.

FIGS. 12D-E illustrates that the output angular array of directions is provided with pincushion distortion across the array of directions, and further the chromatic blur 455 is seen as described in FIGS. 12A-B.

It would be desirable to reduce colour blur 455.

FIG. 13A is a schematic diagram illustrating in end view extraction of coloured light from an extraction waveguide 1 illuminated by a white pixel comprising separated red, green, and blue colour sub-pixels 222R, 222G, 222B; and FIG. 13B is a schematic diagram illustrating in front view extraction of coloured light from an extraction waveguide 1 illuminated by a white pixel comprising separated red, green and blue colour sub-pixels 222R, 222G, 222B. Features of the embodiment of FIGS. 13A-B not discussed in further detail may be assumed to correspond to the features with equivalent reference numerals as discussed above, including any potential variations in the features.

In comparison to FIGS. 12A-B, FIGS. 13A-B illustrate output ray directions 404RGB that are the same for the rays 404R, 404G, 404B incident onto the location 229 at the front guide surface 8. Thus in FIG. 13A, angles of incidence ϕ_{R}, ϕ_{G}, ϕ_{B} for rays 404R, 404G, 404B respectively are output with a common angle of refraction ϕ_{RGB}′, and for FIG. 13A, angles of incidence θ_{R}, θ_{G}, θ_{B} for rays 404R, 404G, 404B respectively are output with a common angle of refraction θ_{RGB}′. To achieve the rays 404R, 404G, 404B the pixels 222R, 222G, 22B are spatially separated on the spatial light modulator 48.

FIG. 13C is a schematic graph illustrating a corrected array of pixel locations 222R, 222B on the surface of a spatial light modulator 48; FIG. 13D is a schematic graph illustrating a region of the graph of FIG. 13C; and FIG. 13E is a schematic graph illustrating the array of angular output directions corresponding to the array of pixel locations of FIG. 13C in an illustrative embodiment of an anamorphic near-eye display apparatus. Features of the embodiment of FIGS. 13C-E not discussed in further detail may be assumed to correspond to the features with equivalent reference numerals as discussed above, including any potential variations in the features.

In the alternative embodiment of FIGS. 13C-D, for rays directed to angular location 227, corresponding sub-pixels 222R, 222B are indicated, illustrating that the lateral location has shifted for red and blue wavelengths.

FIG. 13E illustrates that embodiments in which the relative location of colour sub-pixels 222R, 222G and 222B on the spatial light modulator 48 are moved in location to adjust for distortion and colour shift can achieve a uniform distribution of angular locations.

Arrangements of colour sub-pixels 222R, 222G, 222B to provide the pixel array of FIG. 13C will now be described.

FIG. 13F is a schematic diagram illustrating in front view arrangements of colour sub-pixels 222R, 222G, 222B for first and second locations 225, 227 on the spatial light modulator 48, wherein the pitch P_{LR}, P_{LG}. P_{LB} in the lateral direction vary; FIG. 13G is a schematic diagram illustrating in front view arrangements of colour sub-pixels 222R, 222G, 222B for first and second locations 225, 227 on the spatial light modulator 48, wherein the pitch P_{LR}, P_{LG}, P_{LB} of the sub-pixels 222R, 222G. 222B of each colour component across the pixels 222 in the lateral direction varies in the lateral direction 195 and the pitch P_{TR}, P_{TG}, P_{TB} in the transverse direction of the sub-pixels 222R. 222G, 222B of each colour component across the pixels 222 in the transverse direction varies in the transverse direction 197; and FIG. 13H is a schematic diagram illustrating in front view arrangements of colour sub-pixels 222R, 222G, 222B for first and second locations 225, 227 on the spatial light modulator 48, wherein the pitch of the pixels 222 varies in the lateral and transverse directions but the separation of the sub-pixels 222R, 222G, 222B for a single pixel 222 in the lateral direction is constant. Features of the embodiment of FIGS. 13F-H not discussed in further detail may be assumed to correspond to the features with equivalent reference numerals as discussed above, including any potential variations in the features.

The alternative embodiments of FIGS. 13F-H illustrate an anamorphic near-eye 45 display apparatus 100 such as illustrated in FIG. 1A comprising: an illumination system 240 comprising a spatial light modulator 48, the illumination system 240 being arranged to output light; and an optical system 250 arranged to direct light from the illumination system 240 to a viewer's eye 45. The optical system 250 has an optical axis 199 and has anamorphic properties in a lateral direction 195 and a transverse direction 197 that are perpendicular to each other and perpendicular to the optical axis 199. The spatial light modulator 48 comprises pixels 222 distributed in the lateral direction 195. The optical system 250 comprises: a transverse anamorphic component 60 comprising lens 61 having positive optical power in the transverse direction 197, wherein the transverse anamorphic component 60 is arranged to receive light from the spatial light modulator 48 and the illumination system 240 is arranged so that light output from the transverse anamorphic component 60 is directed in directions that are distributed in the transverse direction 197. The extraction waveguide 1 is arranged to receive light rays 480 for respective pixels 222 and from the transverse anamorphic component 60. The lateral anamorphic component 110 has positive optical power in the lateral direction 195 and the extraction waveguide 1 is arranged to guide light from the transverse anamorphic component 60 to the lateral anamorphic component 110 along the extraction waveguide 1 in a first direction 191. The light reversing reflector 140 is arranged to reflect light that has been guided along the extraction waveguide 1 in the first direction 191 so that the reflected light is guided along the extraction waveguide 1 in a second direction 193 opposite to the first direction 191, wherein the extraction waveguide 1 comprises an array of extraction features 169 comprising extraction reflectors 170A-N, the extraction features 169 being arranged to transmit light guided along the extraction waveguide 1 in the first direction 191 and to extract light guided along the extraction waveguide 1 in the second direction 193 towards an eye 45 of a viewer, the array of extraction features 169 being distributed along the extraction waveguide 1 so as to provide exit pupil 40 expansion.

Considering the alternative embodiment of FIG. 13F, the spatial light modulator 48 comprises an array of pixels 222, wherein each pixel 222 comprises sub-pixels 222R, 222G, 222B of plural colour components. The pitch P_{LG}, P_{LR}, P_{LB} of the sub-pixels 222R, 222G, 222B of each colour component across the pixels 222 in the lateral direction 195 varies between the colour components in a manner that compensates for chromatic aberration between light 404R, 404G, 404B of the colour components. Considering location 225 the pitch P_{LG}(225), P_{LR}(225), P_{LB}(225) is different to the pitch P_{LG}(227), P_{LR}(227), P_{LB}(227) at the location 227 (separated by distance Δ_{L}, Δ_{T} in the lateral and transverse directions 195, 197 respectively on the spatial light modulator 48. The sub-pixels 222R, 222G, 222B of each pixel 222 are disposed with the same pitch in the transverse direction 197 so that the pitch P_{TG}, P_{TR}, P_{TB} is constant across the array of pixels 222 in the transverse direction 197. Advantageously the visibility of chromatic blur 455 in the lateral direction 195 and the visibility of image distortion can be reduced.

In the alternative embodiment of FIG. 13F, the sub-pixels 222R, 222G, 222B of each pixel 222 are aligned in the transverse direction 197. Further, the pitch P_{T}. Pro, P_{T} of the sub-pixels 222R, 222G. 222B of each colour component across the pixels 222 in the transverse direction 197 is the same for each colour component. Advantageously complexity of structure of spatial light modulator 48 is reduced.

In the alternative embodiment of FIG. 13G, the pitch P_{TR}, P_{TG}, P_{TB} of the sub-pixels 222R, 222G, 222B of each colour component across the pixels 222 in the transverse direction 197 varies between the colour components in a manner that compensates for chromatic aberration between light of the colour components. Considering the alternative embodiment of FIG. 13G, in comparison to the embodiment of FIG. 13F, the sub-pixels 222R, 222G, 222B of each pixel 222 are disposed with different pitches in the transverse direction 197 so the pitch P_{TG}(227), P_{TR}(227), P_{TB}(227) varies across the array of pixels 222 in the transverse direction 197. Advantageously the visibility of chromatic blur 455_{L}, 455_{T} in the lateral and transverse directions 195, 197 respectively can be reduced.

Considering the alternative embodiment of FIG. 13H, in comparison to the embodiment of FIG. 13F, the sub-pixels 222R, 222G, 222B of each pixel 222 are disposed with the same spacings d₁, d₂ in the lateral direction 195 and the spacing P_{L}(227), P_{T} (227), varies across the array of pixels 222 in the lateral and transverse directions 195, 197. Advantageously the visibility of distortion may be reduced.

It may be desirable to reduce the complexity of the spatial light modulator 48 while achieving reduced chromatic blur 455 and image distortion.

FIG. 13I is a flowchart illustrating a method to provide calculation of the location of the array of red, green and blue colour sub-pixels of the spatial light modulator comprising c different colour sub-pixels, m pixel columns and n pixel rows; and FIG. 13J is an alternative flowchart illustrating a method to provide calculation of the location of the array of red, green and blue colour sub-pixels of the spatial light modulator comprising c different colour sub-pixels, m pixel columns and n pixel rows.

With reference to the exemplary method illustrated in FIG. 13I, in a first step S1, an image angle is selected, for example the image angle corresponding to a panel location 227 in FIG. 13E.

In a second step S2, the colour channel is selected, for example the red colour channel.

In a third step S3, the corrected colour sub-pixel location 222R on the spatial light modulator 48 is calculated. Steps S2 and S3 area repeated for the three colour sub-pixels 222G, 222B.

In a fourth step S4, image data is addressed to the respective pixel location such that the correct image data is sent to the correct direction. The steps S1-S4 are then repeated for each image angular location, for example as illustrated by the array of FIG. 13E and the image angular locations therebetween the elements of the array.

With reference to the exemplary method illustrated in FIG. 13J, in a first step S1, a desired image of m columns and n rows with c colour channels is read into computer memory and the variables K, J and c are initialised to values corresponding to the first pixel in the image array (for example 0, 0, R), then while the test conditions are not met, step S2 is performed in which the optical position of the pixel is calculated based on the known optical distortion of the system. Then step S3 is performed in which the inverse distortion is mathematically calculated for the image pixel position so that when it is written or output by the system it will be displayed in the originally desired position. Step S4 writes or outputs the modified pixel position. The values of c, K and J are then incremented until the entire original image is processed and a new output image is produced. In step S5, the SLM 48 may then be written or addressed with the pre corrected image which will undo the distortions of the system and then render the appearance of the original image.

An alternative embodiment comprising the method of FIGS. 13I-J may be provided for the pixel arrangements of FIGS. 2A-D for example. In such fixed pixel 222 arrays, the image data is provided to compensate for colour and distortion errors.

In alternative embodiments, the method of FIGS. 13I-J may be provided for pixel arrangements of FIGS. 13F-H. Advantageously chromatic image blur 455 and image distortions may be further reduced.

It may be desirable to provide further reduction of chromatic image blur 455 that arises from refraction at the front light guide surface 8.

In the present description, the colour pixels 222R, 222G, 222B may more generally be provided by other or alternative wavelength bands including but not limited to white sub-pixels, yellow sub-pixels, magenta sub-pixels and cyan sub-pixels. The pixel 222 may comprise three sub-pixels or a number of sub-pixels different to three, for example one sub-pixel in a monochromatic display apparatus 100 or four sub-pixels in an extended colour gamut display apparatus 100.

FIG. 13K is a schematic diagram illustrating in front view extraction of coloured light from an extraction waveguide 1 illuminated by a white pixel 222RGB, wherein the extraction waveguide 1 further comprises a colour splitting diffractive optical element 142 arranged between the light reversing reflector 140 and the array of extraction reflectors 170; and FIG. 13L is a schematic diagram illustrating in front view operation of the colour splitting diffractive optical element 142 of FIG. 13K.

In the alternative embodiment of FIGS. 13K-L, the colour splitting diffractive optical element 142 is arranged to diffract incident light ray 404RGB so that light incident onto the light reversing reflector 140 is incident with different angles θ_{R}, θ_{G}, θ_{B} that are output as light rays 404R, 404G, 404B respectively. The diffractive spreading may have the inverse dispersion as that provided by the dispersive refraction at the front light guide surface 8. Advantageously chromatic blur 455 may be reduced.

The colour splitting diffractive optical element 142 may be a grating, such as a Pancharatnam-Berry lens, with operation as described elsewhere herein with respect to FIGS. 10A-B for example, or may be another type of diffractive optical element such as a volume hologram.

Alternative arrangements of illumination systems and transverse anamorphic components 60 will now be described.

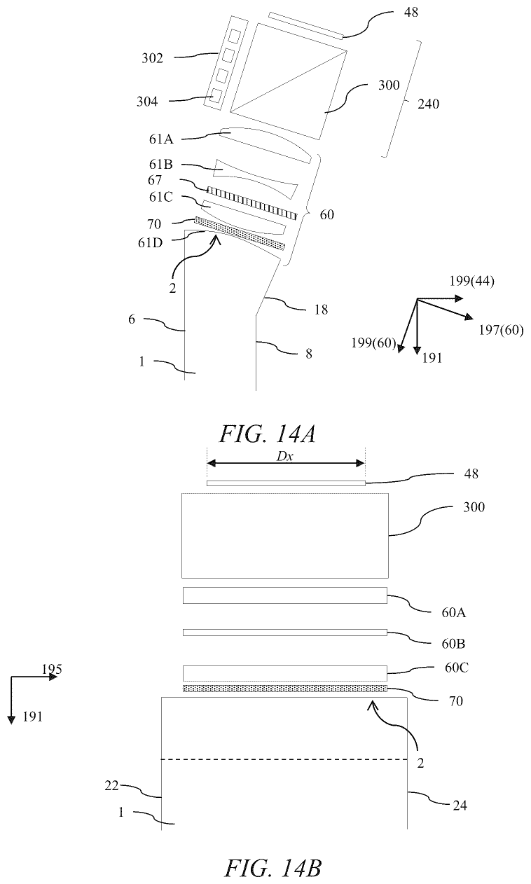

FIG. 14A is a schematic diagram illustrating in side view a detail of an arrangement of a transverse lens 61 that forms a transverse anamorphic component 60; and FIG. 14B is a schematic diagram illustrating in front view a detail of the arrangement of the transverse lens 61 of FIG. 14A. Features of the embodiment of FIGS. 14A-B not discussed in further detail may be assumed to correspond to the features with equivalent reference numerals as discussed above, including any potential variations in the features.

In the alternative embodiment of FIG. 14A, the transverse lens 61 forming the transverse anamorphic component 60 comprises a compound lens 61A-C. Further the compound lens may comprise a lens 61D comprising the curved input end 2 of the extraction waveguide 1. FIG. 14B illustrates that the illumination system 240 and transverse anamorphic component 60 do not provide optical power in the lateral direction 195, that is the compound lenses 61A-D are cylindrical or elongate with a non-spherical surface profile, for example aspheric such as illustrated by the shapes of lenses 61A-B to achieve improved field aberrations and advantageously increased MTF at higher field angles.

Advantageously aberrations in the transverse direction 197(60) may be improved.

Further, the illumination system may comprise a reflective spatial light modulator 48, an illumination array 302 comprising light sources 304 and a beam combiner cube arranged to illuminate the spatial light modulator 48. The illumination array 302 may comprise different coloured light sources so that the spatial light modulator 48 may provide time sequential colour illumination.

FIG. 14A further illustrates that the transverse anamorphic component 60 may comprise a transverse diffractive component 67 that is provided with optical power in the transverse direction 197. The component 67 may have chromatic aberrations that are angularly varying so as to correct for chromatic aberrations from the refractive components 60A-D in the transverse direction 197. Colour blurring in the transverse direction 197 may advantageously be reduced.

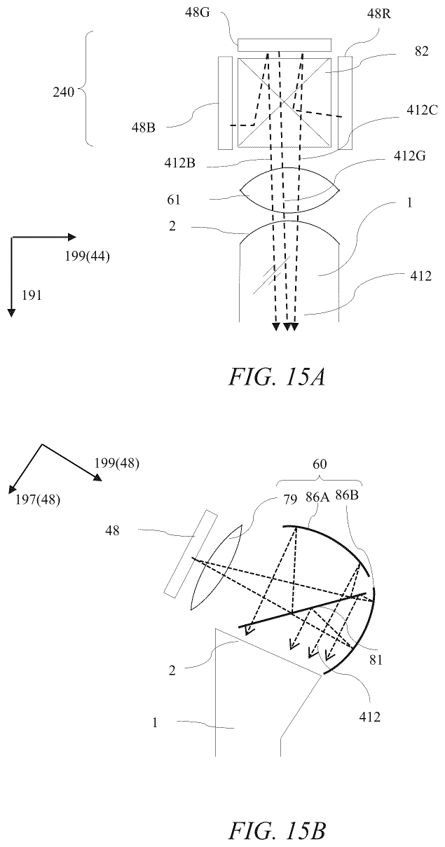

FIG. 15A is a schematic diagram illustrating in side view a spatial light modulator arrangement 50 for use in the anamorphic near-eye display apparatus 100 of FIG. 1A comprising separate red, green and blue spatial light modulators 48R, 48G, 48B and a beam combining element 82. Features of the embodiment of FIG. 15A not discussed in further detail may be assumed to correspond to the features with equivalent reference numerals as discussed above, including any potential variations in the features.

The alternative embodiment of FIG. 15A illustrates that the illumination system 240 may comprise red, green and blue spatial light modulators 48R, 48G, 48B and a colour combining prism arrange to direct light rays 412R, 412G, 412B towards the transverse anamorphic component 60. Such an arrangement may be used to provide high resolution colour imagery from emissive spatial light modulators 48 for example. Emissive displays may be OLED on silicon or microLED on silicon spatial light modulators 48 for example. Advantageously high resolution colour virtual images may be provided.

FIG. 15B is a schematic diagram illustrating in side view an illumination system 240 and transverse anamorphic component 60 for use in the anamorphic near-eye display apparatus 100 of FIG. 1A comprising a birdbath folded arrangement. Features of the embodiment of FIG. 15B not discussed in further detail may be assumed to correspond to the features with equivalent reference numerals as discussed above, including any potential variations in the features.

In the alternative embodiment of FIG. 15B, the spatial light modulator 48 illuminates a catadioptric illumination system 240 comprising input lens 79, curved mirror 86A and partially reflective mirror 81 such that rays 412 are directed into the input side 2 of the extraction waveguide 1. Advantageously chromatic aberrations in the transverse direction 197 may be reduced. The partially reflective mirror 81 may be a polarising beam splitter or may be a thin metallised layer for example.

Additionally or alternatively curved mirror 86B may be provided to increase efficiency of operation.

FIG. 16 is a schematic diagram illustrating in perspective front view an alternative arrangement of an input focusing lens 61. Features of the embodiment of FIG. 16 not discussed in further detail may be assumed to correspond to the features with equivalent reference numerals as discussed above, including any potential variations in the features.

Spatial light modulator 48 comprises active area 49A and border 49B and is aligned to the lens of the transverse anamorphic component 60 that is a compound lens comprising lenses 60A-F. Some of the lenses 60A-F may comprise surfaces that have a constant radius and some may comprise variable radius surfaces such that in combination aberration correction is advantageously improved. Some of the lenses 60A-F may comprise aspheric surfaces to achieve improved aberrations, such as reducing field curvature.

Alternative arrangements of spatial light modulator 48, illumination system 240 and optical system 250 will now be described.

FIG. 17 is a schematic diagram illustrating in side view a spatial light modulator arrangement for use in the anamorphic near-eye display apparatus of FIG. 1A comprising a spatial light modulator 48 comprising a laser 50, a scanning arrangement 51 and a light diffusing screen 52. Features of the embodiment of FIG. 17 not discussed in further detail may be assumed to correspond to the features with equivalent reference numerals as discussed above, including any potential variations in the features.

In the alternative embodiment of FIG. 17, the spatial light modulator 48 comprises the laser 50 arranged to direct a beam 490 towards scanning arrangement 51 that may be a rotating mirror for example, with oscillation 53 that is synchronised to the image data.

The beam 490 is arranged to illuminate a screen 52 to provide a diffuse light source 55 at the screen. The screen 52 may comprise a diffusing arrangement so that the transmitted light is diffused into light cone 491 arranged to provide input light rays 492 into the transverse anamorphic component 60 and extraction waveguide 1.

The screen 52 may alternatively comprise a photoemission layer such as a phosphor laser at which the laser beam 490 is arranged to produce emission from the photoemission layer. The output colour can advantageously be independent of the laser 50 emission wavelength. Further laser speckle may be reduced.

The laser 50 may comprise a one dimensional array of laser emitting pixels 222 across a row 221T and the scanning arrangement 51 may provide one dimensional array of light sources 55 at the screen 52 for each addressable row of the spatial light modulator 48. The scanning speed of the scanning arrangement 51 is reduced, advantageously achieving reduced cost and complexity.

Alternatively the laser 50 may comprise a single laser emitter and the scanning arrangement 51 may provide two dimensional scanning of the beam 490 to achieve a two dimensional pixel array of emitters 55 at the screen 52. Advantageously laser 50 cost may be reduced.

Further arrangements comprising laser sources will now be described.

FIG. 18A is a schematic diagram illustrating in side view input to the extraction waveguide 1 comprising a spatial light modulator 48 comprising laser sources and a scanning arrangement 51; FIG. 18B is a schematic diagram illustrating in front view a spatial light modulator 48 comprising a row of laser light sources 172 for use in the arrangement of FIG. 18A; and FIG. 18C is a schematic diagram illustrating an alternative illumination arrangement. Features of the embodiment of FIGS. 18A-C not discussed in further detail may be assumed to correspond to the features with equivalent reference numerals as discussed above, including any potential variations in the features.

The alternative embodiment of FIG. 18A comprises a transverse anamorphic component 60 that is formed by a deflector element 50 that comprises scanning mirror 51.

FIG. 18B illustrates a spatial light modulator 48 suitable for use in the arrangement of FIG. 18A comprising a one dimensional array of pixels 222A-N wherein the pixels 222A-N each comprise a laser source. Control system 500 is arranged to supply line-at-a-time image data to spatial light modulator 48 controller 505 that outputs pixels data to laser pixels 222A-N by means of driver 509; and location data to scanning arrangement 51 by means of scanner driver 511. The laser pixels 222A-N are arranged in a single row with pitch P_{L} in the lateral direction 195 that is the same as illustrated in FIG. 2D for example.

Returning to the description of FIG. 18A, in operation, image data for a first addressed row of image data are applied to the laser pixels 222A-N and the scanning arrangement 51 adjusted so that the laser light from the spatial light modulator 48 is directed as ray 490A in a first direction across the transverse direction 197. At a different time, image data for a different addressed row of image data are applied to the laser pixels 222A-N and the scanning arrangement 51 adjusted so that the laser light from the spatial light modulator 48 is directed as ray 490B in a different direction across the transverse direction 197. The transverse anamorphic component 60 is thus arranged to receive light from the spatial light modulator 48 and the illumination system 240 is arranged so that light output from the transverse anamorphic component 60 is directed in directions illustrated by rays 490A. 490B that are distributed in the transverse direction with cone 491.

In other words, the scanning arrangement 51 scans about the lateral direction 197(60) and serves to provide illustrative light rays 490A, 490B sequentially. By means of sequential scanning, the scanning arrangement 51 effectively has positive optical power in the transverse direction 197(60) for light from the spatial light modulator 48, achieving output cone 491 in a sequential manner. In this manner, the scanning arrangement 51 directs light in directions that are distributed in the transverse direction, allowing it to serve as a transverse anamorphic component 60. The scanning of the scanning arrangement 51 may be arranged not to direct light near to parallel to the direction 191 along the extraction waveguide 1. Advantageously double imaging is reduced.

Advantageously the cost and complexity of the illumination system 240 and transverse anamorphic component 60 may be reduced.

The alternative embodiment of FIG. 18C provides beam expander 61A, 61B that increases the width 63 of the output beam from the illumination system 240. In FIG. 18C, the illumination system 240 further comprises a deflector element 50 arranged to deflect light output from the transverse anamorphic component 60 by a selectable amount, the deflector element 50 being selectively operable to direct the light output from the transverse anamorphic component 60 in the directions that are distributed in the transverse direction 197. Advantageously uniformity of the output image from across the exit pupil 40 is provided.

Embodiments including alternative forms of reflective extraction features 169 to those of FIG. 1A will now be described. It may be desirable to reduce the manufacturing cost and complexity of the extraction waveguide 1.

FIG. 19A is a schematic diagram illustrating a front perspective view of an anamorphic near-eye display apparatus 100 comprising a stepped extraction waveguide 1; and FIG. 19B is a schematic diagram illustrating in side view the operation of the anamorphic near-eye display apparatus 100 of FIG. 19A. Features of the embodiment of FIGS. 19A-B not discussed in further detail may be assumed to correspond to the features with equivalent reference numerals as discussed above, including any potential variations in the features.

In the alternative embodiment of FIG. 19A the extraction features 169 are provided by steps 12A-D separated by intermediate regions 10. The rear guide surface 8 thus has a stepped shape comprising a plurality of facets 12 extending in a lateral direction 195 across the extraction waveguide 1 and oriented to reflect input light from the input end 2 through the front guide surface 8 as output light, and intermediate regions 10 between the facets 12 that are arranged to direct light through the extraction waveguide 1 without extracting it. Stepped extraction waveguides are described further in U.S. Pat. No. 9,594,261, herein incorporated by reference in its entirety.

By way of comparison with FIG. 1A, the arrangement of FIGS. 19A-B may provide an extraction waveguide 1 that is more conveniently manufactured and with advantageously lower cost.

The anamorphic near-eye display apparatus 100 of FIGS. 19A-B may comprise various embodiments arranged to improve aberrations and improve image quality as described elsewhere herein. The transverse anamorphic component 60 may comprise a light transmitting optical stack 610 such as illustrated with reference to FIGS. 8-F. The lateral anamorphic component 110 may comprise the arrangements illustrated with reference to FIGS. 7A-I. Field curvature may be improved by the arrangements of FIGS. 9A-D. Aberration control and power of anamorphic components 60, 110 may be further improved by the Pancharatnam-Berry lenses of FIGS. 10A-F for use in the lateral anamorphic component 110 and/or transverse anamorphic component 60. Chromatic aberrations and image distortions may be improved as illustrated in FIGS. 13A-K hereinabove for example.

It may be desirable to improve the image luminance uniformity.

FIG. 20A is a schematic diagram illustrating in perspective front view an alternative arrangement of the anamorphic near-eye display apparatus 100 wherein the reflective extraction features 169 comprise extraction reflectors 174A-D comprising plural constituent plates 180A-E and FIG. 20B is a schematic diagram illustrating in side view the operation of the anamorphic near-eye display apparatus 100 of FIG. 20A. Features of the embodiment of FIGS. 20A-B not discussed in further detail may be assumed to correspond to the features with equivalent reference numerals as discussed above, including any potential variations in the features.

In comparison to FIG. 1A, in the alternative embodiment of FIG. 20, the extraction waveguide 1 comprises plural constituent plates 180A-E optically coupled together, wherein the extraction reflectors 174A-D are formed between the constituent plates 180A-E. The extraction reflectors 174A-D extend between the opposing rear and front guide surfaces 6, 8 of the extraction waveguide 1. In other words, the extraction reflectors 174A-E extend across the entirety of the extraction waveguide 1 between the opposing rear and front guide surfaces 6, 8; however typically some regions 178A. 178B along the extraction waveguide 1 may be provided without extraction reflectors 174 as discussed hereinabove.

In the alternative embodiment of FIG. 20A-B, the extraction reflectors 174 have the same reflective area. Advantageously luminance variations with viewing angle may be reduced.

The anamorphic near-eye display apparatus 100 of FIGS. 20A-B may comprise various embodiments arranged to improve aberrations and improve image quality as described elsewhere herein. The transverse anamorphic component 60 may comprise a light transmitting optical stack 610 such as illustrated with reference to FIGS. 8-F. The lateral anamorphic component 110 may comprise the arrangements illustrated with reference to FIGS. 7A-1. Field curvature may be improved by the arrangements of FIGS. 9A-D. Aberration control and power of anamorphic components 60, 110 may be further improved by the Pancharatnam-Berry lenses of FIGS. 10A-F for use in the lateral anamorphic component 110 and/or transverse anamorphic component 60. Chromatic aberrations and image distortions may be improved as illustrated in FIGS. 13A-K.

It may be desirable to increase the efficiency of operation and to reduce the complexity of manufacture.

FIG. 21A is a schematic diagram illustrating a front perspective view of an anamorphic near-eye display apparatus 100 comprising a polarisation-sensitive reflector 700; FIG. 21B is a schematic diagram illustrating in side view the operation of the anamorphic near-eye display apparatus 100 of FIG. 21A for light propagating in the first direction 191 along the extraction waveguide 1; FIG. 21C is a schematic diagram illustrating in side view the operation of the anamorphic near-eye display apparatus 100 of FIG. 21A for light propagating in the second direction 193 along the extraction waveguide 1; FIG. 21D is a schematic diagram illustrating a side view of polarised light propagation in the anamorphic near-eye display apparatus of FIG. 21A; FIG. 21E is a schematic diagram illustrating a front view of polarised light propagation in the anamorphic near-eye display apparatus of FIG. 21A; and FIG. 21F is a schematic diagram illustrating alignment directions through the polarisation control components of FIGS. 21D-E. Features of the embodiment of FIGS. 21A-F not discussed in further detail may be assumed to correspond to the features with equivalent reference numerals as discussed above, including any potential variations in the features.

The anamorphic near-eye display apparatus 100 comprises: an illumination system 240 comprising a spatial light modulator 48, the illumination system 240 being arranged to output light; and an optical system 250 arranged to direct light from the illumination system 240 to the pupil 44 of a viewer's eye 45, wherein the optical system 250 has an optical axis 199 and has anamorphic properties in a lateral direction 195 and a transverse direction 197 that are perpendicular to each other and perpendicular to the optical axis 199, wherein the spatial light modulator 48 comprises pixels 222 distributed in the lateral direction 195, and the optical system 250 comprises: a transverse anamorphic component 60 having positive optical power in the transverse direction 197, wherein the transverse anamorphic component 197 is arranged to receive light from the spatial light modulator 48 and the illumination system 240 is arranged so that light output from the transverse anamorphic component 60 is directed in directions that are distributed in the transverse direction 197, an extraction waveguide 1 arranged to receive light from the transverse anamorphic component 60; a lateral anamorphic component 110 having positive optical power in the lateral direction 195, the extraction waveguide 1 being arranged to guide light from the transverse anamorphic component 60 to the lateral anamorphic component 195 along the extraction waveguide 1 in a first direction 191; and a light reversing reflector 140 that is arranged to reflect light guided along the extraction waveguide 1 in the first direction 191 to form light that is guided along the extraction waveguide 1 in a second direction 193 opposite to the first direction.

The extraction waveguide 1 comprises: a front guide surface 8; a polarisation-sensitive reflector 702 opposing the front guide surface 8; and an extraction element 169 disposed outside the polarisation-sensitive reflector 702, the extraction element 169 comprising: a rear guide surface 6 opposing the front guide surface 8; and an array of extraction features 272A-D.

The anamorphic near-eye display apparatus 100 is arranged to provide light 401 guided along the extraction waveguide 1 in the first direction 191 with an input linear polarisation state 902 before reaching the polarisation-sensitive reflector 702; and the optical system 250 further comprises a polarisation conversion retarder 72 disposed between the polarisation-sensitive reflector 702 and the light reversing reflector 140, wherein the polarisation conversion retarder 72 is arranged to convert a polarisation state of light passing therethrough between a linear polarisation state 902 and a circular polarisation state 922, and the polarisation conversion retarder 72 and the light reversing reflector 140 are arranged in combination to rotate the input linear polarisation state 902 of the light guided in the first direction 191 so that the light guided in the second direction 193 and output from the polarisation conversion retarder 72 has an orthogonal linear polarisation state 904 that is orthogonal to the input linear polarisation state 902; the polarisation-sensitive reflector 702 is arranged to reflect light guided in the first direction having the input linear polarisation state 902 and to pass light guided in the second direction 193 having the orthogonal linear polarisation state 194, so that the front guide surface 8 and the polarisation-sensitive reflector 702 are arranged to guide light 401 in the first direction 191, and the front guide surface 8 and the rear guide surface 6 are arranged to guide light 406 in the second direction 193, and the array of extraction features 172 is arranged to extract light guided along the extraction waveguide 1 in the second direction 193 towards an eye 45 of a viewer through the front guide surface 8, the array of extraction features 172 being distributed along the extraction waveguide 1 so as to provide exit pupil expansion 40 in the transverse direction 197.

Extraction waveguide 1 comprises waveguide member IIlA between the front guide surface 8 and polarisation-sensitive reflector 700 and waveguide member 111B between the polarisation-sensitive reflector 700 and the rear guide surface 6.

Considering FIG. 21B, the propagation of light rays in cone 491 that are distributed in the transverse direction 197 are illustrated. On-axis light ray 401 from a pixel 222 of the spatial light modulator 48 is directed through the transverse anamorphic component 60 into the extraction waveguide 1.

The polarisation-sensitive reflector 700 may comprise a reflective linear polariser 702, or a dielectric stack for example. Light ray 401 has a polarisation state 902 provided by the input polariser 70 and propagates in the direction 191 by guiding between the polarisation-sensitive reflector 700 and the front guide surface 8.

The light cone 491_{T} is incident on the reflective linear polariser 702 and is reflected such that a replicated light cone 491_{T}f is provided propagating along the extraction waveguide 1 in the direction 191.

FIG. 3C illustrates the propagation of corresponding reflected light cones 493_{T}, 493_{T}f after reflection at the light reversing component 140. In the transverse direction 197, the lateral anamorphic component 110 has no optical power and has a surface normal direction that is parallel to the first directions 191, 193. The visibility of artefacts arising from stray light including double images and ghost images may be reduced.

The reflected light cones 493_{T}, 493_{T}f propagate along the second direction 193 about optical axes 199(60) and 199f(60). Corresponding transverse directions 197(60), 197f(60) are also indicated.

Reflected light rays propagating in the second direction 193 along the extraction waveguide 1 have polarisation state 904 that is provided by polarisation conversion retarder 72 (that may be a quarter waveplate for example) at or near the lateral anamorphic component 110 and reflection from the light reversing reflector 140.

Both cones 493_{T}, 493_{T}f comprise image data that between the cones 493_{T}, 493_{T}f is flipped about the direction 191 and thus provides degeneracy of ray directions for a given pixel 222 on the spatial light modulator 48. It is desirable to remove such degeneracy so that only one of the cones 493_{T}, 493_{T}f is extracted and a secondary image is not directed to the pupil 44 of the eye 45.

Output light ray 401 propagates by total internal reflection of opposing surfaces 6, 8 until it is incident on a guide surface 176 at which at least some light is reflected, and then at extraction facet 172 at which at least some light is further reflected as will be described further hereinbelow such that light cone 493_{T} is preferentially directed towards the front guide surface 8. After refraction at the light guide surface 8, light in the cone 495_{T} is extracted towards the eye 45, with a cone angle that has increased size compared to the cone 493_{T}.

The extraction facets 172A-E are inclined at the same angle, such that for each of the light extraction facets 172A-E of FIG. 1A, the light cones 493_{T} are parallel and image blur for light ray 401 extracted to the pupil 44 from different extraction facets 172 across the waveguide is advantageously reduced.

By way of comparison, the light cone 493_{T}f around light ray 461 which is incident on the surface 8 and then directly incident on extraction facet 172 without first reflecting from the guide surface 176 for preferential transmission through the extraction facet 172, and light cone 493_{T}f is not directed towards the eye 45. Degeneracy is reduced or removed and image cross-talk or reflected images are advantageously reduced.

The present embodiments enable the uniformity of output to be improved in comparison to the anamorphic near-eye display apparatus 100 of FIGS. 19A-B and is more conveniently manufactured in comparison to the anamorphic near-eye display apparatus 100 of FIGS. 20A-B. Further, relatively high efficiency output may be achieved with a wide spectral bandwidth.

FIG. 21G is a schematic diagram illustrating a side view of polarised light propagation in the anamorphic near-eye display apparatus 100 of FIGS. 7F-G wherein the extraction waveguide 1 comprises a polarisation-sensitive reflector 702; and FIG. 21H is a schematic diagram illustrating a side view of polarised light propagation in the anamorphic near-eye display apparatus 100 of FIGS. 7H-I wherein the waveguide comprises a polarisation-sensitive reflector 702. Features of the embodiment of FIGS. 21G-H not discussed in further detail may be assumed to correspond to the features with equivalent reference numerals as discussed above, including any potential variations in the features.

In the alternative embodiment of FIG. 21G, the anamorphic near-eye display apparatus 100 comprises an: extraction waveguide 1 comprising: a front guide surface 8; a polarisation-sensitive reflector 702 opposing the front guide surface 8; and an extraction element 270 disposed outside the polarisation-sensitive reflector 702, wherein the extraction element 270 comprises: a rear guide surface 6 opposing the front guide surface 8; and the array of extraction features 169 comprising inclined extraction reflectors 272A-D.

The anamorphic near-eye display apparatus 100 is arranged to provide light guided along the extraction waveguide 1 in the first direction 191 with an input linear polarisation state 902 before reaching the polarisation-sensitive reflector 702.

A polarisation conversion retarder 89 is disposed between the reflective linear polariser 99 and the light reversing reflector 140 is a first polarisation conversion retarder 89. The anamorphic near-eye display apparatus 100 comprises a second polarisation conversion retarder 87 arranged between the polarisation-sensitive reflector 702 and the reflective linear polariser 99, the second polarisation conversion retarder 87 being arranged to convert from a state that is parallel or orthogonal to the input linear polarisation state 902 to a polarisation state 990 that has a component parallel to the input linear polarisation state 902 and a component orthogonal to the input linear polarisation state 902.

The anamorphic near-eye display apparatus 100 comprises an absorptive linear polariser 85 arranged to pass the component 991 orthogonal to the input linear polarisation state 902. In an alternative embodiment, the absorptive linear polariser 85 may be arranged to pass the component parallel to the input linear polarisation state 902.

The reflective linear polariser 99 is arranged to pass the same component 991 as the absorptive linear polariser 85.

The second polarisation conversion retarder 87, the absorptive linear polariser 85, the reflective linear polariser 99, the first polarisation conversion retarder 89 and the light reversing reflector 140 are arranged in combination to rotate the input linear polarisation state 902 of the light guided in the first direction 191 so that the light guided in the second direction 193 and output from the second polarisation conversion retarder 87 has a linear polarisation state 997 that has a component 999P parallel to the input linear polarisation state 902 and a component 999S orthogonal to the input linear polarisation state 902.

The polarisation-sensitive reflector 702 is arranged to reflect light guided in the first direction 191 having the input linear polarisation state 902 and to pass the component 999S of light guided in the second direction 193 that is orthogonal to the input linear polarisation state 902, so that the front guide surface 8 and the polarisation-sensitive reflector 702 are arranged to guide light in the first direction 191, and the front guide surface 8 and the rear guide surface 6 are arranged to guide the component 999S of light that is orthogonal to the input linear polarisation state 902 in the second direction 193.

The polarisation-sensitive reflector 702 may comprise a reflective linear polariser or at least one dielectric layer.

The alternative embodiment of FIG. 21H provides second polarisation conversion retarder 88 that is arranged to provide rotation of a linear polarisation state, such as a half waveplate in comparison to the second polarisation conversion retarder 87 of FIG. 21G that is arranged to provide conversion between a linear and circular polarisation state, such as a quarter waveplate. Control of input light losses for light propagating in the first direction 191 may be balanced with output light losses for light propagating in the second direction 193 may be achieved.

Advantageously improved aberrations may be achieved in at least the lateral direction 195 and an extraction waveguide 1 with reduced cost and complexity may be provided.

An alternative extraction arrangement will now be described.

FIG. 21I is a schematic diagram illustrating a front perspective view of an anamorphic near-eye display apparatus comprising a polarisation-sensitive reflector wherein the extraction element is a deflection element; FIG. 21J is a schematic diagram illustrating a side view of the anamorphic near-eye display apparatus of FIG. 21I; and FIG. 21K is a schematic diagram illustrating a side view of a portion of the anamorphic near-eye display apparatus of FIG. 21I. Features of the embodiment of FIGS. 21I-K not discussed in further detail may be assumed to correspond to the features with equivalent reference numerals as discussed above, including any potential variations in the features.

By way of comparison with FIG. 21A, in the alternative embodiment of FIGS. 21I-K, the extraction waveguide 1 comprises a rear guide surface 6 and a polarisation-sensitive reflector 700 opposing the rear guide surface 6; the anamorphic directional illumination device 1000 that may be an anamorphic near-eye display apparatus further comprises a deflection arrangement 112 disposed outside the polarisation-sensitive reflector 700, the anamorphic directional illumination device 1000 is arranged to provide light guided along the extraction waveguide 1 in the first direction 191 with an input linear polarisation state 902 before reaching the polarisation-sensitive reflector 700. The optical system 250 further comprises a polarisation conversion retarder 72 disposed between the polarisation-sensitive reflector 700 and the light reversing reflector 140, wherein the polarisation conversion retarder 72 is arranged to convert a polarisation state 902 of light passing therethrough between a linear polarisation state and a circular polarisation state 922, and the polarisation conversion retarder 72 and the light reversing reflector 140 are arranged in combination to rotate the input linear polarisation state 902 of the light guided in the first direction 191 so that the light guided in the second direction 193 and output from the polarisation conversion retarder 72 has an orthogonal linear polarisation state 904 that is orthogonal to the input linear polarisation state 902. The polarisation-sensitive reflector 700 is arranged to reflect light guided in the first direction 191 having the input linear polarisation state 902 so that the rear guide surface 6 and the polarisation-sensitive reflector 700 are arranged to guide light in the first direction 191, and to pass light guided in the second direction 193 having the orthogonal linear polarisation state 904 so that the passed light is incident on the deflection arrangement 112; and the deflection arrangement 112 is arranged to deflect at least part of the light passed by the polarisation-sensitive reflector 700 that is incident thereon towards an output direction forwards of the anamorphic directional illumination device 1000.

In the embodiment of FIG. 21A-K, the extraction features are provided in the deflection arrangement 112 as deflection element 116, deflection features 118 and reflectors 117.

Considering FIG. 21K, in operation, the light ray 460C(191) may be transmitted with high efficiency along the extraction waveguide 1. The reflected light ray 460C(193) is transmitted by the polarisation-sensitive reflector 700 onto an intermediate polarisation conversion retarder 73 with optical axis direction 773 arranged to convert the incident p-polarisation state 904 to an s-polarisation state 902. Deflection arrangement 112 comprises deflection element 116 that comprises deflection features 118A that are reflectors 117 that may be partially reflective. At least some of the light 460C_{R}(193) with s-polarisation state 902 is transmitted by draft facet 118B and reflected to output towards the eye 45 of the viewer. Some of the light 460C_{T}(193) is transmitted and guides within the front waveguide 114 comprising front guide surface 8. Such light is directed to output at deflection features 118A at different locations in the second direction 193. Advantageously exit pupil 40 size is increased and image uniformity improved.

The polarisation-sensitive reflector 700 may comprise reflective polarisers 702, dichroic stacks 712 or other types of polarisation-sensitive reflectors. The partially reflective layer 275 may be provided by dichroic stacks 276, metallic layers or other partially reflective layers. The partially reflective layers 275 may be polarisation sensitive.

By way of comparison with the embodiments of FIGS. 21A-H, the alternative embodiment of FIG. 21I-K provides output light 460CR(193) that does not pass back through the polarisation-sensitive reflector 700 after deflection. Advantageously stray light is reduced and image quality improved.

The anamorphic near-eye display apparatus 100 of FIGS. 21A-K may comprise various embodiments arranged to improve aberrations and improve image quality as described elsewhere herein. The transverse anamorphic component 60 may comprise a light transmitting optical stack 610 such as illustrated with reference to FIGS. 8A-F. The lateral anamorphic component 110 may comprise the arrangements illustrated with reference to FIGS. 7A-I. Field curvature may be improved by the arrangements of FIGS. 9A-D. Aberration control and power of anamorphic components 60, 110 may be further improved by the Pancharatnam-Berry lenses of FIGS. 10A-F for use in the lateral anamorphic component 110 and/or transverse anamorphic component 60. Chromatic aberrations and image distortions may be improved as illustrated in FIGS. 13A-K. The features mentioned above may be provided in isolation or in combination.

It may be desirable to further reduce the cost and complexity of the extraction waveguide 1.

FIG. 22A is a schematic diagram illustrating in perspective front view an alternative arrangement of the anamorphic near-eye display apparatus 100 wherein the extraction waveguide 1 comprises a diffractive optical element 11B; FIG. 22B is a schematic diagram illustrating in side view the operation of the anamorphic near-eye display apparatus 100 of FIG. 22A. Features of the embodiment of FIGS. 22A-B not discussed in further detail may be assumed to correspond to the features with equivalent reference numerals as discussed above, including any potential variations in the features.

Considering the alternative embodiment of FIG. 22A, the extraction waveguide 1 comprises a transmissive element 11A and a diffractive optical element 11B optically coupled to the transmissive element 11A. The operation of the transverse anamorphic component 60 and lateral anamorphic component 110 are as described elsewhere herein.

The diffractive optical element 11B is arranged to provide extraction of some of the light guided in the extraction waveguide 1 between the opposing rear and front guide surfaces 6, 8, wherein the diffractive optical element 11B is arranged between the opposing rear and front guide surfaces 6, 8. Central ray 460C on the optical axis 199(60) along the first direction 191 of the extraction waveguide 1 is partially reflected by the diffractive optical element 11B to output light 464 away from the eye 45. After reflection at the light reversing reflector, light is further reflected.

Advantageously the extraction features 169 that are diffractive optical element 11B may be conveniently manufactured and attached to the transmissive element 11A.

The anamorphic near-eye display apparatus 100 of FIGS. 22A-B may be modified to include any of the various features described above that are arranged to improve aberrations and improve image quality as described elsewhere herein, for example as follows. The transverse anamorphic component 60 may comprise a light transmitting optical stack 610 such as illustrated with reference to FIGS. 8-F. The lateral anamorphic component 110 may comprise the arrangements illustrated with reference to FIGS. 7A-I. Field curvature may be improved by the arrangements of FIGS. 9A-D. Aberration control and power of anamorphic components 60, 110 may be further improved by the Pancharatnam-Berry lenses of FIGS. 10A-F for use in the lateral anamorphic component 110 and/or transverse anamorphic component 60. Chromatic aberrations and image distortions may be improved as illustrated in FIGS. 13A-K.

The features of FIGS. 7A-I, FIGS. 8A-F, FIGS. 9A-D, FIGS. 10A-F, FIGS. 11A-E, and FIGS. 13A-K mentioned above may be provided in isolation or in combination.

Head-wear 600 comprising the anamorphic near-eye display apparatus 100 will now be described.

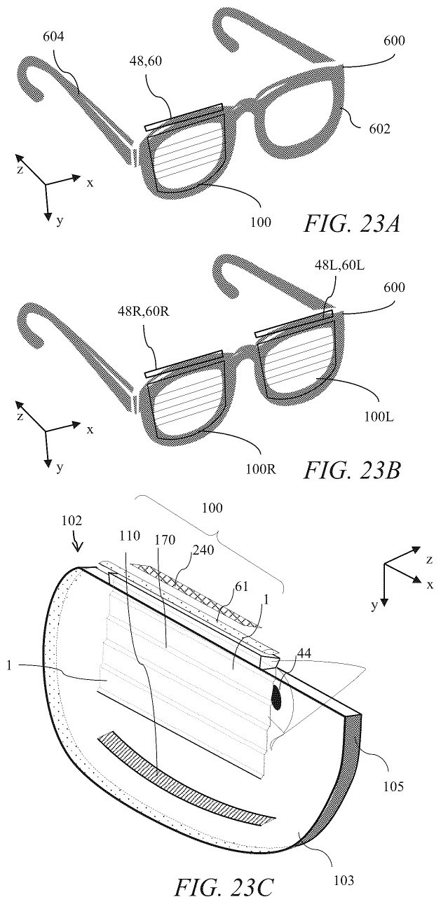

FIG. 23A is a schematic diagram illustrating in perspective front view augmented reality head-worn display apparatus 600 comprising a monocular anamorphic display apparatus arranged with spatial light modulator 48 and transverse anamorphic component 60 formed by the transverse lens 61 in brow position; and FIG. 23B is a schematic diagram illustrating in perspective front view augmented reality head-worn display apparatus 600 comprising binocular anamorphic display apparatuses 100L, 100R arranged with spatial light modulators 48R, 48L and transverse anamorphic components 60R, 60L in brow position. Features of the embodiments of FIGS. 23A-B not discussed in further detail may be assumed to correspond to the features with equivalent reference numerals as discussed above, including any potential variations in the features.

The head-worn display apparatus 600 may comprise a pair of spectacles 600 comprising the anamorphic near-eye display apparatus 100 described elsewhere herein that is arranged to extend across at least one eye 45 of a viewer 47 when the head-worn display apparatus 600 is worn. The head-worn display apparatus 600 may comprise a pair of spectacles comprising spectacle frames 602 with rims 603 and arms 604, which serve as a head-mounting arrangement arranged to mount the anamorphic near-eye display apparatus 100 on a head of a wearer with the anamorphic near-eye display apparatus 100 extending across at least one eye of the wearer. In general, any other head-mounting arrangement may alternatively be provided. The rims 603 and/or arms 604 may comprise electrical systems for at least power, sensing and control of the illumination system 240. The anamorphic near-eye display apparatus 100 of the present embodiments may be provided with low weight and may be transparent. The head-worn display apparatus 600 may be tethered by wires to remote control system or may be untethered for wireless control. Advantageously comfortable viewing of augmented reality content may be provided.

It may be desirable to provide improved aesthetic appearance of the anamorphic near-eye display apparatus 100.

FIG. 23C is a schematic diagram illustrating in perspective front view an eyepiece arrangement 102 for an augmented reality head-worn display apparatus 600 comprising an embedded display apparatus 100. Features of the embodiment of FIG. 23C not discussed in further detail may be assumed to correspond to the features with equivalent reference numerals as discussed above, including any potential variations in the features.

The eyepiece arrangement 102 may be arranged within the head-worn display apparatus 600 and may comprise the anamorphic near-eye display apparatus 100. The extraction waveguide 1 may be embedded with a substrate 103 that extends around the components 170, 110 of the anamorphic near-eye display apparatus 100. The shape of the substrate 103 may be profiled to fit various shaped head-worn display apparatus, for example spectacles. Advantageously aesthetic appearance may be improved.

The edge 105 of the substrate 103 may be provided with a light absorbing surface that absorbs incident light from the anamorphic near-eye display apparatus 100. The light absorbing surface may be a structured anti-reflection surface that is coated with an absorbing material. Advantageously image contrast is improved.

It may be desirable to change the illumination system 240 positioning in the head-worn display apparatus 600.

The eye-piece arrangement 102 comprising substrate 103 may further be provided for others of the embodiments of the present disclosure.

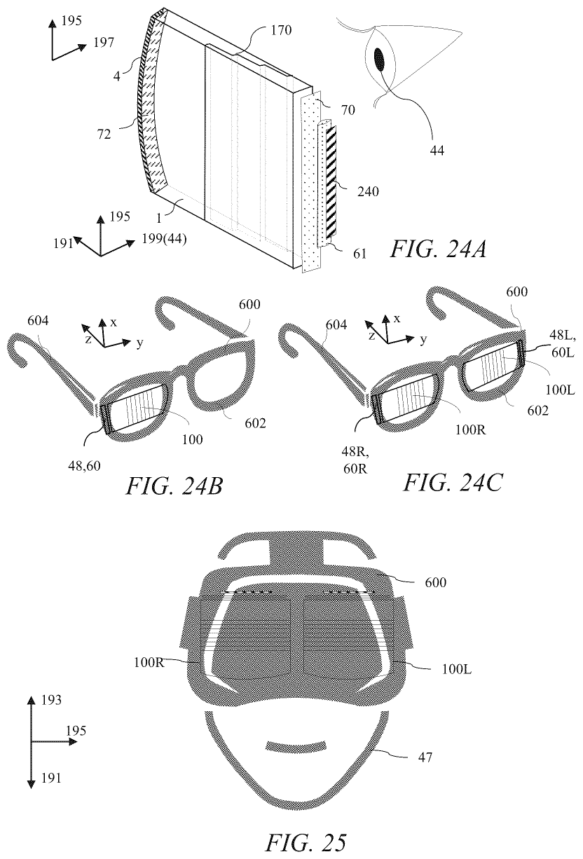

FIG. 24A is a schematic diagram illustrating in perspective front view an anamorphic near-eye display apparatus 100 with spatial light modulator 48 in temple location; FIG. 24B is a schematic diagram illustrating in perspective front view augmented reality head-worn display apparatus 600 comprising a left-eye anamorphic display apparatus arranged with spatial light modulator in temple position; and FIG. 24C is a schematic diagram illustrating in perspective front view augmented reality head-worn display apparatus 600 comprising left-eye and right-eye anamorphic display apparatuses arranged with spatial light modulator in temple position. Features of the embodiments of FIGS. 24A-C not discussed in further detail may be assumed to correspond to the features with equivalent reference numerals as discussed above, including any potential variations in the features.

In comparison to the arrangement of FIG. 1A, the illumination system 240 is arranged on the side of the extraction waveguide 1 and the direction 191 in which the extraction waveguide 1 extends in the horizontal direction for the eyes 45 of the user. Thus the lateral direction 195 for the pupil 44 is vertical and the transverse direction 197 is horizontal. The anamorphic near-eye display apparatus 100 may be arranged within the arms of the head-wear 600, reducing the bulk of the rims 603 of the head-worn display apparatus 600. Advantageously the aesthetic appearance of the head-worn display apparatus 600 may be improved. Further the connectivity between the illumination system 240 and control electronics arranged in the arms 604 may be provided with reduced complexity, reducing cost.

It would be desirable to provide a virtual reality head-worn display apparatus 600 in which the head-worn display apparatus is not transparent to external images.

FIG. 25 is a schematic diagram illustrating in front view virtual reality head-worn display apparatus 600 comprising left-eye and right-eye anamorphic display apparatuses 1OOR, 100L. Features of the embodiment of FIG. 25 not discussed in further detail may be assumed to correspond to the features with equivalent reference numerals as discussed above, including any potential variations in the features.

The alternative embodiment of head-worn display apparatus 600 of FIG. 25 may comprise display apparatuses 100R, 100L mounted in head gear 601 that have larger size than desirable for spectacle head-worn display apparatus 600 of FIG. 23B. Referring to FIG. 1F aberrations may be reduced for a given field angle, field of view increased for a given ellipse blur PSF 452 limit. Further image brightness may be increased.

Alternative arrangements of anamorphic near-eye display apparatus comprising an input waveguide and separate extraction waveguide will now be described.

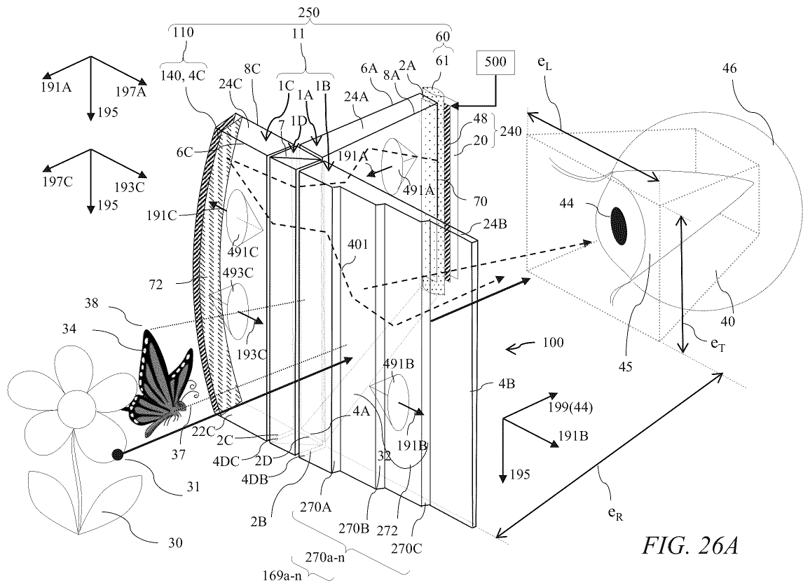

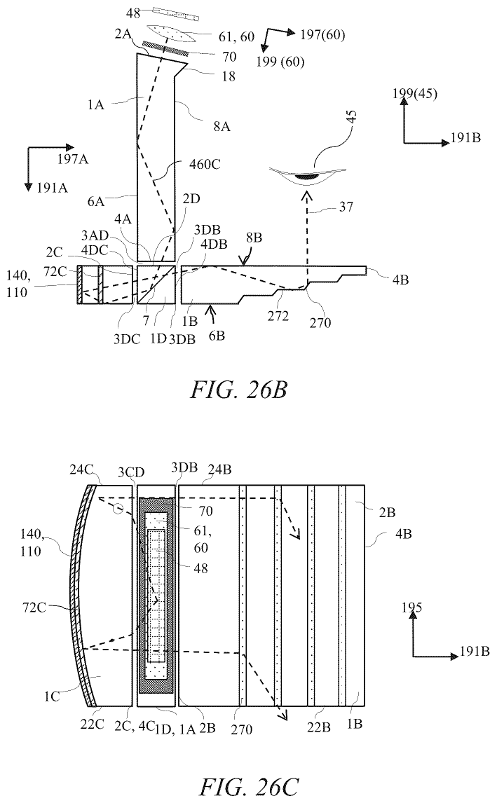

FIG. 26A is a schematic diagram illustrating a front perspective view of an anamorphic near-eye display apparatus 100; FIG. 26B is a schematic diagram illustrating a top view of the anamorphic near-eye display apparatus 100 of FIG. 26A; and FIG. 26C is a schematic diagram illustrating a front view of the anamorphic near-eye display apparatus 100 of FIG. 26A.

FIG. 26A illustrates an anamorphic near-eye display apparatus 100 comprising: an illumination system 240 comprising a spatial light modulator 48, the illumination system 240 being arranged to output light (for example light ray 401); and an optical system 250 arranged to direct light from the illumination system 240 to a viewer's eye 45, wherein the optical system 250 has an optical axis 19) and has anamorphic properties in a lateral direction 195 and a transverse direction 197 that are perpendicular to each other and perpendicular to the optical axis 199, wherein the spatial light modulator 48 comprises pixels 222 distributed in the lateral direction 195, and the optical system 250 comprises: a transverse anamorphic component 60 having positive optical power in the transverse direction 197, wherein the transverse anamorphic component 60 is arranged to receive light 401 from the spatial light modulator 48 and the illumination system 250 is arranged so that light output from the transverse anamorphic component 60 is directed in directions that are distributed in the transverse direction 197; an input waveguide 1A arranged to receive light from the transverse anamorphic component 60; a partially reflective mirror 7, the input waveguide 1A being arranged to guide light from the transverse anamorphic component 60 to the partially reflective mirror 7 along the input waveguide 1A, and the partially reflective mirror 7 being arranged to reflect at least some of that light; an intermediate waveguide 1C arranged to receive at least some of the light reflected by the partially reflective mirror 7, a lateral anamorphic component 110 having positive optical power in the lateral direction 195, the intermediate waveguide 1C being arranged to guide the light received from the partially reflective mirror 7 to the lateral anamorphic component 110 along the intermediate waveguide 1C in a first direction 191C; a light reversing reflector 140 that is arranged to reflect light that has been guided along the intermediate waveguide 1C in the first direction 191C so that the reflected light is guided along the intermediate waveguide 1C in a second direction 193C opposite to the first direction 191C to the partially reflective mirror 7, the partially reflective mirror 7 being arranged to transmit at least some of that light; and an extraction waveguide 1B arranged to receive at least some of the light transmitted by the partially reflective mirror 7 that has been guided in the second direction 193C along the intermediate waveguide 1C, wherein the extraction waveguide 1B comprises an array of reflective extraction features 170a-n, the reflective extraction features 170a-n being arranged to extract light guided along the extraction waveguide 1B towards an eye 45 of a viewer, the array of reflective extraction features 170a-n being distributed along the extraction waveguide 1B so as to provide exit pupil 40 expansion.

Input waveguide 1A is arranged to guide light rays 400 in cone 491A from the transverse anamorphic component 60 to partially reflective mirror 7 along the input waveguide 1A in direction 191A. The input waveguide 1A has opposing rear and front guide surfaces 6A, 8A that are planar and parallel. The input waveguide 1A further has an input face 2A extending in the lateral and transverse directions 195(60), 197(60), the input waveguide 1A being arranged to receive light 400 from the illumination system 240 through an input face 2A. The input face 2A extends in the lateral direction 195 between edges 22A, 24A of the input waveguide 1A, and extends in the transverse direction 197 between opposing rear and front guide surfaces 6A, 8A of the input waveguide 1A. The output face 4A of the input waveguide 1B is arranged to output light towards the partially reflective mirror 7.

The input waveguide 1A and the intermediate waveguide 1C comprise no extraction features that are arranged to extract light guided therealong. In operation input waveguide 1A is arranged to guide light rays 400 between the opposing rear and front guide surfaces 6, 8 as illustrated by the zig-zag paths of guided rays 401 in both input waveguide 1A. Advantageously light may be directed with high efficiency from the transverse anamorphic component 60 to the partially reflective mirror 7 and images may be provided with reduced image blur.

Partially reflective mirror 7 is arranged to receive light from the input waveguide 1A. Partially reflective mirror 7 may be arranged within a mirror waveguide 1D with edges 22D, 24D, input face 2D, waveguide output face 4DC and waveguide output face 4DB.

Air gaps 3AD, 3DC and 3DB are arranged between mirror waveguide 1D and input waveguide 1A, intermediate waveguide 1C and extraction waveguide 1B respectively. Some light rays may guide within the mirror waveguide 1D. The operation of the air gaps 3 will be described further hereinbelow with respect to FIGS. 6G-K.

In general, the mirror 7 of the mirror waveguide 1D is arranged to direct at least some of the light from the input waveguide 1A into the intermediate waveguide 1C.

Partially reflective mirror 7 may comprise partially reflective layers such as air gaps, reflective polarisers or dielectric layers. Partially reflective mirror 7 may provide a polarisation-sensitive reflectivity and polariser 70 may be provided as described hereinbelow in FIGS. 7A-B for example.

Partially reflective mirror 7 may be further arranged to transmit light that is reflected by light reversing reflector 140 of the intermediate waveguide 1C. In alternative embodiments the partially reflective mirror 7 may be arranged to transmit light from the input waveguide 1A and reflect light from the intermediate waveguide 1C.

Intermediate waveguide 1C is arranged to receive at least some of the light from the partially reflective mirror 7 and comprises a light reversing reflector 140 that is arranged to reflect light in light cones 491C that has been guided in the first direction 191C along the intermediate waveguide 1C in the first direction 191C so that the reflected light in light cone 493C is guided along the intermediate waveguide 1C in a second direction 193C opposite to the first direction 191C, and towards the partially reflective mirror 7 and extraction waveguide 1B.

The intermediate waveguide 1C further has an input face 2C extending in the lateral and transverse directions 195(60), 197(60), the intermediate waveguide 1C being arranged to receive light 400 from the partially reflective mirror 7. The input face 2C extends in the lateral direction 195 between edges 22C, 24A of the intermediate waveguide 1C, and extends in the transverse direction 197C between opposing rear and front guide surfaces 6C, 8C of the intermediate waveguide 1C.

The intermediate waveguide 1C may comprise no extraction features that are arranged to extract light guided therealong. The front and rear guide surfaces 8C, 6C of the intermediate waveguide 1C are planar and parallel. Advantageously light may be transmitted along the intermediate waveguide 1C with high efficiency and image blur of the output image is reduced.

In the embodiment of FIG. 26A, the light reversing reflector 140 is a reflective end 4C of the intermediate waveguide 1C. Furthermore, the light reversing reflector 140 forms the lateral anamorphic component 110. In particular, the reflective end 4C of the intermediate waveguide 1C has a curved shape and further comprises a reflective material in the lateral direction 195 that provides positive optical power, affecting the light rays in cone 491C in the lateral direction 195(110), and no power in the transverse direction 197(110). The reflective material may be a reflective film such as ESR™ from 3M or may be an evaporated or sputtered metal material. In the embodiment of FIG. 26A, the lateral anamorphic component 110 is thus a curved mirror with positive optical power in the lateral direction 195 and no optical power in the transverse direction 197.

The optical system 250 is thus arranged so that light output from the lateral anamorphic component 110 is directed in directions that are distributed in the transverse direction 197(110) and the lateral direction 195(110). The curved shape of the reflective end 4C may be a shape that is the cross section of a sphere, ellipse, parabola or other aspheric shape to achieve desirable imaging of light rays from the spatial light modulator 48 to the pupil 44 of the eye 45 as will be described further hereinbelow.

The reflected light from the light reversing reflector 140 is output from the intermediate waveguide 1C and incident on the mirror waveguide 1D with a polarisation state 902 that is preferentially transmitted by the partially reflective mirror 7. Advantageously efficiency may be increased.

Extraction waveguide 1B is arranged to receive light from the lateral anamorphic component, 110.

The extraction waveguide 1B further has an input face 2B extending in the lateral and transverse directions 195(60), 197(60), the extraction waveguide 1B being arranged to receive light 400 from the partially reflective mirror 7. The input face 2B extends in the lateral direction 195 between edges 22B, 24B of the extraction waveguide 1B, and extends in the transverse direction 197B between opposing rear and front guide surfaces 6B, 8B of the extraction waveguide 1B. The output face 4B of the extraction waveguide 1B may for example comprise a light absorbing material. Advantageously stray light may be reduced.

The extraction waveguide 1B has a front guide surface and a rear guide surface 8B, 6B, and the rear guide surface 6B comprises extraction facets 270 that are the reflective extraction features 169. The extraction waveguide comprises an array of reflective extraction features 170a-n, the reflective extraction features 170a-n being arranged to extract light guided along the extraction waveguide 1B towards an eye 45 of a viewer, the array of reflective extraction features 170a-n being distributed along the extraction waveguide 1B so as to provide exit pupil expansion.

The extraction waveguide 1B comprises extraction facets 270 and intermediate surfaces 272 extending along the extraction waveguide between adjacent pairs of extraction reflectors 270 and that are arranged on the rear light guide surface 6B. In the embodiment of FIG. 26A, intermediate surfaces 272 are arranged between pairs of extraction reflectors 170A-B, 170B-C. 170C-D and 170D-E. Such external surfaces may reflect guided light 401 to the eye 45 by means of total internal reflection at intermediate surface 272 and total internal reflection at the extraction facet 270 and thus are polarisation independent so that polarisation conversion retarder 72B may be omitted and polarisation state 904 may propagate within the extraction waveguide 1B. The input linear polariser is thus arranged to pass light that is in an s-polarisation state 904 in the extraction waveguide. Advantageously increased efficiency may be achieved.

In the embodiment of FIG. 26A, the directions 193C, 191B are the same. In other embodiments described hereinbelow, the directions 193C, 191B may be different. The extraction reflectors 270 are arranged to extract at least some of light cone 491B guided along the extraction waveguide 1B in the direction 191B towards an eye 45 of a viewer 47 as will be described further hereinbelow.

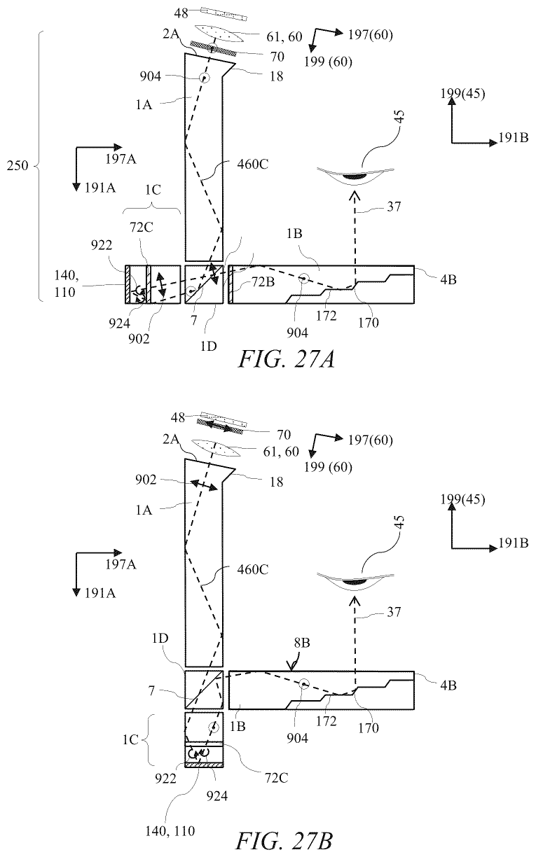

FIGS. 27A-B are schematic diagrams illustrating a top view of polarisation state propagation in alternative arrangements of anamorphic near-eye display apparatuses. Features of the embodiments of FIGS. 27A-B not discussed in further detail may be assumed to correspond to the features with equivalent reference numerals as discussed above, including any potential variations in the features.

By way of comparison with FIG. 26B, the alternative embodiment of FIG. 27A comprises extraction reflectors 170 disposed internally within the extraction waveguide 1B. However the polarisation of light suitable for efficient reflection at the partially reflective mirror 7 is the same in FIG. 26B and FIG. 27A.

The extraction reflectors 170 extend partially across the extraction waveguide 1B between opposing rear and front guide surfaces 6, 8 of the extraction waveguide 1B with successively shifted positions. The successively shifted positions are arranged along the waveguide in the direction 191B. In other words, in the transverse direction 197 the extraction reflectors 170 extend partially across the extraction waveguide 1B with successively shifted positions.

The input linear polariser 70 is disposed between the spatial light modulator 48 and the partially reflective mirror 7 which in the embodiment of FIG. 26B is between the transverse anamorphic component 60 and the input waveguide 1A. The input linear polariser 70 is an absorbing polariser such as a dichroic iodine polariser arranged to transmit a linear polarisation state 904,902 and absorb the orthogonal polarisation state 902, 904 respectively.

In the alternative embodiment of FIG. 27A, the polariser 70 may be arranged to transmit the s-polarised polarisation state 904 that may be preferentially reflected from the partially reflective mirror 7 and towards the intermediate waveguide 1C. A polarisation conversion retarder 72C is disposed between the the partially reflective mirror 7 and the light reversing reflector 140, the polarisation conversion retarder 72C being arranged to convert a polarisation state of light passing therethrough between a linear polarisation state 904 and a circular polarisation state 924, wherein the polarisation conversion retarder 72C has a retardance of a quarter wavelength at a wavelength of visible light, for example 550 nm; that is the polarisation conversion retarder 72C may be a quarter wave retardation at a visible wavelength such as 550 nm and may comprise a stack of composite retarders arranged to achieve the operation of a quarter wave retarder over an increased spectral band, for example comprising a Pancharatnam stack. Improved chromaticity of output may be achieved.

After reflection at the light reversing reflector 140, orthogonal circular polarisation state 922 is provided and the polarisation conversion retarder 72C provides p-polarisation linear state 902 back towards the partially reflective mirror 7 that is preferentially transmitted towards the extraction waveguide 1B. Increased transmission of the partially reflective mirror 7 may be achieved for light rays propagating towards the extraction waveguide 1B.

The optical system 250 further comprises a further polarisation conversion retarder 72B disposed between the the partially reflective mirror 7 and the extraction waveguide 1B, the polarisation conversion retarder 72B being arranged to convert a polarisation state of light passing therethrough between a linear polarisation state 902 and an orthogonal linear polarisation state 904, wherein the further polarisation conversion retarder 72B has a retardance of a half wavelength at a wavelength of visible light. As will be described hereinbelow, the further polarisation conversion retarder 72B provides polarisation state 904 incident onto the extraction reflectors 170. Advantageously improved efficiency may be achieved as will be described hereinbelow.

The alternative embodiment of FIG. 27B comprises extraction reflectors 170 disposed internally within the extraction waveguide 1B. The input linear polariser 70 is disposed between the spatial light modulator 48 and and the transverse anamorphic component 60. The polariser 70 may be arranged to transmit the p-polarised polarisation state 902 that may be preferentially transmitted by the partially reflective mirror 7 and towards the intermediate waveguide 1C. The polarisation conversion retarder is arranged to convert a polarisation state of light passing therethrough between a linear polarisation state 902 and a circular polarisation state 922. After reflection at the light reversing reflector 140, orthogonal circular polarisation state 924 is provided and the polarisation conversion retarder 72C provides s-polarisation linear state 904 back towards the partially reflective mirror 7 that is preferentially reflected towards the extraction waveguide 1B. Increased reflectivity of the partially reflective mirror 7 may be achieved for light rays propagating towards the extraction waveguide 1B.

The further polarisation conversion retarder 72C of FIG. 27A is omitted so that the polarisation state 904 is preferentially reflected by the reflection extractors 170. Advantageously efficiency is increased.

By way of comparison with FIG. 1A to FIG. 25, the alternative embodiments of FIG. 26A to FIG. 27B comprise an input waveguide 1A that is separated from the extraction waveguide 1B. Intermediate waveguide 1C may be arranged with the aberration correction embodiments provided for the lateral direction 195 and transverse direction 197 as described hereinabove. Further the extraction waveguide 1B may be provided with the various embodiments of extraction feature 169 as described hereinabove. Furthermore, the embodiments of FIG. 26A to FIG. 27B do not provide light incidence onto extraction features 169 for light passing in a first direction 191, for example as illustrated in FIG. 1B hereinabove. Advantageously efficiency may be increased and stray light reduced.

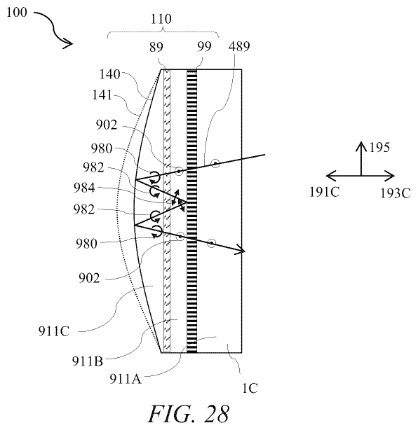

FIG. 28 is a schematic diagram illustrating in front view an anamorphic near-eye display apparatus 100 an intermediate waveguide 1C of an anamorphic near-eye display apparatus 100 of the type illustrated in FIG. 26A to FIG. 27B comprising an input waveguide 1A, a partial mirror 7, an intermediate waveguide 1C and an extraction waveguide 1B wherein the lateral anamorphic component 110 further comprises a planar reflective linear polariser 99 and a polarisation conversion retarder 89 arranged between the light reversing reflector 140 that is the reflective end 4, and the reflective linear polariser 99.

In comparison to the embodiment of FIG. 7A, in the alternative embodiment of FIG. 28, the lateral anamorphic component 110 is provided at the end 4C of the intermediate waveguide 1C rather than the end 4 of the extraction waveguide 1 of FIG. 7A. Further, the extraction waveguide 1B is arranged to receive light from the transverse anamorphic component 60 by way of the input waveguide 1A and the intermediate waveguide 1C.

Such an arrangement may achieve the desirable aberration and size improvements of FIG. 7A. In the above examples, specific examples of the lateral anamorphic component 110 and transverse anamorphic component 60 are shown (for example comprising reflective linear polariser 99, polarisation conversion retarder 89 of FIG. 7A and FIG. 28, and half-silvered mirror 214 and a reflective polariser 218 of FIG. 8A. Pancharatnum-Berry lens 350 of FIG. 10A and so on), but this is not limitative and in general any of aberration enhancement embodiments disclosed herein for use in embodiments comprising extraction waveguides 1 may alternatively be applied in embodiments comprising intermediate waveguides 1C. Similarly, the various features may be combined together in any combination.

The illumination system 240 and optical system 250 of the embodiments hereinabove may be provided for anamorphic directional illumination devices for illumination of external scenes 479.

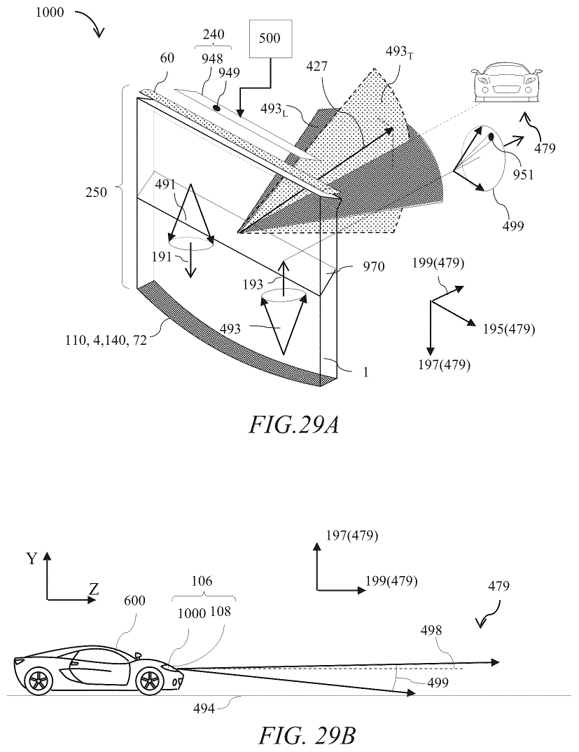

FIG. 29A is a schematic diagram illustrating a front perspective view an anamorphic directional illumination device 1000 arranged to illuminate an external scene 479. Features of the embodiment of FIG. 29A not discussed in further detail may be assumed to correspond to the features with equivalent reference numerals as discussed above, including any potential variations in the features.

The alternative embodiment of FIG. 29A illustrates an anamorphic directional illumination device 1000 that comprises an illumination system 240 comprising a light source array 948, the illumination system being arranged to output light. Light source array 948 may for example comprise an array of light emitting diodes, or may be provided by a spatial light modulator 48 as described elsewhere herein.

Optical system 250 is arranged to direct light from the illumination system 240. The light in light cone 499 may be directed towards an externally illuminated scene 479. Illuminated scenes 479 may include but are not limited to roads, rooms, external spaces, processing equipment, metrology environments, theatrical stages, human bodies such as for face illumination for face detection and measurement purposes.

The optical system 250 has an optical axis 199 and has anamorphic properties in a lateral direction 195 and a transverse direction 197 that are perpendicular to each other and perpendicular to the optical axis 199, wherein the light source array 948 comprises light sources 949a-n distributed in the lateral direction 195, and which may further be distributed in the transverse direction 197 as described elsewhere herein.

The optical system 250 further comprises a transverse anamorphic component 60 having positive optical power in the transverse direction 197, wherein the transverse anamorphic component 60 is arranged to receive light from the light source array 948 and the illumination system 250 is arranged so that light output from the transverse ananorphic component 60 is directed in directions that are distributed in the transverse direction 197.

The optical system 250 further comprises an extraction waveguide 1 arranged to receive light from the transverse anamorphic component 60 and a lateral anamorphic component 110 having positive optical power in the lateral direction 195, the extraction waveguide 1 being arranged to guide light in light cone 491 from the transverse anamorphic component 60 to the lateral anamorphic component 110 along the extraction waveguide 1 in a first direction 191.

A light reversing reflector 140 is arranged to reflect light that has been guided along the extraction waveguide 1 in the first direction 191 so that the reflected light in light cone 493 is guided along the extraction waveguide 1 in a second direction 193 opposite to the first direction 191.

The extraction waveguide 1 comprises at least one reflective extraction feature 970 disposed internally within the extraction waveguide 1, the at least one reflective extraction feature 970 being arranged to transmit light guided along the extraction waveguide 1 in the first direction 191 and to extract light guided along the extraction waveguide 1 in the second direction 193 to provide output light cone 499 directed towards the illuminated scene 479.

The anamorphic directional illumination device 1000 of FIG. 29A may comprise various embodiments arranged to improve efficiency, aberrations and image quality as described for the embodiments of anamorphic near-eye display apparatus 100 described elsewhere herein.

As illustrated in FIG. 7A for example, the lateral anamorphic component 110 may comprise: a reflective linear polariser 99 disposed between the light reversing reflector 140 and the at least one extraction feature 970; and a polarisation conversion retarder 89 disposed between the reflective linear polariser 99 and the light reversing reflector 140, the polarisation conversion retarder 89 being arranged to convert a polarisation state of light passing therethrough between a linear polarisation state and a circular polarisation state. Aberrations of the lateral anamorphic component 110 may be improved in the lateral direction. Fidelity of optical cones 499 and field of illumination may be increased. Higher contrast illumination of external scenes 479 may be provided. Reduced glare and increased luminance may be achieved.

As illustrated in FIG. 8A for example, the transverse anamorphic component 60 may comprise: a partially reflective surface 214; a reflective linear polariser 218 disposed in series with the partially reflective surface 214, wherein at least one of the partially reflective surface 214 and the reflective linear polariser 218 has positive optical power in the transverse direction 197; and a polarisation conversion retarder 216 disposed between the partially reflective surface 214 and the reflective linear polariser 218, the polarisation conversion retarder 216 being arranged to convert a polarisation state of light passing therethrough between a linear polarisation state and a circular polarisation state. In alternative embodiments, not shown, the extraction waveguide 1 may comprise the intermediate waveguide 1C of FIG. 26A for example. Advantageously the fidelity of light cones output may be improved in the transverse direction. Higher contrast illumination of external scenes may be provided. Reduced glare and increased luminance may be achieved.

As illustrated in FIG. 9A for example, the lateral anamorphic component 110 may comprise a lens 95 formed by at least one surface 91, 92 of an air gap 97. In alternative embodiments, not shown, the extraction waveguide 1 may comprise the intermediate waveguide 1C of FIG. 26A for example. Advantageously the fidelity of light cones output may be improved. Higher contrast illumination of external scenes may be provided. Reduced glare and increased luminance may be achieved.

As illustrated in FIG. 10A for example, the lens of the lateral anamorphic component 110 is a Pancharatnam-Berry lens 350. In alternative embodiments, not shown, the extraction waveguide 1 may comprise the intermediate waveguide 1C of FIG. 26A for example. Advantageously the fidelity of light cones output may be improved. Higher contrast illumination of external scenes may be provided. Reduced glare and increased luminance may be achieved. The compactness of the anamorphic directional illumination device may be improved.

As illustrated in FIGS. 1A-C for example, the at least one of an input end 2 of the extraction waveguide 1, the transverse anamorphic component 60 and the light source array 948 has a curvature in the lateral direction 195 that compensates for field curvature of the lateral anamorphic component 110. In alternative embodiments, not shown, the extraction waveguide 1 may comprise the input waveguide 1A of FIG. 26A for example. Advantageously the fidelity of light cones output may be improved and the field of illumination increased. Higher contrast illumination of external scenes may be provided. Reduced glare and increased luminance may be achieved.

As illustrated in FIGS. 13F-H for example, the light source array 948 may be provided (in place of spatial light modulator 48) comprising an array of light sources 949 (in place of pixels 222), wherein each light source 949 (in place of pixel 222) comprises sub-light sources 949R, 949G, 949B (in place of pixels 222R, 222G, 222B) of plural colour components and a pitch P of the sub-light sources 949R, 949G, 949B of each colour component across the light sources in the lateral direction 195 varies between the colour components in a manner that compensates for chromatic aberration between light of the colour components. Advantageously colouration of the output light cones 499 may be reduced. Image fidelity may be increased and field of illumination improved.

By way of comparison with the anamorphic near-eye display apparatuses 100 described hereinabove, the output light from the anamorphic directional illumination device 1000 is provided as illumination cones 951a-n for illumination of a scene 479 compared to the angular pixel information for illumination of pupil 44 and retina 46. High resolution imaging of illuminated scenes 479 may be achieved with high efficiency and low cost in a compact package.

The light sources 949 may output light that is visible light or infra-red light. Advantageously directional illumination of scenes 479 may be provided for visible illumination or illumination of scenes for other detectors such as LIDAR detectors. The light sources 949 may have different spectral outputs. The different spectral outputs include: a white light spectrum, plural different white light spectra, red light, orange light, and/or infra-red light. A visible illumination may be provided and a further illumination for detection purposes may also be provided, which may have different illumination structures to achieve improved signal to noise of detection.

In an alternative embodiment, the scene 479 may comprise a projection screen and the anamorphic directional illumination device 1000 may provide projection of images onto the projection screen. Advantageously a lightweight and portable image projector with high efficiency may be provided in a thin package.

The reflective extraction feature 970 of FIG. 29A may alternatively be provided by an array of light extraction features 970a-n. Advantageously the aesthetic appearance of the directional illumination appearance may be modified. Alternatively the reflective extraction feature 970 may be provided by at least one of reflective extraction feature 169 as described elsewhere hereinabove and may comprise at least one feature such as, but not limited to, extraction reflectors 170, 172, 174 and diffractive extraction features 112B. Alternative embodiments of light source array 948 may be provided by embodiments of spatial light modulator 48 as described hereinabove, for example in FIGS. 2A-D, FIG. 17, and FIGS. 18A-C. The transverse anamorphic component 60 may alternatively comprise a light transmitting optical stack 610 such as illustrated with reference to FIGS. 8A-F. The lateral anamorphic component 110 may alternatively comprise the arrangements illustrated with reference to FIGS. 7A-I. Field curvature may be improved by the arrangements such as FIGS. 9A-D. Aberration control and power of anamorphic components 60, 110 may be further improved by the Pancharatnam-Berry lenses of FIGS. 10A-F for use in the lateral anamorphic component 110 and/or transverse anamorphic component 60. Chromatic aberrations and image distortions may be improved as illustrated in FIGS. 13A-K. The waveguide arrangement may comprise the extraction waveguide 1 such as illustrated in FIG. 1A; polarisation-sensitive reflector 700 such as illustrated in 21A-H; or the input waveguide 1A, the partial reflector 7, the intermediate waveguide 1C and the extraction waveguide 1B. The features mentioned above may be provided in isolation or in combination.

Alternative embodiments of waveguide 1 arrangements, transverse anamorphic component 60 arrangements, lateral anamorphic component 110 arrangements and extraction feature 970 arrangements may be provided as described elsewhere hereinabove.

FIG. 29B is a schematic diagram illustrating a side view of a road scene 479 comprising a vehicle 600 comprising a vehicle external light apparatus 106 comprising the anamorphic directional illumination device 1000 of FIG. 29A. Features of the embodiment of FIG. 29B not discussed in further detail may be assumed to correspond to the features with equivalent reference numerals as discussed above, including any potential variations in the features.

The alternative embodiment of FIG. 29B illustrates a vehicle external light apparatus 106 comprising an anamorphic directional illumination device 1000 such as illustrated in FIG. 29A that is a vehicle external light device mounted on a housing 108 for fitting to a vehicle 600. The vehicle external light apparatus 106 is arranged to illuminate an external scene 479 such as a road environment.

The vehicle external light apparatus 106 provides output light cone 499 so that the horizon 499 and road surface 494 may be illuminated. In the example of FIG. 29B the cross section of light cone 499 is distributed across the transverse direction 197. In alternative embodiments the cross section of light cone 499 may be distributed across the lateral direction 195.

The light source array 948 may be controlled by controller 500 in response to the location of objects such as other drivers or road hazards in the illuminated scene 479. The light cone 499 may be arranged to illuminate a two dimensional array of light cones 951 corresponding to respective light sources 949. The light sources 949a-n may be individually or collectively controllable so that some parts of the scene 479 are illuminated and other parts are not illuminated or illuminated with different illuminance. Advantageously glare to other drivers may be reduced while providing increased levels of illuminance of the road scene 479.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. An anamorphic near-eye display apparatus comprising:
an illumination system comprising a spatial light modulator, the illumination system being arranged to output light; and
an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises an array of extraction features, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion, and
the lateral anamorphic component comprises:
a reflective linear polariser disposed between the light reversing reflector and the array of extraction features; and
a polarisation conversion retarder disposed between the reflective linear polariser and the light reversing reflector, the polarisation conversion retarder being arranged to convert a polarisation state of light passing therethrough between a linear polarisation state and a circular polarisation state.

2. An anamorphic near-eye display apparatus according to claim 1, wherein the reflective linear polariser is curved in the lateral direction.

3. An anamorphic near-eye display apparatus according to claim 2,
wherein the light reversing reflector is not curved in the lateral direction.

4. An anamorphic near-eye display apparatus according to claim 1, wherein the light reversing reflector is curved in the lateral direction.

5. An anamorphic near-eye display apparatus according to claim 1, wherein the polarisation conversion retarder is curved in the lateral direction.

6. An anamorphic near-eye display apparatus according to claim 1, wherein the polarisation conversion retarder has a retardance of a quarter wavelength at a wavelength of visible light.

7. An anamorphic near-eye display apparatus according to claim 1, wherein the optical system comprises an input linear polariser disposed between the spatial light modulator and the array of extraction reflectors, wherein the input linear polariser and the reflective linear polariser of the lateral anamorphic component are arranged to pass a common polarisation state.

8. An anamorphic near-eye display apparatus according to claim 1, wherein the lateral anamorphic component further comprises:
a polarisation control retarder disposed between the reflective linear polariser and the array of extraction features, the polarisation control retarder being arranged to change a polarisation state of light passing therethrough; and
an absorbing linear polariser disposed between the polarisation control retarder and the reflective linear polariser, wherein the absorbing linear polariser and the reflective linear polariser are arranged to pass a common linear polarisation state that is a component of the polarisation state output from the polarisation control retarder in the direction along the waveguide.

9. An anamorphic near-eye display apparatus according to claim 8, wherein the polarisation control retarder has a retardance of a quarter wavelength or a half wavelength at a wavelength of visible light.

10. An anamorphic near-eye display apparatus according to claim 8, wherein the optical system comprises an input linear polariser disposed between the spatial light modulator and the array of extraction reflectors.

11. An anamorphic near-eye display apparatus according to claim 1, wherein the extraction features are extraction features disposed internally within the extraction waveguide.

12. An anamorphic near-eye display apparatus according to claim 11, wherein the extraction features comprise extraction reflectors that extend across at least part of the extraction waveguide between front and rear guide surfaces of the extraction waveguide.

13. An anamorphic near-eye display apparatus according to claim 12, wherein the extraction reflectors comprise intermediate surfaces spaced apart by a partially reflective coating.

14. An anamorphic near-eye display apparatus according to claim 13, wherein the partially reflective coating comprises at least one dielectric layer.

15. An anamorphic near-eye display apparatus according to claim 12, wherein the extraction reflectors have a surface normal direction that is inclined with respect to the direction along the waveguide by an angle in the range 20 to 40 degrees.

16. An anamorphic near-eye display apparatus according to claim 1, wherein the extraction waveguide has a front guide surface and a rear guide surface, and the rear guide surface comprises extraction facets that are the extraction features, each extraction facet being arranged to reflect light guided in the second direction towards an eye of a viewer through the front guide surface.

17. An anamorphic near-eye display apparatus according to claim 1, wherein the extraction waveguide has a front guide surface and a rear guide surface, and the rear guide surface comprises a diffractive optical element comprising the extraction features.

18. An anamorphic near-eye display apparatus according to claim 1, wherein:
the extraction waveguide comprises:
a front guide surface;
a polarisation-sensitive reflector opposing the front guide surface; and
an extraction element disposed outside the polarisation-sensitive reflector, wherein the extraction element comprises:
a rear guide surface opposing the front guide surface; and
the array of extraction features;
the anamorphic near-eye display apparatus is arranged to provide light guided along the extraction waveguide in the first direction with an input linear polarisation state before reaching the polarisation-sensitive reflector;
the polarisation conversion retarder disposed between the reflective linear polariser and the light reversing reflector is a first polarisation conversion retarder;
the anamorphic near-eye display apparatus comprises a second polarisation conversion retarder arranged between the polarisation-sensitive reflector and the reflective linear polariser, the second polarisation conversion retarder being arranged to convert from a state that is parallel or orthogonal to the input linear polarisation state to a polarisation state that has a component parallel to the input linear polarisation state and a component orthogonal to the input linear polarisation state;
the anamorphic near-eye display apparatus comprises an absorptive linear polariser arranged to pass the component parallel to the input linear polarisation state or the component orthogonal to the input linear polarisation state;
the reflective linear polariser is arranged to pass the same component as the absorptive linear polariser;
the second polarisation conversion retarder, the absorptive linear polariser, the reflective linear polariser, the first polarisation conversion retarder and the light reversing reflector are arranged in combination to rotate the input linear polarisation state of the light guided in the first direction so that the light guided in the second direction and output from the second polarisation conversion retarder has a linear polarisation state that has a component parallel to the input linear polarisation state and a component orthogonal to the input linear polarisation state; and the polarisation-sensitive reflector is arranged to reflect light guided in the first direction having the input linear polarisation state and to pass the component of light guided in the second direction that is orthogonal to the input linear polarisation state, so that the front guide surface and the polarisation-sensitive reflector are arranged to guide light in the first direction, and the front guide surface and the rear guide surface are arranged to guide the component of light that is orthogonal to the input linear polarisation state in the second direction.

19. An anamorphic near-eye display apparatus according to claim 18, wherein the polarisation-sensitive reflector comprises a reflective linear polariser.

20. An anamorphic near-eye display apparatus according to claim 18, wherein the polarisation-sensitive reflector comprises at least one dielectric layer.

21. An anamorphic near-eye display apparatus according to claim 1, wherein the optical system further comprises:
an input waveguide arranged to receive light from the transverse anamorphic component;
a partially reflective mirror, the input waveguide being arranged to guide light from the transverse anamorphic component to the partially reflective mirror along the input waveguide, and the partially reflective mirror being arranged to reflect at least some of that light;
an intermediate waveguide arranged to receive at least some of the light reflected by the partially reflective mirror;
a lateral anamorphic component having positive optical power in the lateral direction, the intermediate waveguide being arranged to guide the light received from the partially reflective mirror to the lateral anamorphic component along the intermediate waveguide in a first direction;
a light reversing reflector that is arranged to reflect light that has been guided along the intermediate waveguide in the first direction so that the reflected light is guided along the intermediate waveguide in a second direction opposite to the first direction to the partially reflective mirror, the partially reflective mirror being arranged to transmit at least some of that light; and
wherein the extraction waveguide is arranged to receive at least some of the light transmitted by the partially reflective mirror that has been guided in the second direction along the intermediate waveguide.

22. A head-worn display apparatus comprising an anamorphic near-eye display apparatus according to claim 1 and a head-mounting arrangement arranged to mount the anamorphic near-eye display apparatus on a head of a wearer with the anamorphic near-eye display apparatus extending across at least one eye of the wearer.

23. An anamorphic near-eye display apparatus comprising:
an illumination system comprising a spatial light modulator, the illumination system being arranged to output light; and
an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises an array of extraction features, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion, and
the transverse anamorphic component comprises:
a partially reflective surface;
a reflective linear polariser disposed in series with the partially reflective surface, wherein at least one of the partially reflective surface and the reflective linear polariser has positive optical power in the transverse direction; and
a polarisation conversion retarder disposed between the partially reflective surface and the reflective linear polariser, the polarisation conversion retarder being arranged to convert a polarisation state of light passing therethrough between a linear polarisation state and a circular polarisation state.

24. An anamorphic near-eye display apparatus according to claim 23, wherein each of the partially reflective surface and the reflective linear polariser has positive optical power in the transverse direction.

25. An anamorphic near-eye display apparatus according to claim 23, wherein the at least one of the partially reflective surface and the reflective linear polariser that has positive optical power in the transverse direction has no optical power in the lateral direction.

26. An anamorphic near-eye display apparatus according to claim 23, wherein the transverse anamorphic component further comprises at least one lens element.

27. An anamorphic near-eye display apparatus according to claim 23, wherein the reflective linear polariser is disposed after the partially reflective surface in a direction of transmission of light from the spatial light modulator.

28. An anamorphic near-eye display apparatus according to claim 23, wherein the reflective linear polariser is disposed before the partially reflective surface in a direction of transmission of light from the spatial light modulator.

29. An anamorphic near-eye display apparatus according to claim 23, wherein
the extraction waveguide has an input end extending in the lateral and transverse directions, the extraction waveguide being arranged to receive light from the illumination system through the input end, and
the transverse anamorphic component is disposed between the spatial light modulator and the input end of the extraction waveguide.

30. An anamorphic near-eye display apparatus according to claim 29, wherein the transverse anamorphic component further comprises a further polarisation conversion retarder that either is disposed before the partially reflective surface and the reflective linear polariser in a direction of transmission of light from the spatial light modulator or is disposed after the partially reflective surface and the reflective linear polariser in a direction of transmission of light from the spatial light modulator.

31. An anamorphic near-eye display apparatus according to claim 29, further comprising a linear polariser arranged between the transverse anamorphic component and the input end of the extraction waveguide.

32. An anamorphic near-eye display apparatus according to claim 23, wherein the spatial light modulator is arranged to output linearly polarised light.

33. An anamorphic near-eye display apparatus according to claim 23, wherein the illumination system further comprises an output polariser disposed between the spatial light modulator and the transverse optical component, the output polariser being arranged to output linearly polarised light.

34. An anamorphic near-eye display apparatus comprising:
an illumination system comprising a spatial light modulator, the illumination system being arranged to output light; and
an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises an array of extraction features, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion, and
wherein the lateral anamorphic component comprises a lens formed by at least one surface of an air gap formed in a waveguide.

35. An anamorphic near-eye display apparatus according to claim 34, wherein the air gap has edges, and the anamorphic near-eye display apparatus comprises reflectors extending across the edges of the air gap.

36. An anamorphic near-eye display apparatus according to claim 34, wherein the waveguide in which the air gap is formed is the extraction waveguide.

37. An anamorphic near-eye display apparatus according to claim 36, wherein the light reversing reflector is a reflective end of the extraction waveguide.

38. An anamorphic near-eye display apparatus according to claim 34, wherein the lateral anamorphic component further comprises the light reversing reflector.

39. An anamorphic near-eye display apparatus comprising:
an illumination system comprising a spatial light modulator, the illumination system being arranged to output light; and
an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises an array of extraction features, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion, and
the lens of the lateral anamorphic component is a Pancharatnam-Berry lens.

40. An anamorphic near-eye display apparatus comprising:
an illumination system comprising a spatial light modulator, the illumination system being arranged to output light; and
an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises an array of extraction features, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion, and
at least one of an input end of the extraction waveguide, the transverse anamorphic component and the spatial light modulator has a curvature in the lateral direction that compensates for field curvature of the lateral anamorphic component.

41. An anamorphic near-eye display apparatus comprising:
an illumination system comprising a spatial light modulator, the illumination system being arranged to output light; and
an optical system arranged to direct light from the illumination system to a viewer's eye, wherein the optical system has an optical axis and has anamorphic properties in a lateral direction and a transverse direction that are perpendicular to each other and perpendicular to the optical axis, wherein the spatial light modulator comprises pixels distributed in the lateral direction, and the optical system comprises:
a transverse anamorphic component having positive optical power in the transverse direction, wherein the transverse anamorphic component is arranged to receive light from the spatial light modulator and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises an array of extraction features, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion, and
the spatial light modulator comprises an array of pixels, wherein each pixel comprises sub-pixels of plural colour components and a pitch of the sub-pixels of each colour component across the pixels in the lateral direction varies between the colour components in a manner that compensates for chromatic aberration between light of the colour components.

42. An anamorphic near-eye display apparatus according to claim 41, wherein the sub-pixels of each pixel are aligned in the transverse direction.

43. An anamorphic near-eye display apparatus according to claim 41, wherein a pitch of the sub-pixels of each colour component across the pixels in the transverse direction is the same for each colour component.

44. An anamorphic near-eye display apparatus according to claim 41, wherein a pitch of the sub-pixels of each colour component across the pixels in the transverse direction varies between the colour components in a manner that compensates for chromatic aberration between light of the colour components.

45. An anamorphic near-eye display apparatus according to claim 23, wherein the extraction features are reflective extraction features disposed internally within the extraction waveguide.

46. An anamorphic near-eye display apparatus according to claim 45, wherein the reflective extraction features comprise extraction reflectors extending across at least part of the extraction waveguide between front and rear guide surfaces of the extraction waveguide.

47. An anamorphic near-eye display apparatus according to claim 46, wherein the extraction reflectors comprise intermediate surfaces spaced apart by a partially reflective coating.

48. An anamorphic near-eye display apparatus according to claim 47, wherein the partially reflective coating comprises at least one dielectric layer.

49. An anamorphic near-eye display apparatus according to claim 46, wherein the extraction reflectors have a surface normal direction that is inclined with respect to the direction along the waveguide by an angle in the range 20 to 40 degrees.

50. An anamorphic near-eye display apparatus according to claim 23, wherein the extraction waveguide has a front guide surface and a rear guide surface, and the rear guide surface comprises extraction facets that are the extraction features, each extraction facet being arranged to reflect light guided in the second direction towards an eye of a viewer through the front guide surface.

51. An anamorphic near-eye display apparatus according to claim 23, wherein the extraction waveguide has a front guide surface and a rear guide surface, and the rear guide surface comprises a diffractive optical element comprising the extraction features.

52. An anamorphic near-eye display apparatus according to claim 23, wherein:
the extraction waveguide comprises:
a front guide surface;
a polarisation-sensitive reflector opposing the front guide surface; and
an extraction element disposed outside the polarisation-sensitive reflector,
the extraction element comprising:
a rear guide surface opposing the front guide surface; and
the array of extraction features;
the anamorphic near-eye display apparatus is arranged to provide light guided along the extraction waveguide in the first direction with an input linear polarisation state before reaching the polarisation-sensitive reflector; and
the optical system further comprises a polarisation conversion retarder disposed between the polarisation-sensitive reflector and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has an orthogonal linear polarisation state that is orthogonal to the input linear polarisation state;
the polarisation-sensitive reflector is arranged to reflect light guided in the first direction having the input linear polarisation state and to pass light guided in the second direction having the orthogonal linear polarisation state, so that the front guide surface and the polarisation-sensitive reflector are arranged to guide light in the first direction, and the front guide surface and the rear guide surface are arranged to guide light in the second direction; and
the array of extraction features is arranged to extract light guided along the extraction waveguide in the second direction towards an eye of a viewer through the front guide surface, the array of extraction features being distributed along the extraction waveguide so as to provide exit pupil expansion in the transverse direction.

53. An anamorphic near-eye display apparatus according to claim 52, wherein the polarisation-sensitive reflector comprises a reflective linear polariser.

54. An anamorphic near-eye display apparatus according to claim 52, wherein the polarisation-sensitive reflector comprises at least one dielectric layer.

55. An anamorphic near-eye display apparatus according to claim 23, wherein the optical system further comprises:
an input waveguide arranged to receive light from the transverse anamorphic component;
a partially reflective mirror, the input waveguide being arranged to guide light from the transverse anamorphic component to the partially reflective mirror along the input waveguide, and the partially reflective mirror being arranged to reflect at least some of that light;
an intermediate waveguide arranged to receive at least some of the light reflected by the partially reflective mirror,
a lateral anamorphic component having positive optical power in the lateral direction, the intermediate waveguide being arranged to guide the light received from the partially reflective mirror to the lateral anamorphic component along the intermediate waveguide in a first direction;
a light reversing reflector that is arranged to reflect light that has been guided along the intermediate waveguide in the first direction so that the reflected light is guided along the intermediate waveguide in a second direction opposite to the first direction to the partially reflective mirror, the partially reflective mirror being arranged to transmit at least some of that light; and
wherein the extraction waveguide is arranged to receive at least some of the light transmitted by the partially reflective mirror that has been guided in the second direction along the intermediate waveguide.

56. A head-worn display apparatus comprising an anamorphic near-eye display apparatus according to claim 23 and a head-mounting arrangement arranged to mount the anamorphic near-eye display apparatus on a head of a wearer with the anamorphic near-eye display apparatus extending across at least one eye of the wearer.

57. An anamorphic directional illumination device comprising:
an illumination system comprising a light source array, the illumination system being arranged to output light; and
an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises:
a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises at least one extraction feature, the at least one extraction feature being arranged to transmit light guided along the extraction waveguide in the first direction and to extract light guided along the extraction waveguide in the second direction, and
the lateral anamorphic component comprises:
a reflective linear polariser disposed between the light reversing reflector and the at least one extraction feature; and
a polarisation conversion retarder disposed between the reflective linear polariser and the light reversing reflector, the polarisation conversion retarder being arranged to convert a polarisation state of light passing therethrough between a linear polarisation state and a circular polarisation state.

58. An anamorphic directional illumination device comprising:
an illumination system comprising a light source array, the illumination system being arranged to output light; and
an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises:
a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises at least one extraction feature, the at least one extraction feature being arranged to transmit light guided along the extraction waveguide in the first direction and to extract light guided along the extraction waveguide in the second direction, and
the transverse anamorphic component comprises:
a partially reflective surface;
a reflective linear polariser disposed in series with the partially reflective surface, wherein at least one of the partially reflective surface and the reflective linear polariser has positive optical power in the transverse direction; and
a polarisation conversion retarder disposed between the partially reflective surface and the reflective linear polariser, the polarisation conversion retarder being arranged to convert a polarisation state of light passing therethrough between a linear polarisation state and a circular polarisation state.

59. An anamorphic directional illumination device comprising:
an illumination system comprising a light source array, the illumination system being arranged to output light; and
an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises:
a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises at least one extraction feature, the at least one extraction feature being arranged to transmit light guided along the extraction waveguide in the first direction and to extract light guided along the extraction waveguide in the second direction, and
wherein the lateral anamorphic component comprises a lens formed by at least one surface of an air gap formed in a waveguide.

60. An anamorphic directional illumination device comprising:
an illumination system comprising a light source array, the illumination system being arranged to output light; and
an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises:
a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises at least one extraction feature, the at least one extraction feature being arranged to transmit light guided along the extraction waveguide in the first direction and to extract light guided along the extraction waveguide in the second direction, and
the lens of the lateral anamorphic component is a Pancharatnam-Berry lens.

61. An anamorphic directional illumination device comprising:
an illumination system comprising a light source array, the illumination system being arranged to output light; and
an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises:
a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises at least one extraction feature, the at least one extraction feature being arranged to transmit light guided along the extraction waveguide in the first direction and to extract light guided along the extraction waveguide in the second direction, and
at least one of an input end of the extraction waveguide, the transverse anamorphic component and the light source array has a curvature in the lateral direction that compensates for field curvature of the lateral anamorphic component.

62. An anamorphic directional illumination device comprising:
an illumination system comprising a light source array, the illumination system being arranged to output light; and
an optical system arranged to direct light from the illumination system, wherein the optical system has an optical axis and has anamorphic properties in a lateral direction and a transverse direction that are perpendicular to each other and perpendicular to the optical axis, wherein the light source array comprises light sources distributed in the lateral direction, and the optical system comprises:
a transverse anamorphic component having positive optical power in the transverse direction, wherein the transverse anamorphic component is arranged to receive light from the light source array and the illumination system is arranged so that light output from the transverse anamorphic component is directed in directions that are distributed in the transverse direction;
an extraction waveguide arranged to receive light from the transverse anamorphic component;
a lateral anamorphic component having positive optical power in the lateral direction, the extraction waveguide being arranged to guide light from the transverse anamorphic component to the lateral anamorphic component along the extraction waveguide in a first direction; and
a light reversing reflector that is arranged to reflect light that has been guided along the extraction waveguide in the first direction so that the reflected light is guided along the extraction waveguide in a second direction opposite to the first direction,
wherein
the extraction waveguide comprises at least one extraction feature, the at least one extraction feature being arranged to transmit light guided along the extraction waveguide in the first direction and to extract light guided along the extraction waveguide in the second direction, and
the light source array comprises an array of light sources, wherein each light source comprises sub-light sources of plural colour components and a pitch of the sub-light sources of each colour component across the light sources in the lateral direction varies between the colour components in a manner that compensates for chromatic aberration between light of the colour components.

63. A vehicle external light device comprising an anamorphic directional illumination device according to claim 57.

64. A vehicle external light apparatus comprising:
a housing for fitting to a vehicle;
a vehicle external light device according to claim 63 mounted on the housing.
